(19) United States
(12) Patent Application Publication
(10) Pub. No.: US 2026/0094755 A1
(43) Pub. Date: Apr. 2, 2026

(54) N-PHASE TRANS-INDUCTOR VOLTAGE REGULATOR INTEGRATED INDUCTOR, MULTI-PHASE MODULE, INTELLIGENT POWER MODULE, AND POWER SUPPLY SYSTEM

(71) Applicant: MetaPWR Electronics Co., Ltd., Shanghai (CN)

(72) Inventors: Mingzhun ZHANG, Shanghai (CN); Xiaoni Xin, Shanghai (CN); Yahong Xiong, Shanghai (CN)

(73) Assignee: MetaPWR Electronics Co., Ltd., Shanghai (CN)

(21) Appl. No.: 19/344,535

(22) Filed: Sep. 30, 2025

(30) Foreign Application Priority Data
Sep. 30, 2024 (CN) 202411385244.6
Nov. 1, 2024 (CN) 202411551010.4
Jan. 24, 2025 (CN) 202510117850.8
Mar. 3, 2025 (CN) 202510244202.9
Apr. 22, 2025 (CN) 202510506575.9
Aug. 26, 2025 (CN) 202511202169.X

(51) Int. Cl. H01F 27/28; H01F 27/24; H02M 3/155

(52) U.S. Cl. CPC H01F 27/28; H01F 27/24; H02M 3/155

(57) ABSTRACT

The present application discloses an N-phase TLVR integrated inductor, a multi-phase module, an IPM having a small parasitic inductance, and a power supply system of a semiconductor chip. The integrated inductor and IPM constitute a multi-phase module and a power supply system of a semiconductor chip. The N-phase integrated inductor is provided with a copper sheet.

### CROSS-REFERENCE TO RELATED APPLICATION

This application claims the priority benefit of China application serial no. CN202411385244.6 filed on Sep. 30, 2024, China application serial no. CN202411551010.4 filed on Nov. 1, 2024, China application serial no. CN202510117850.8 filed on Jan. 24, 2025, China application serial no. CN202510244202.9 filed on Mar. 3, 2025, China application serial no. CN202510506575.9 filed on Apr. 22, 2025, China application serial no. CN202511202169.X filed on Aug. 26, 2025. The entirety of each of the above-mentioned patent applications is hereby incorporated by reference herein and made a part of this specification.

### BACKGROUND

### Description of Related Art

In recent years, with the development of technologies such as data center, artificial intelligence, and supercomputers, more and more powerful ASICs are used to obtain applications, such as CPU, GPU, TPU, NPU, ML, AI accelerator, network switch, server, etc. and they consume a large amount of current, such as thousands of amperes, and the power requirements thereof fluctuate rapidly. This load is traditionally supplied using a multi-phase voltage regulator (VR). In order to keep up with the increase in load current and bandwidth, the number of phases of the VR and its output decoupling capacitor are increased. These approaches improve the transient response of a conventional VR to some extent; however, due to its larger output impedance, the space occupied by the decoupling capacitor, and the distance between the decoupling capacitor and the load, the traditional VR achieves a performance limit in transient response. Other techniques of improving conventional VR, such as increasing switching frequency and/or decreasing inductance of inductors, improve transient response, but at the expense of reduced efficiency. The anti-coupling inductance technology has a relatively low leakage inductance, and therefore has a relatively fast transient response. In addition, the reverse coupling inductor has a relatively high steady-state equivalent inductance, which is beneficial to the improvement of efficiency. That is, the anti-coupling inductance technology can meet the requirements of transient performance, and can also improve the efficiency. Therefore, the anti-coupling technology is a technical mean of a VR design. However, the multi-phase coupled inductor comprises a plurality of windings, and the plurality of windings physically need to be coupled to each other, so the manufacturing difficulty is large; the application is not flexible enough; and the Trans-inductor voltage regulator (hereinafter referred to as TLVR) technology can realize coupling of multiple mutually independent inductors with no coupling relationship in a physical manner by means of auxiliary windings; to solve the difficulty of manufacturing multi-phase coupled inductors; in addition, the multi-phase coupled inductor has the performance of multi-phase coupled inductor; therefore, it is a design hotspot in the field. The structure of the TLVR inductor increases the auxiliary winding, so that the original magnetic circuit of the main winding becomes longer. Therefore, different topologies have different effects on the performance of the VRM module. In addition, the TLVR module is configured in a system application, in different topologies, the dynamic performance of the TLVR module is different. The present application is based on the benefits and difficulties of the TLVR, the solution of the two-phase and multi-phase TLVR modules and the solution of the TLVR module on the system mainboard are provided.

### SUMMARY

In view of the above, one of the objectives of the application is to provide an N-phase trans-inductor voltage regulator (TLVR) integrated inductor, where N is a positive integer greater than 1, characterized by comprising:
a magnetic core, N sets of winding assemblies, a power electrical connector assembly, N auxiliary winding electrical connectors, a metal sheet and a signal electrical connector;
the magnetic core comprises a top surface, a bottom surface, a first side surface, a second side surface, a third side surface and a fourth side surface; the magnetic core is provided with N magnetic core windows, and the magnetic core window penetrates from the top surface to the bottom surface;
the winding assembly comprises a main winding and an auxiliary winding; the main winding and the auxiliary winding are electrically isolated, the winding assembly is arranged in the magnetic core window, and the main winding and the auxiliary winding are coupled to each other;
the power electrical connector assembly comprises at least one first power electrical connector and at least one second power electrical connector; the current directions of the first power electrical connector and the second power electrical connector are opposite; the power electrical connector assembly is disposed on the second side surface and/or the fourth side surface of the magnetic core;
the auxiliary winding electrical connector is disposed on the first side surface and/or the third side surface of the magnetic core;
the metal sheet is at least partially disposed on a side surface of the magnetic core, and is located between the magnetic core and the power electrical connector assembly or the auxiliary winding electrical connector; the metal sheet and at least one potential in the power electrical connector assembly are electrical isolated, and the metal sheet and the auxiliary winding electrical connector are electrical isolated;
the signal electrical connector is disposed on the first side surface and/or the third side surface of the magnetic core.

Preferably, the second side surface is provided with two first power electrical connectors and two second power electrical connectors, and the first electrical connector and the second electrical connector are arranged in a staggered manner; and the fourth side surface is provided with two first power electrical connectors and two second power electrical connectors, and the first electrical connector and the second electrical connector are arranged in a staggered manner.

Preferably, the second side surface is provided with two first power electrical connectors, and one second power electrical connector disposed between the two first power electrical connectors; and the fourth side surface is provided with two first power electrical connectors, and one second power electrical connector disposed between the two first power electrical connectors.

Preferably, a second power electrical connector is disposed on the first side surface and/or the third side surface of the magnetic core, and the second power electrical connector is disposed between the auxiliary winding electrical connectors.

Preferably, the signal electrical connector is an PCB board parallel to the third side surface.

Preferably, the winding assembly further comprises an insulating medium, the insulating medium is disposed between the main winding and the auxiliary winding, and the main winding and the auxiliary winding are electrically isolated by the insulating medium.

Preferably, the winding assembly is provided with a winding step, the winding step comprises a main winding step, an auxiliary winding step and an insulating medium step, the main winding step, the auxiliary winding step and the insulating medium step have the same height.

Preferably, the magnetic core window is provided with a window step corresponding to the winding step.

Preferably, the main winding, the auxiliary winding and the insulating medium are all in “T”-shaped, and the magnetic core window is also in “T”-shaped.

Preferably, the winding assembly is provided with a winding step, the winding step comprises a main winding step and an auxiliary winding step, the main winding step and the auxiliary winding step have the same height, the magnetic core window is correspondingly provided with a window step, the window step is provided with a protrusion, the protrusion is located between the main winding and the auxiliary winding, and is used for limiting and insulating the main winding and the auxiliary winding.

Preferably, the signal electrical connector comprises two rows of signal pins, and the number of signal pins close to one side of the magnetic core is less than the number of signal pins on the side away from the magnetic core.

Preferably, the top of the magnetic core is provided with a second power electrical connector.

Preferably, the magnetic core comprises at least one row of magnetic columns, and the length of the magnetic columns in the same row gradually decreases from the two sides to the middle.

Preferably, a top surface and/or a bottom surface of the magnetic core is provided with a groove.

Preferably, the shortest distance between the side wall or the bottom surface of the groove and the adjacent winding is greater than or equal to 0.5 mm.

An N-phase trans-inductor voltage regulator (TLVR) integrated inductor, where N is a positive integer greater than 1, characterized by comprising:
a magnetic core, N sets of winding assemblies, a first power electrical connector, two electrical connector layers, a metal sheet and a signal electrical connector;
the magnetic core comprises a top surface, a bottom surface, a first side surface, a second side surface, a third side surface and a fourth side surface; the magnetic core is provided with N magnetic core windows, and the magnetic core window penetrates from the top surface to the bottom surface;
the winding assembly comprises a main winding and an auxiliary winding; the main winding and the auxiliary winding are electrically isolated, the winding assembly is arranged in the magnetic core window, and the main winding and the auxiliary winding are coupled to each other;
the electrical connector layer is disposed on the first side surface and the third side surface opposite to each other or the second side surface and the fourth side surface opposite to each other, and the first power electrical connector and the signal electrical connector are disposed on the first side surface and the third side surface opposite to each other respectively or are disposed on the second side surface and/or the fourth side surface at the same time;
the electrical connector layer comprises at least one second power electrical connector and at least one auxiliary winding electrical connector;
the metal sheet is at least partially disposed on a side surface of the magnetic core, and is located between the magnetic core and the electrical connector layer or the first power electrical connector, the metal sheet is electrically isolated from at least one potential in the electrical connector layer, and the metal sheet is electrically isolated from the first power electrical connector.

Preferably, the top surface and/or the bottom surface of the magnetic core is provided with a groove.

Preferably, the inner side wall of the magnetic core window is provided with a protrusion for physically isolating the main winding and the auxiliary winding.

Preferably, a length of the protrusion is less than or equal to a depth of the magnetic core window.

An N-phase TLVR integrated inductor, where N is a positive integer greater than 1, characterized by comprising:
a magnetic core, N sets of winding assemblies, an electrical connector layer, a second power electrical connector, and a signal electrical connector assembly;
the magnetic core comprises a top surface, a bottom surface, a first side surface, a second side surface, a third side surface and a fourth side surface; the magnetic core is provided with N magnetic core windows, and the magnetic core window penetrates from the top surface to the bottom surface;
the winding assembly comprises a main winding and an auxiliary winding; the main winding and the auxiliary winding are electrically isolated, the winding assembly is arranged in the magnetic core window, and the main winding and the auxiliary winding are coupled to each other;
the second power electrical connector is attached to the magnetic core, the electrical connector layer and the signal electrical connector assembly are disposed on the outer side of the second power electrical connector, and a sheet-like insulating material is provided between the second power electrical connector and the electrical connector layer or the signal electrical connector assembly;
the electrical connector layer comprises a first power electrical connector and an auxiliary winding electrical connector.

Preferably, the second power electrical connector is disposed on the first side surface, the second side surface, the third side surface, and the fourth side surface of the magnetic core, the electrical connector layer is disposed on the first side surface and the third side surface of the magnetic core, and the signal electrical connector assembly is disposed on the second side surface and the fourth side surface of the magnetic core.

Preferably, the N magnetic core windows of the magnetic core are arranged in a row along the second side surface or the fourth side surface, and the winding assembly is arranged in a row along the second side surface or the fourth side surface.

Preferably, the second power electrical connector is disposed on the second side surface and the fourth side surface of the magnetic core, the electrical connector layer is disposed on the second side surface of the magnetic core, and the signal electrical connector layer is disposed on the fourth side surface of the magnetic core.

Preferably, the second power electrical connector is a metal sheet, and each metal sheet extends to the top surface and the bottom surface of the magnetic core to form a pin.

A multi-phase module, where N is a positive integer greater than 1, characterized by comprising:
a top assembly, a middle assembly and a bottom assembly;
the top assembly comprises a top substrate, N IPMs, at least one input capacitor, and other passive elements;
the middle assembly comprises an N-phase TLVR integrated inductor, the N-phase TLVR inductor comprising a magnetic core, N sets of winding assemblies, a plurality of electrical connectors and a metal sheet, the magnetic core comprising a top surface, a bottom surface, a first side surface, a second side surface, a third side surface and a fourth side surface, the winding assembly comprising a main winding; the main winding and the plurality of electrical connectors are respectively electrically connected to the N IPMs by means of a top substrate; the metal sheet is at least partially disposed on a side surface of the magnetic core and is attached to the magnetic core, the electrical connector is disposed on an outer side of the metal sheet, and the metal sheet is electrically isolated from the electrical connector; the plurality of electrical connectors comprise a first power electrical connector or comprise a first power electrical connector and a second power electrical connector;
the bottom assembly comprises a bottom substrate, and at least one capacitor disposed on the bottom substrate, the bottom substrate comprises a first side, a second side, a third side, and a fourth side.

Preferably, the metal sheet extends toward the top surface and the bottom surface of the magnetic core to form a pin, and the metal sheet is a second power electrical connector.

Preferably, the winding assembly further comprising N auxiliary windings; the magnetic core is provided with N magnetic core windows, and the magnetic core window penetrates from the top surface to the bottom surface; the main winding and the auxiliary winding are electrically isolated; the winding assembly is disposed in the magnetic core window, and the main winding and the auxiliary winding are coupled to each other.

Preferably, the bottom assembly further comprises a plurality of copper pillars and a second plastic package, and the copper pillars are disposed on the bottom substrate;
the copper pillar is used for electrically connecting the main winding and the bottom substate, for electrically connecting the electrical connector and the bottom substrate;
the second plastic package encapsulates the copper pillars and the capacitors together, the top surface of the second plastic package is provided with electrical connection pins.

Preferably, the multi-phase module, further comprising an auxiliary winding; the magnetic core is provided with N magnetic core windows, and the magnetic core window penetrates from the top surface to the bottom surface; each main winding and one auxiliary winding are coupled to each other and are disposed in a same magnetic core window; the electrical connector further comprises an auxiliary winding electrical connector; the metal sheet is electrically isolated from the auxiliary winding electrical connector; an electrical wiring is provided on the top surface of the second plastic package; and the electrical wiring is used for assisting in electrical connection of the auxiliary winding loop.

Preferably, a bottom surface of the bottom substrate is provided with a pin, the pin is in the form of an i-row*j-column matrix, the pin comprises a VIN pin, a GND pin, a Vo pin and a Sig pin, the Sig pin is located in the first row and/or the i-th row, the GND pin and the VIN pin are located in a region of a second row to an (i-1)-th row or to an i-th row adjacent to the second side edge and the fourth side edge, and the GND pin and the VIN pin are staggered; the Vo pin and the GND pin are disposed in a region surrounded by the Sig pin and the VIN pin, and the Vo pin and the GND pin are staggered.

Preferably, a bottom surface of the bottom substrate is provided with a pin, the pin is in the form of an i-row*j-column matrix, the pin comprises a VIN pin, a GND pin, a Vo pin and a Sig pin, the Sig pin is located in the first row and/or the i-th row, the GND pin and the VIN pin are located in a region of a second row to an (i-1)-th row or to an i-th row adjacent to the second side edge and the fourth side edge, and the GND pin and the VIN pin are alternately arranged; a Vo pin and a GND pin are disposed in a region surrounded by the Sig pin and the VIN pin, and the Vo pin and the GND pin are staggered; the bottom surface of the bottom substrate is further provided with a function extension pin TLG pin and a TLC pin.

Preferably, the TLG pin and the TLC pin are arranged opposite to each other, symmetrically arranged or centrally arranged.

Preferably, a top surface of the top substrate is provided with a capacitor and a heat dissipation metal block, the heat dissipation metal block and the IPM are correspondingly arranged, and projections of the IPM and the corresponding heat dissipation metal block on the top surface of the top substrate at least partially overlap.

Preferably, a heat dissipation metal block is disposed above the IPM, the heat dissipation metal block is thermally connected to a corresponding IPM unit respectively, a plastic package is disposed above the top substrate, the plastic package encapsulates the device disposed above the top substrate, and an upper surface of the heat dissipation metal block is exposed from the plastic package.

Preferably, the IPM is a bare silicon wafer; the top assembly further comprises a first plastic package, the first plastic package encapsulates the bare silicon wafer into a whole, and an upper surface of the bare silicon wafer is exposed from the first plastic package.

Preferably, a bottom surface of the bottom substrate is provided with a pin, and the pin is configured as an LGA pin arranged in P*Q matrix, wherein P and Q are both natural numbers greater than 1; the pin includes a VIN pin, a GND pin, a Vo pin, and a Sig pin, the Sig pin is disposed adjacent to a third side of the bottom substrate, the VIN pin is disposed adjacent to the Sig pin, and the Vo pin and the GND pin are staggered.

Preferably, the VIN pin is disposed at the first row and two ends of the second row adjacent to the third side, the VIN pin is disposed in the middle of the second row and the middle of the third row, and the GND pins are disposed at two ends of the third row; the Vo pin includes a plurality of Vo pin rows, the GND pin includes a plurality of GND pin rows, the Vo pin row and the GND pin row are arranged in the fourth row to the Pth row, and the Vo pin row and the GND pin row are staggered.

Preferably, the multi-phase module, further comprising an auxiliary winding; the magnetic core is provided with N magnetic core windows, and the magnetic core window penetrates from the top surface to the bottom surface; each of the main windings and one auxiliary winding are coupled to each other and are disposed in the same magnetic core window; the electrical connector further comprises an auxiliary winding electrical connector; the pin further comprises a function extension pin TLG pin and a TLC pin, the TLG pin and the TLC pin are arranged adjacent to the second side and the fourth side, and the TLG pin and the TLC pin are arranged in an area where any m adjacent Vo pins and GND pins in the first column and the Q column are located, wherein m is a natural number greater than 1.

Preferably, all the Vo pins are short-circuited to form an output network.

Preferably, the Vo pin comprises at least two regions, the Vo pins in each region are short-circuited to form an output network, and the output networks independently supply power to a load or supply power to a load after being connected in parallel.

A multi-phase module, comprising:
M top assemblies, M middle assemblies and a bottom assembly;
each of the top assemblies comprises a top substrate, N IPMs, M and N both being positive integers greater than 1;
the middle assembly comprises M N-phase integrated inductors; each of the N-phase integrated inductors comprises a magnetic core, an N-phase main winding and a plurality of electrical connectors; the magnetic core comprises a top surface and a bottom surface; the N-phase main winding and the plurality of electrical connectors are provided with pins on the top surface and the bottom surface of the magnetic core;
an N-phase main winding and a plurality of electrical connectors in each of the N-phase integrated inductors are respectively electrically connected to the N IPMs by means of the top substrate;
the bottom assembly, comprising at least one bottom substrate, and at least one capacitor provided on the bottom substrate, wherein M * N main windings and a plurality of electrical connectors in the middle assembly are electrically connected to the capacitors on the bottom substrate and the bottom substrate;
the bottom substrate comprises a first side, a second side, a third side, and a fourth side.

Preferably, the multi-phase module, comprising a controller, wherein the controller is disposed on an upper surface of the bottom substrate, and the controller is configured to drive and control the multi-phase module.

Preferably, the multi-phase module further comprises a plurality of bottom substrate pins, and the plurality of bottom substrate pins are disposed on a lower surface of the bottom substrate.

Preferably, the magnetic core further comprises a first side surface, a second side surface, a third side surface and a fourth side surface; the magnetic core is provided with N magnetic core windows, and the magnetic core window penetrates from the top surface to the bottom surface; the plurality of electrical connectors comprise a power electrical connector assembly, N auxiliary winding electrical connectors, and a signal electrical connector; each of the N-phase integrated inductors further comprises an N-phase auxiliary winding; each of the main windings is coupled to and electrically isolated from a corresponding auxiliary winding, and the mutually coupled main winding and auxiliary winding are disposed in one window of the magnetic core; and the electrical connector is disposed on at least one side surface of the magnetic core.

An IPM, comprising at least one minimum power unit, wherein the minimum power unit comprises a first power sub-unit and a second power sub-unit arranged in parallel; current directions in the first power sub-unit and the second power sub-unit are opposite, and magnetic fluxes generated by the current cancel each other; the first power sub-unit and the second power sub-unit both comprise at least one pair of switching devices, the switching device comprises a high-side switching device and a low-side switching device, and the high-side switching device and the low-side switching device are electrically connected to SW points.

Preferably, the arrangement direction of the switch device in the first power sub-unit is 180° from the arrangement direction of the switch device in the second power sub-unit, and the SW point of the first power sub-unit and the SW point of the second power sub-unit are disposed on the same horizontal line and are electrically connected together.

Preferably, the IPM, comprising a plurality of minimum power units connected in series and/or in parallel, wherein each high-side switching device is horizontally adjacent to a low-side switching device with opposite current directions, each low-side switching device horizontally adjacent to a high-side switching device with opposite current directions, and the SW points of each pair of switching devices are electrically connected together.

Preferably, the IPM, further comprising a Sig pin row, a power pin row, and a SW pin row, wherein the power pin row comprises a VIN pin and a GND pin arranged in a staggered manner; the Sig pin row is arranged adjacent to one side edge of the IPM, and the power pin row and the SW pin row are sequentially arranged at intervals in the same direction.

Preferably, a high frequency filter capacitor is provided near the VIN pin and the GND pin.

Preferably, a high-frequency filter capacitor is disposed between the VIN pin and the GND pin.

Preferably, the IPM, further comprising a VIN pin, a GND pin, a SW pin, and a Sig pin, wherein the Sig pin, the VIN pin, and the GND pin are sequentially arranged in the same direction, the VIN pin is elongated, the GND pin is in a horizontal “E” shape, and comprises three vertical portions and a horizontal portion, the SW pin is located between two adjacent vertical portions, the VIN pin and the GND pin surround the SW pin, and the area of the GND pin is greater than the area of the VIN pin.

Preferably, the IPM, further comprising a logic unit, a synchronization enable pin, a PWM input pin, and N PWM output pins, the IPM comprises a main IPM and a slave IPM, the main IPM receives an input control signal and generates N frequency division control signals, one of the frequency division control signals is used for controlling the main IPM, and the remaining N-1 frequency division control signals are used for controlling N-1 slave IPM.

Preferably, the synchronization enable pin comprises an “enable” state and a “disable” state, and when the synchronous enable pin is in the “enable” state, the frequency of the N frequency division control signals is 1/N of the frequency of the input control signal, and the phase is 360/N degrees in sequence; when the synchronization enable pin is in the “disable” state, the frequency of the N frequency division control signals is the same as the frequency of the input control signal.

Preferably, the main IPM and the N-1 slave IPMs each comprise a current sampling signal, and the N current sampling signals are aggregated into a total sampling signal in the IPM.

A power supply system, wherein the power supply system supplies power to a semiconductor chip, and comprises:
a load mainboard, an IBC converter, M N-phase VR modules, and at least one controller, wherein M and N are both natural numbers greater than 1;
the load mainboard comprises a first plane and a second plane opposite to the first plane;
the IBC converter and the M N-phase VR modules and the semiconductor chip are arranged on the load mainboard;
the controller outputting a plurality of sets of PWM signals, each set of PWM signals comprising N PWMs having a phase difference of 360/N;
the controller simultaneously drives at least one VR module of the M N-phase VR modules by means of a set of PWM signals.

Preferably, each of the VR modules comprises N auxiliary windings and N auxiliary electrical connectors; the M N-phase VR modules are arranged around the semiconductor chip, and the M N-phase VR modules are connected end to end to form an M*N-phase VR loop; or, the N-phase VR modules located on two adjacent sides of the semiconductor chip are connected in series to form two M*N/2-phase VR loops, and M is an even number.

Preferably, each of the VR modules comprises N auxiliary windings and N auxiliary electrical connectors; the M N-phase VR modules are disposed on two sides of the semiconductor chip, the M/2 N-phase VR modules on each side are connected in series to form an M*N/2-phase TLVR loop, or half of the N-phase VR modules on one side and half of the N-phase VR modules on the other side are connected end-to-end in series to form an M*N/2-phase TLVR loop, and the other half of the N-phase VR modules on one side and the other half of the N-phase VR modules on the other side are connected end-to end in series to form an M*N/2-phase TLVR loop.

Preferably, the set of PWM signals simultaneously drive an N-phase circuit of the M N-phase VR modules; the N-phase circuit is from a plurality of different N-phase VR modules, and the plurality of VR modules are located on the same side or on a different side of the semiconductor chip.

Preferably, the IBC converter and the M N-phase VR modules and the semiconductor chip are disposed on a same plane of the load mainboard.

Preferably, the semiconductor chip is disposed on a first plane of the load mainboard; the IBC converter and the M N-phase VR modules are disposed on a second plane of the load mainboard; and the M N-phase VR modules are disposed in a projection range of the semiconductor chip.

Preferably, the M N-phase VRs are disposed on one adapter board or share one bottom substrate to form a VR module, and the VR module is disposed in a projection range of the semiconductor chip.

Compared with the prior art, the application has the following beneficial effects:
(1) by means of a TLVR technology, a multi-phase VRM module has a smaller dynamic inductance so as to meet the requirements of rapid change in load current;
(2) implementing multi-phase coupling characteristics by means of TLVR technology, reducing the manufacturing difficulty of traditional multi-phase coupling inductors;
(3) according to the present application, a TLVR technology is implemented on the basis of two-phase inductance, which not only solves the difficulty of manufacturing a traditional multi-phase coupling inductor, but also has a more flexible application mode; moreover, according to an application scenario, a VRM module having any phase-coupled inductor can be flexibly configured;
(4) the coupling between the main auxiliary windings of the two-phase inductor in the present application can be fully coupled, that is, the coupling coefficient is approximately equal to 1; the arrangement of the auxiliary winding electrical connector provides a certain inductance, that is, equivalent to integrating a certain compensation inductance, and the integrated compensation inductance can adjust the magnitude of the compensation inductance by adjusting the height of the provided shielding layer, so as to cope with the requirements of different application scenarios for different dynamic inductance and steady-state inductance; the space for compensating the inductance is provided on the client main board;
(5) in the inductor structure of the present application, the main winding is connected to the switch device on the top surface, and is connected to the load on the bottom surface, that is, the TLVR technology is implemented in the inductance of the double-sided inductor welding Pad; while better dynamic performance is achieved by means of the TLVR technology, the switching device on the top surface is closer to the heat sink; the heat dissipation capability of the VRM module is enhanced; and the power density of the VRM module is improved.

### BRIEF DESCRIPTION OF THE DRAWINGS

FIG. 1 is a schematic diagram of a circuit structure of an N-phase TLVR inductor module;

FIG. 2 is a schematic structural diagram of the equivalent circuit of FIG. 1;

FIG. 3 is another schematic structural diagram of an N-phase TLVR inductor module;

FIG. 4 is a schematic structural diagram of a two-phase TLVR module;

FIG. 5 is an exploded view of the top assembly;

FIG. 6A is an exploded view of a middle component; FIG. 6B is a structural exploded view of another structure of the middle component;

FIG. 7 is an exploded view of the bottom assembly;

FIG. 8 is a schematic structural diagram of an auxiliary winding loop;

FIG. 9 and FIG. 10 are schematic diagrams of a pin of a bottom substrate;

FIG. 11A is a schematic connection diagram of an embodiment of a magnetic core and a winding assembly;

FIG. 11B to FIG. 11D are schematic connection diagrams of another embodiment of a magnetic core and a winding assembly;

FIG. 11E to FIG. 11G are schematic connection diagrams of another embodiment of a magnetic core and a winding assembly;

FIG. 12 is a simplified equivalent model of a BUCK circuit;

FIG. 13 is a schematic diagram of an IPM structure;

FIG. 14 is a schematic circuit diagram of an IPM;

FIG. 15 to FIG. 17 are schematic diagrams of a pin of a bottom assembly;

FIG. 18 is a schematic structural diagram of an eight-phase TLVR module;

FIG. 19 is an exploded view of the top assembly of the present embodiment;

FIG. 20 is an exploded view of a middle assembly of the present embodiment;

FIG. 21 is an exploded diagram of an integrated inductor according to an embodiment;

FIG. 22 is an exploded schematic diagram of a bottom assembly according to an embodiment;

FIG. 23 to FIG. 26 are schematic diagrams of a pin map of bottom surface;

FIG. 27 is a schematic diagram of a simulation result;

FIG. 28 to FIG. 31 are schematic diagrams of magnetic flux generated by currents in the first main winding, the second main winding, the third main winding and the fourth main winding;

FIG. 32 is a schematic diagram of a power supply system for a semiconductor chip;

FIG. 33 is a schematic structural diagram of a power supply system for a semiconductor chip;

FIG. 34 is another schematic structural diagram of a power supply system for a semiconductor chip;

FIG. 35 is another schematic structural diagram of a power supply system for a semiconductor chip;

FIG. 36 is another schematic structural diagram of a power supply system for a semiconductor chip;

FIG. 37A is another schematic structural diagram of a power supply system for a semiconductor chip;

FIG. 37B is another schematic structural diagram of a power supply system for a semiconductor chip;

FIG. 38 is a schematic diagram of a power supply vertical power supply structure for a semiconductor chip;

FIG. 39 is another schematic structural diagram of a power supply vertical power supply structure for a semiconductor chip;

FIG. 40 is another schematic structural diagram of a power supply vertical power supply structure for a semiconductor chip;

FIG. 41 is a schematic structural diagram of a four-phase TLVR module;

FIG. 42 is an exploded schematic diagram of a four-phase TLVR module;

FIG. 43 is an exploded schematic diagram of a middle assembly structure;

FIG. 44A is another schematic structural diagram of a four-phase TLVR module;

FIG. 44B is another schematic structural diagram of a four-phase TLVR module;

FIG. 44C is an exploded schematic diagram of FIG. 44B;

FIG. 45A to FIG. 45D are another embodiment of a four-phase TLVR module;

FIG. 46A to FIG. 46C are another embodiment of a four-phase TLVR module;

FIG. 47A to FIG. 47J are another embodiment of a four-phase TLVR module;

FIG. 48A to 48D are control strategies of a four-phase module;

FIG. 49A is a schematic structural diagram of a multi-phase TLVR module;

FIG. 49B and FIG. 49C are another schematic structural diagram of a multi-phase module;

FIG. 50A and FIG. 50B are schematic structural diagrams of a multi-phase module.

One of the cores of the present application is to provide a carrier board having a high integration level and a power module.

Technical solutions in the embodiments of the present disclosure will be clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

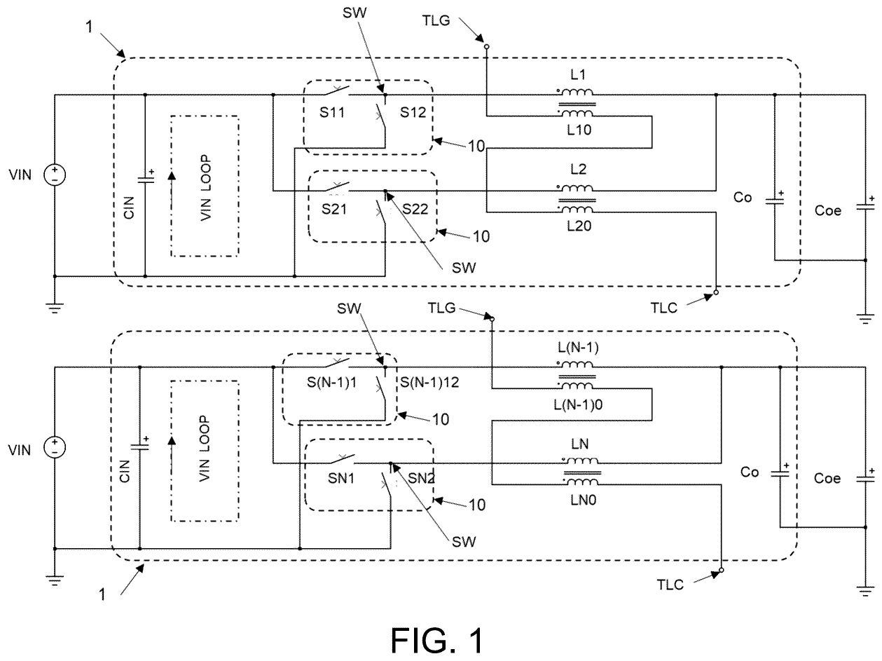

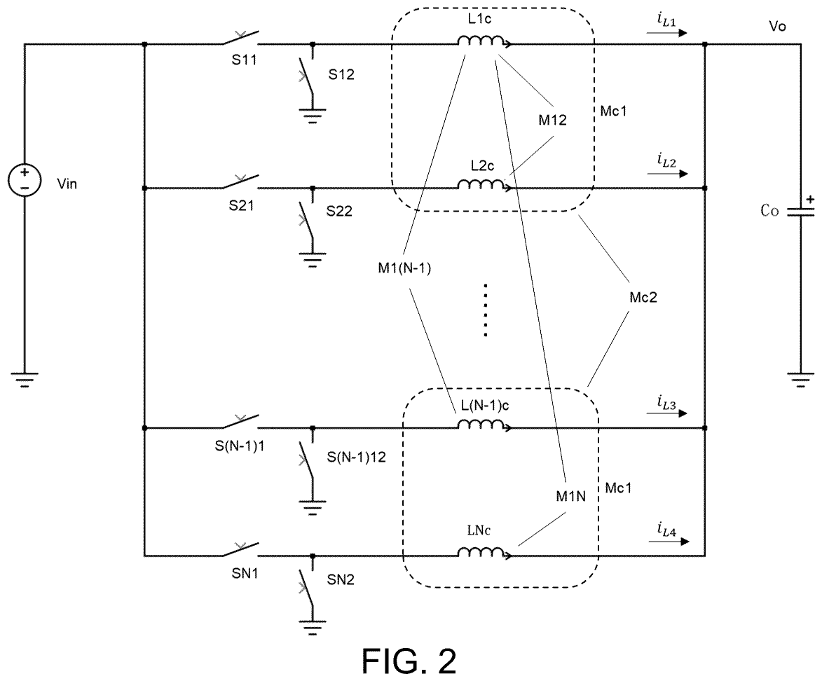

FIG. 1 is a schematic structural diagram of a VRM circuit including an N-phase TLVR integrated inductor according to an embodiment. As shown in FIG. 1, the circuit comprises: a plurality of main windings L1, L2, L3, L4 . . . Ln and auxiliary windings L10, L20, L30, L40 . . . Ln0. The main windings are not coupled with each other and are independent of each other (Herein, weak coupling, such as coupling coefficient being less than 0.3, is treated as uncoupled), while L10, L20, L30, L40 . . . Ln0 serve as auxiliary windings and each being at least partially coupled with L1, L2, L3, L4 . . . Ln, respectively, L10, L20, L30, L40 . . . and Ln0 are connected end to end. Therefore, independent main windings L1, L2, L3, L4 . . . Ln which have no coupling relationship with each other are equivalent to the N-phase opposite coupling inductance that any two phases-have coupling relationship shown in FIG. 2.

With reference to FIG. 1, a single two-phase VRM module 1 comprises an input capacitor Cin, two IPMs 10 (IPM, which is an abbreviation for Intelligent Power Modules, and is an integrated power switching device (such as a power module including field effect transistors MOSFET and other internal logic thereof, controlling circuit, detecting circuit and protecting circuit)), two main windings, two auxiliary windings respectively coupled to the two main windings, and an output capacitor Co; wherein the input capacitor Cin is connected in parallel to the VIN; the two IPMs 10 are connected in parallel, one end of the IPM 10 is connected to the positive end of the input end VIN, and the other end is grounded; the main winding of the inductor is connected to the SW terminal of the IPM 10; the two auxiliary windings are connected in series, one end of one auxiliary winding is connected to the TLVR function extension pin TLG, and one end of the other auxiliary winding is connected to the TLVR function extension pin TLC, and the TLG pins and the TLC pins of N/2 two-phase VRMs are connected in series to form an N-phase auxiliary winding loop to implement a power supply scheme with the N-phase TLVR function. The output capacitor Co and the output terminal of the inductor and ground are connected together to provide energy to the load.

The N/2 two-phase VRM modules 1 can obtain an N-phase power supply solution having a TLVR function by means of series connection, for example, by means of connecting a TLVR function extension pin TLC of a first VRM and a TLVR function extension pin TLG of a second VRM; connecting a TLVR function extension pin TLC of the second VRM and a TLVR function extension pin TLG of a third VRM; and so on, a TLVR function extension pin TLC of an N/2-th VRM being connected to a TLVR function extension pin TLG of the first VRM, so as to implement an N-phase TLVR auxiliary winding loop and an N-phase TLVR function. Furthermore, the auxiliary winding loop can be provided with a compensation inductor as required.

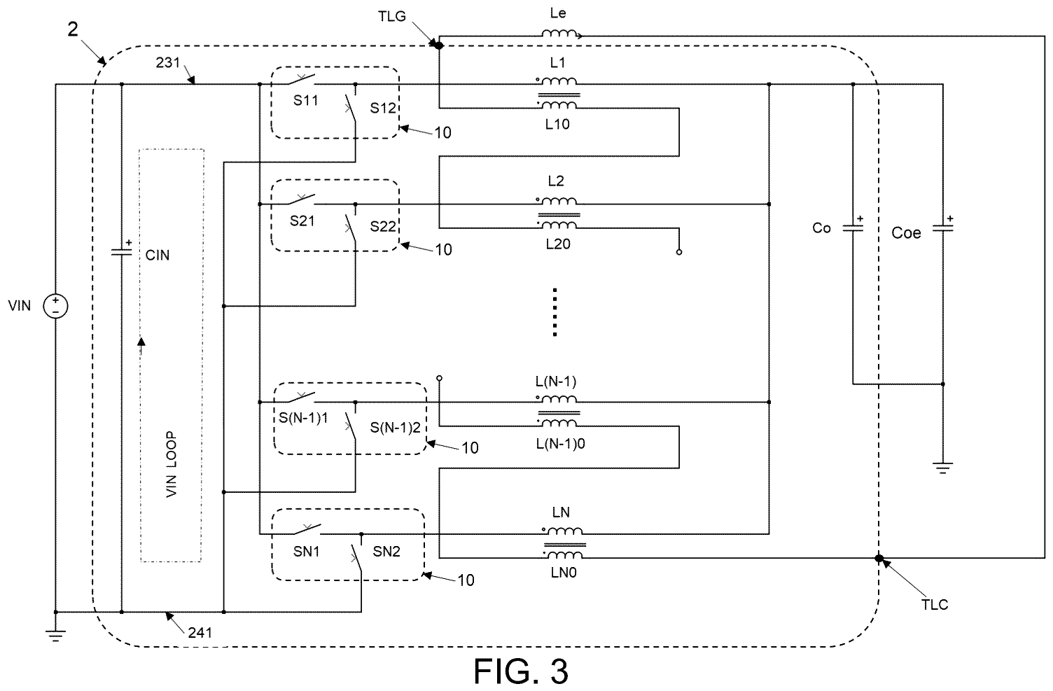

FIG. 3 is a schematic structural diagram of another VRM circuit including an N-phase TLVR inductor. The N-phase TLVR inductors in the circuit are integrated together to form an N-phase inductor unit. A compensation inductor Le is further provided in the loop of the auxiliary winding, one end of the compensation inductor Le is connected to the TLG pin, and the other end is connected to the TLC pin.

The phase difference between two adjacent phases of the control PWM of the N-phase TLVR is 360/N degrees. When two-phase integrated TLVR modules are used to form an N-phase TLVR module, the phase differences between the two PWM signals in one two-phase VRM need to be set to 180 degrees, and the phases of the two two-phase VRMs needs to be set to be 360/N degrees different from each other, so as to achieve optimal TLVR performance.

The present application designs an N-phase TLVR module and a power supply system according to the above principles, where N is a positive integer greater than 1, and preferably, N is an even number.

### Embodiment 1

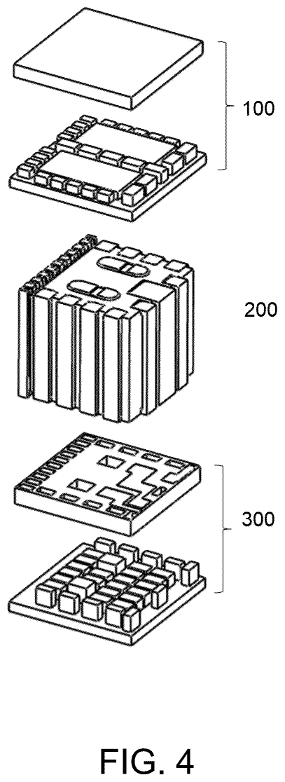

FIG. 4 is a schematic structural diagram of a two-phase TLVR module according to an embodiment. As shown in FIG. 4, the two-phase TLVR module includes a top assembly 100, a middle assembly 200, and a bottom assembly 300.

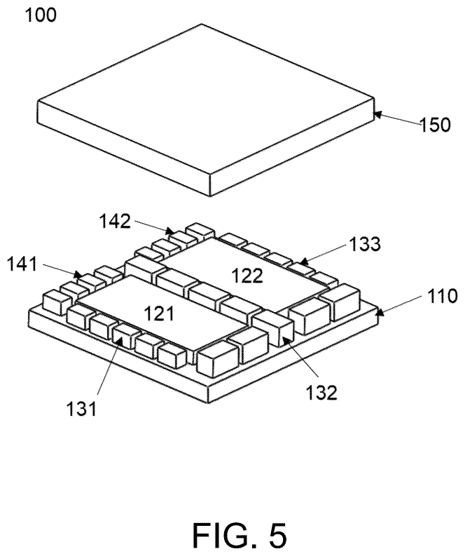

FIG. 5 shows a structural exploded view of the top assembly 100. As shown in FIG. 5, the top assembly 100 comprises a top substrate 110, a first IPM 121, a second IPM 122, an input capacitor 131/132/133, other passive elements 141/142 and a plastic package 150, wherein the input capacitors 131/132 are respectively provided on two sides of the top substrate (such as long sides of the top substrate 110), and the other passive elements 141/142 are arranged on the other two sides of the top substrate 110 (such as the two short sides of the top substrate 110), and the input capacitor 132 is arranged between the first IPM 121 and the second IPM 122, that is, the input capacitors 131/132/133 and the other passive elements 141/142 are substantially distributed around the first IPM 121 and the second IPM 122.

It should be noted that the arrangement manners of the input capacitor, the first IPM, the second IPM, and the other passive elements are merely illustrative and are not limited thereto.

In the present embodiment, both the first IPM 121 and the second IPM 122 are packaged by a CSP (Chip Scale Package), so as to reduce the footprint of the entire TLVR module, thereby improving the power density; The CSP packaged chip is packaged by plastic molding, i.e. the first IPM 121, the second IPM 122, the input capacitor 131/132/133 and the other passive elements 141/142 are welded on the top substrate 110, and then the elements on the substrate are molded with the plastic package 150 by means of a plastic packaging process, thereby ensuring that the element is free from the influence of the external environment and mechanical stress, and is safe and reliable.

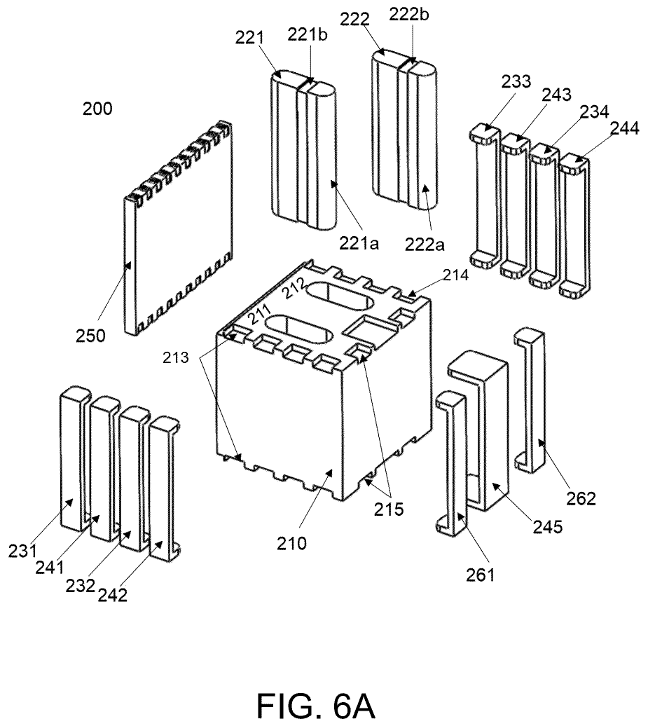

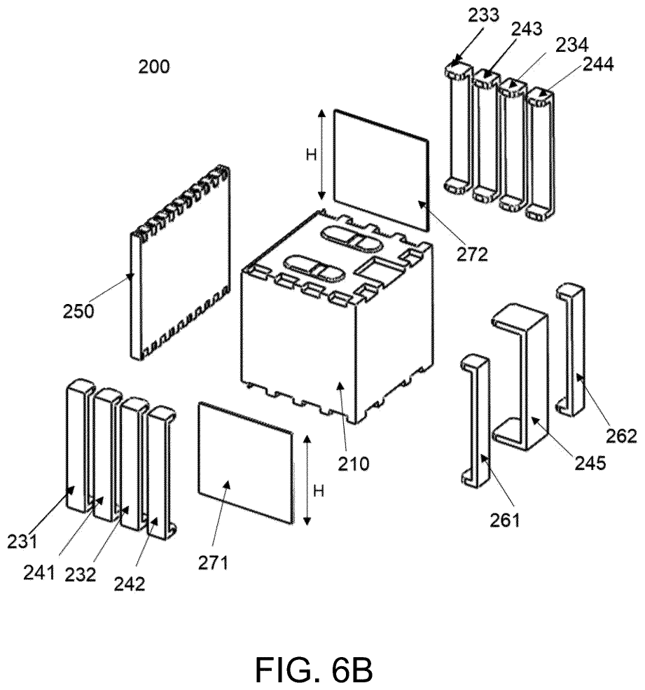

FIG. 6A shows a structural exploded view of the middle assembly 200. As shown in FIG. 6, the middle assembly 200 comprises a magnetic core 210, a first winding assembly, a second winding assembly, a first power electrical connector assembly, a second power electrical connector assembly, an auxiliary winding electrical connector 261/262, and a signal electrical connector 250. Wherein the first winding assembly comprises a first main winding 221, a first insulating medium 221b, and a first auxiliary winding 221a coupled to the first main winding 221, and the first insulating medium 221b is arranged between the first main winding 221 and the first auxiliary winding 221a, thereby achieving electrical isolation. Similarly, the structure of the second winding assembly is substantially identical to the first winding assembly, i.e. the second winding assembly comprises a second main winding 222, a second insulating medium 222b, and a second auxiliary winding 222a coupled to the second main winding 222, the second insulating medium 222b being arranged between the second main winding 222 and the second auxiliary winding 222a, thereby achieving electrical isolation. And the first main winding 221 and the second main winding 222 are relatively independent and have no coupling relationship (or the coupling coefficient is lower than 0.3);

The magnetic core 210 is a cuboid structure or a cube structure, and has six surfaces of a top surface, a bottom surface, a first side surface, a second side surface, a third side surface, and a fourth side surface, wherein the top surface and the bottom surface are disposed opposite to each other, the first side surface and the third side surface are disposed opposite to each other, the second side surface and the fourth side surface are disposed opposite to each other, the first side surface and the second side surface are close to each other, and the third side surface and the fourth side surface are close to each other. And corresponding elements are correspondingly arranged on the six surfaces:

On the top surface, a first window 211 and a second window 212 are provided, and both the first window 211 and the second window 212 penetrate the magnetic core 210, i.e. from the top surface to the bottom surface. and the first winding assembly is arranged in the first window 211, and the second winding assembly is arranged in the second window 212.

The first side surface of the magnetic core is correspondingly provided with an auxiliary winding electrical connector 261/262 for connecting the auxiliary winding, so that the auxiliary winding forms a loop to achieve a TLVR function.

Optionally, a second power electrical connector 245 is further provided on the first side surface, the second power electrical connector 245 is connected to the ground terminal, and is disposed between the auxiliary winding electrical connectors 261 and 262, thereby effectively reducing the direct current impedance of the second power electrical connector 245, reducing the direct current loss, and improving the efficiency. In addition, the second power electrical connector 245 is arranged in an arrangement between the auxiliary winding electrical connectors 261 and 262, which reduces the parasitic inductance value on the auxiliary winding electrical connector 261/262, thereby helping to reduce the dynamic inductance of the TLVR and improving the dynamic performance of the TLVR.

The second side surface of the magnetic core, correspondingly provided with a first power electrical connector assembly, the first power electrical connector assembly comprising a first power electrical connector 231/232 and a second power electrical connector 241/242, the first power electrical connector 231/232 is connected to the positive end of the input voltage, i.e. is connected to the VIN end, so as to transmit the input voltage to the VIN of the IPM through the load mainboard; the second power electrical connector 241/242 is connected to a ground terminal of the input voltage, that is, is connected to the GND end, so as to construct a return path of the input power; thus allowing the current direction in the first power electrical connector 231/232 to flow from the bottom surface to the top surface, and the current direction in the second power electrical connector 241/242 is from the top surface to the bottom surface, that is, the current directions in the first power electrical connector 231/232 and the second power electrical connector 241/242 are opposite; and the first power electrical connector 231/232 and the second power electrical connector 241/242 in the first power electrical connector assembly are staggered from each other, i.e. the second power electrical connector 241 is provided between the first power electrical connectors 231 and 232, the first power electrical connector 232 is provided between the second power electrical connectors 241 and 242. Through the configuration, the current direction in the first power electrical connector 231/232 and the current direction in the second power electrical connector 241/242 are opposite, and the generated magnetic fluxes cancel each other, so as to reduce the parasitic inductance value of the VIN-GND loop (such as the VIN Loop shown in FIG. 1); the resonant frequency between the input capacitor CIN and the parasitic inductance of the input power loop is much higher than the equivalent switching frequency of the VRM; the energy loss caused by resonance of the input loop and the influence on the working stability of the VRM are reduced or avoided, so as to improve the efficiency and reliability of the VRM module.

The third side surface of the magnetic core is correspondingly provided with a signal electrical connector 250 for electrically connecting the load mainboard and the IPM to drive and control IPM to work and detect the working status of the IPM.

Optionally, the signal electrical connector 250 is arranged parallel to the third side surface in a PCB vertical manner.

The fourth side face of the magnetic core, correspondingly provided with a second power electrical connector assembly; the second power electrical connector assembly comprises a first power electrical connector 233/234 and a second power electrical connector 243/244, the first power electrical connector 233/234 is connected to the positive end of the input voltage, that is, is connected to the VIN end, for transmitting the input voltage from the load mainboard to a VIN of the IPM; the second power electrical connector 243/244 is connected to a ground terminal of an input voltage, that is, is connected to a GND end, and is used as a return path for input power; the current direction in the first power electrical connector 233/234 flows from the bottom surface to the top surface; and the current direction in the second power electrical connector 243/244 is from the top surface to the bottom surface; therefore, the current directions in the first power electrical connector 233/234 and the second power electrical connector 243/244 are opposite; the first power electrical connector 233/234 and the second power electrical connector 243/244 in the second power electrical connector assembly are arranged in a staggered manner, that is, a second power electrical connector 243 is provided between the first power electrical connectors 233 and 234, and a first power electrical connector 234 is provided between the second power electrical connectors 243 and 244;

After the above configuration, the current directions in the first power electrical connector 233/234 and the second power electrical connector 243/244 are opposite, and the generated magnetic flux cancel each other so as to reduce the parasitic inductance value of the VIN-GND loop (such as the VIN Loop shown in FIG. 1). The resonant frequency between the input capacitor CIN and the parasitic inductance of the input power loop is much higher than the equivalent switching frequency of the VRM; the energy loss caused by resonance of the input loop and the influence on the working stability of the VRM are reduced or avoided, so as to improve the efficiency and reliability of the VRM module.

It should be noted that the manufacturing method of the winding assembly is not limited to being assembled into a winding assembly by using a copper post, and then assembling the winding assembly into a window of the magnetic core, or first pressing the copper post together with the plastic molding or encapsulant material together to form a winding assembly, and then assembling the winding assembly into a window of the magnetic core; or the winding assembly is manufactured by a PCB process, which is not limited herein.

FIG. 6B is another preferred embodiment of the middle assembly 200, and the difference between the embodiment shown in FIG. 6B and the embodiment shown in FIG. 6A is that in FIG. 6B, a copper sheet 271 is provided between the magnetic core 210 and the first power electrical connector assembly; a second copper sheet 272 is provided between the magnetic core 210 and the second power electrical connector assembly; and the copper sheets 271 and 272 usually can be assembled by bonding, and of course, a preferred mode is integrally press-fitted with the magnetic core 210 together, that is, the so-called copper-iron co-sintering method. An insulating layer can be provided between the copper sheet and the power electrical connector to achieve electrical isolation; the copper sheet can also be electrically connected to the first power electrical connector and electrically isolated from the second power electrical connector; or the copper sheet can also be electrically connected to the second power electrical connector and electrically isolated from the first power electrical connector; in summary, the copper sheet can be electrically isolated from the first and second power electrical connectors at the same time; or the copper sheet is electrically connected to one of the first power electrical connector or the second power electrical connector and electrically isolated from the other potential; the electrical isolation method is not limited to adding the insulating gasket, or using Coating glue on the surface of the magnetic core to achieve electrical isolation, that is, before the magnetic core is sprayed with Coating glue, the copper sheet is first provided, and the magnetic core and the copper sheet are wrapped together in the coating glue, then assembling the power electrical connector assembly. Wherein, the copper sheet can be replaced by other metal sheet with good electrical conductivity, such as aluminum sheet. In another preferred insulating manner, some insulating material particles with slightly larger diameters, such as glass beads having a diameter greater than 30 μm, glass powder, ceramic powder, epoxy resin powder, Al2O3 powder, etc. are added in the coating glue; and the distance between the copper sheet and the power electrical connector assembly is ensured by means of the insulating material particles, so as to ensure safe electrical isolation. After the copper sheets 271 and 272 are arranged, the magnetic flux generated by the current on the power electrical connector cuts the copper sheet and induces eddy current effects on the copper sheet, and the eddy currents on the copper sheet also generate magnetic flux, and cancel the magnetic flux generated by the current on the power electrical connector. Therefore, the parasitic inductance on the input power loop is further reduced, and the resonance frequency between the input capacitor CIN and the parasitic inductance of the input power loop is further higher than the equivalent switching frequency of the VRM; energy loss caused by input loop resonance and impact on VRM operating stability are reduced or avoided to improve the efficiency and reliability of the VRM module.

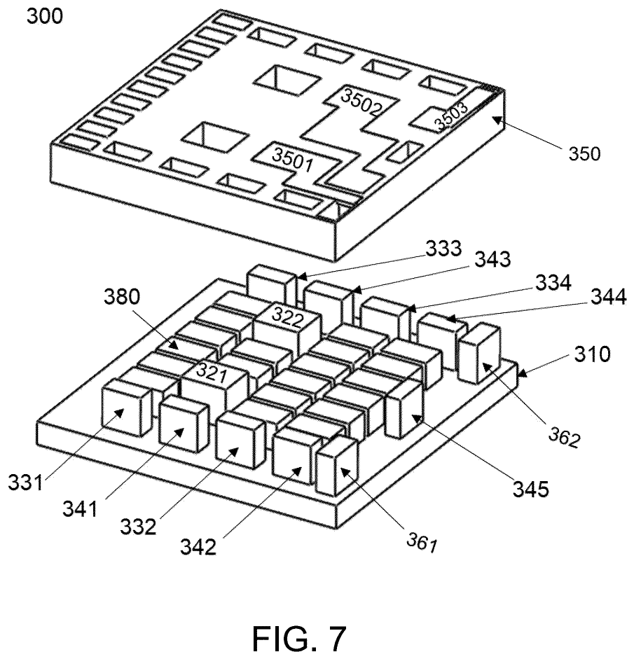

FIG. 7 shows a structural exploded view of the bottom assembly 300. As shown in FIG. 7, the bottom assembly 300 comprises a bottom substrate 310, copper pillars 321/322/331/332/333/334/341/342/343/344/361/362/345, a capacitor 380 and a plastic packaging material 350; the copper pillars 321/322 are used for connecting the Vo ends of the first main winding and the second main winding and the bottom substrate 310; the copper pillars 331/332/333/334 are used for connecting the first power electrical connector and the bottom substrate 310; the copper pillars 341/342/343/344 are used for connecting the second power electrical connector and the bottom substrate 310; the copper pillars 361/362 are used for realizing the electrical connection of the TLVR auxiliary winding loop; the copper pillars 345 are used for connecting the additional second power electrical connectors GND and the bottom substrate 310; and the capacitor 380 is used for connecting between Vo and GND for energy storage, so as to improve the dynamic performance of the output voltage at the load end. The bottom substrate 310 has a first side edge, a second side edge, a third side edge and a fourth side edge, wherein the first side edge and the third side edge are arranged opposite to each other, the second side edge and the fourth side edge are arranged opposite to each other, the first side edge and the second side edge are close to each other, and the third side edge and the fourth side edge are close to each other.

In the present embodiment, the copper pillar and the capacitor in the bottom assembly are first welded to the bottom substrate 310, and then the component on the bottom substrate is molded by plastic package 350 by means of a plastic packaging process; since the copper pillar on the bottom assembly needs to be electrically connected to the middle assembly on the top surface of the plastic packaging material, the plastic packaging material of the bottom assembly needs to be ground at a certain thickness on the top surface, ensuring that the copper pillar exposes the plastic packaging material, and forming a pin that can be soldered on the top surface of the plastic packaging material; to implement an electrical connection with the middle assembly; and, an electrical connection wire 3501/3502/3503 is arranged on the top surface of the plastic packaging material, and is used for connecting the auxiliary winding loop.

Optionally, some of the capacitors may be arranged at edge portions of the first side edge and/or the third side edge.

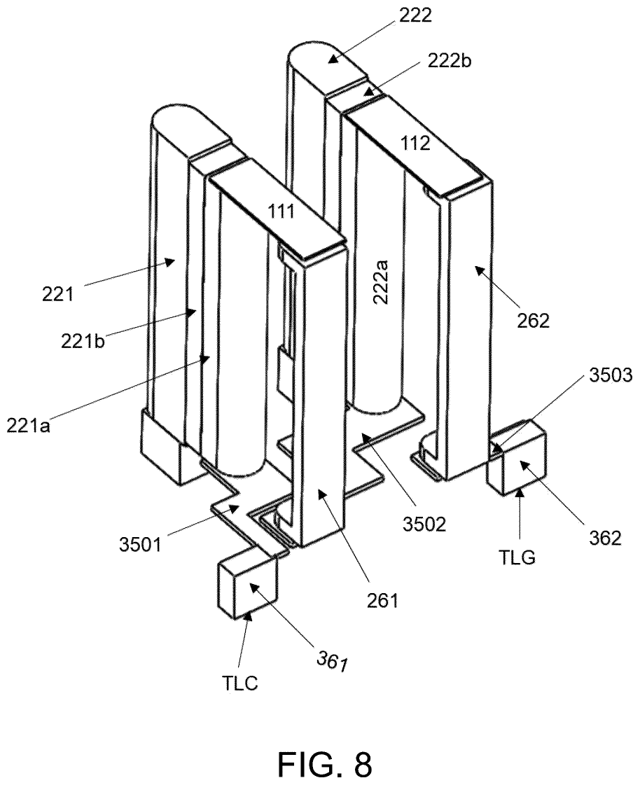

The connection result of the auxiliary winding loop is shown in FIG. 8, and the bottom surface of the bottom substrate 310 of the bottom assembly 300 is provided with the TLG and the TLC pin in FIG. 1; the TLG pin is connected to the electrical wiring 3503 by means of the bottom substrate 310 and the copper pillar 362, and the electrical wiring 3503 is electrically connected to the bottom pin of the auxiliary winding electrical connector 262; the top pin of the auxiliary winding electrical connector 262 is electrically connected to the top pin of the auxiliary winding 222a by a PCB wire 112 in the top substrate 110 in the top assembly, the bottom pin of the auxiliary winding 222a is electrically connected to the bottom pin of the auxiliary winding electrical connector 261 by means of the electrical wiring 3502; the top pin of the auxiliary winding electrical connector 261 is electrically connected to the top pin of the auxiliary winding 221a by means of a PCB wire 111 in the substrate 110 in the top assembly; the bottom pin of the auxiliary winding 221a is electrically connected to the copper pillar 361 in the bottom assembly by means of the electrical wiring 3501, and the copper pillar 361 in the bottom assembly is electrically connected to the TLC pin of the bottom surface of the bottom substrate by means of the bottom substrate 310.

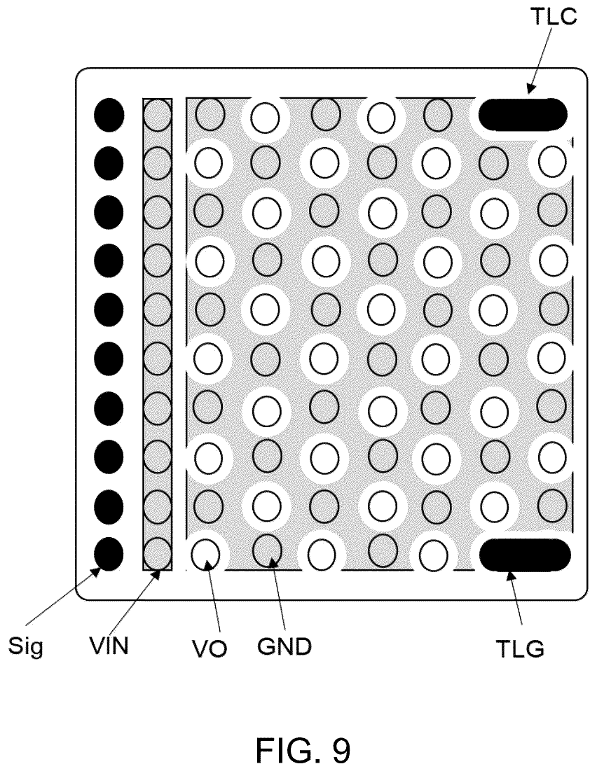

FIG. 9 shows a schematic diagram of a bottom pin of the bottom substrate 310. As shown in FIG. 9, the overall pins are arranged in an matrix format, and the left column of black round pins on the left side are Sig pins (Sig being an abbreviation of Signal, which may also be referred to as signal pins) for a connection function for signal input and output; the second column of pins from the left is the input VIN pin of the same potential; the right upper and lower right identifiers TLC and TLG pins being used for extending pins of a multi-phase TLVR function. In addition to signal pins, VIN pins, TLVR function extension pins (TLC/TLG), Vo pins and GND pins are arranged at other positions on the bottom substrate 310, and Vo pins and GND pins are staggered (distributed in each row and/or column). Because the capacitor 380 on the top surface of the substrate 310 is connected to the output end and GND end of the inductor on the top surface of the substrate 310, the capacitor 380 is used for energy storage at the load and improves the dynamic performance of the output voltage; after passing through the capacitor, Vo and GND are connected to the load, and Vo and GND wirings are staggered with each other between the capacitor and the load, so that the parasitic inductance of the wiring between the capacitor and the load is minimized, and the dynamic performance is improved;

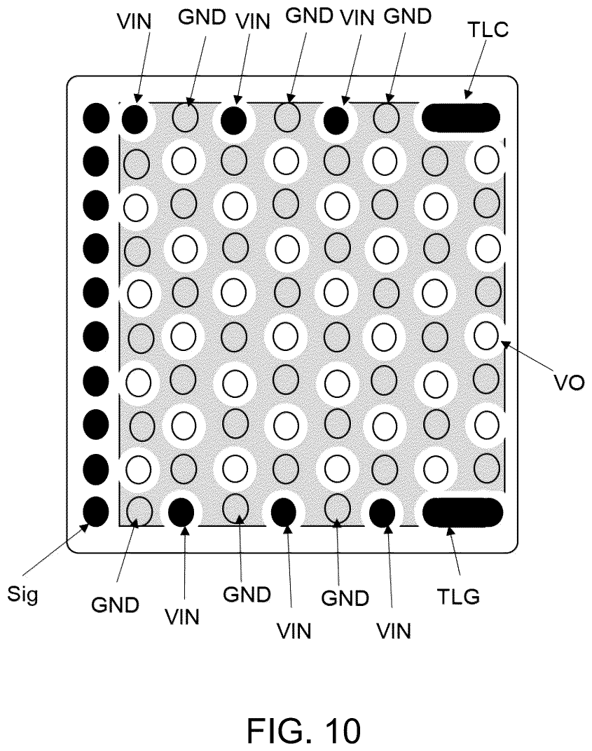

FIG. 10 shows a schematic diagram of a bottom pin of another bottom substrate 310. as shown in FIG. 10. Different from FIG. 9, the VIN pins of the second column are arranged to the top edge and the bottom edge of the middle, and are staggered with the GND, so that the loop parasitic inductance between VIN and GND is minimized, which helps to reduce the parasitic inductance on the input power loop, so that the resonance frequency between the input capacitor CIN and the parasitic inductance of the input power loop is further higher than the equivalent switching frequency of the VRM; energy loss caused by input loop resonance and impact on VRM operating stability are reduced or avoided to improve the efficiency and reliability of the VRM module.

When the outputs of a plurality of the two-phase TLVR modules in the embodiment are connected in parallel to provide a larger output current, the auxiliary windings of the plurality of two-phase TLVR modules need to be connected in series by means of the TLC and TLG pins to form a loop, for example, the TLC pin of the first two-phase TLVR module is connected to the TLG pin of the second two-phase TLVR module, the TLC pin of the second two-phase TLVR module are connected to the TLG pin of the third two-phase TLVR module, and so on, the TLC pin of the last two-phase TLVR module are connected to the TLG pin of the first two-phase TLVR module. The series connection of the TLC pins and the TLG pins of the modules is typically done on the load motherboard.

Optionally, in certain embodiments, the series connection of the TLC pins and the TLG pins of the modules may also be done on a substrate in the bottom assembly of the multi-phase VR module.

Optionally, a compensation inductor Le is added to the auxiliary winding series loop, so as to adjust the values of the dynamic inductance and the steady-state inductance, so as to meet different requirements of different application scenarios for the inductance.

The main winding in the TLVR module of the present application penetrates from the top surface of the magnetic core to the bottom surface of the magnetic core, and achieves the lowest direct current impedance by providing the shortest winding length, which helps to reduce the direct current loss under heavy load, so as to improve the efficiency under heavy load. In order to improve the coupling coefficient between the auxiliary winding and the main winding, the auxiliary winding is also arranged to penetrate from the top surface of the magnetic core to the bottom surface of the magnetic core, that is, the auxiliary winding and the main winding are arranged in the same window of the magnetic core, so as to achieve the optimal coupling coefficient between the main winding and the auxiliary winding. However, the auxiliary winding needs to realize the connection of the loop, and the auxiliary winding electrical connector needs to be provided. The auxiliary winding electrical connector is disposed on a first side surface of the magnetic core, and as shown in FIG. 6B and FIG. 8, the auxiliary winding electrical connector has a certain inductance, which acts as a compensation inductor. Therefore, the TLVR module in the present application integrates a certain amount of compensation inductor, and the external compensation inductor can be omitted. The space and cost of the load mainboard are saved.

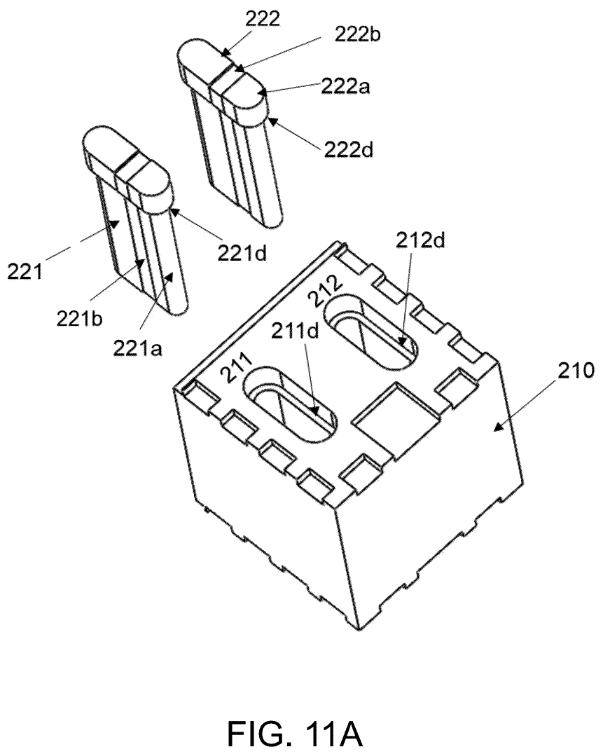

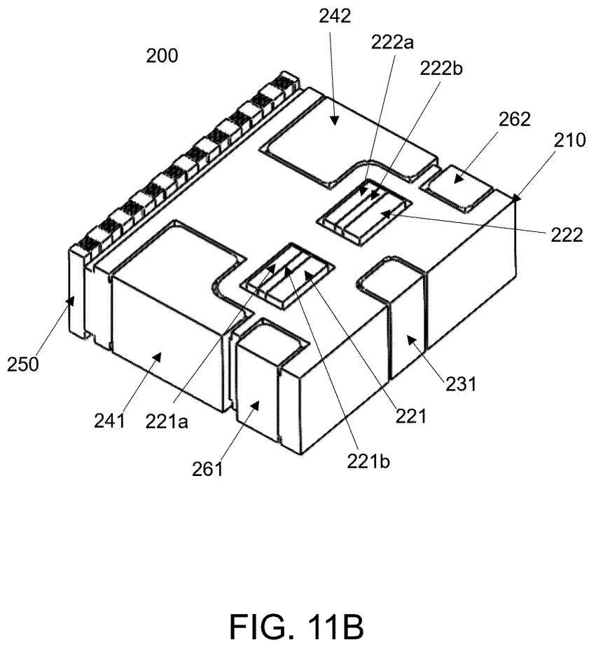

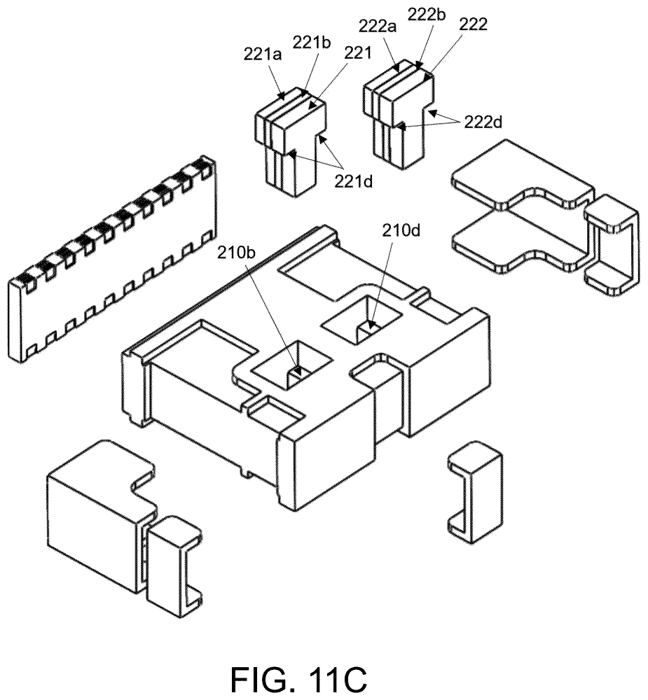

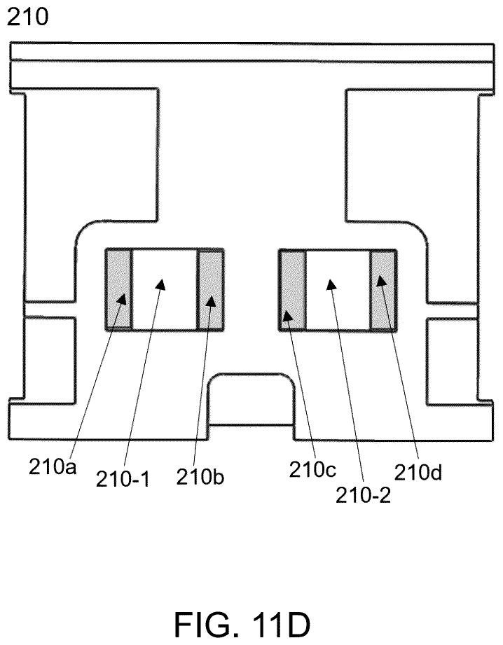

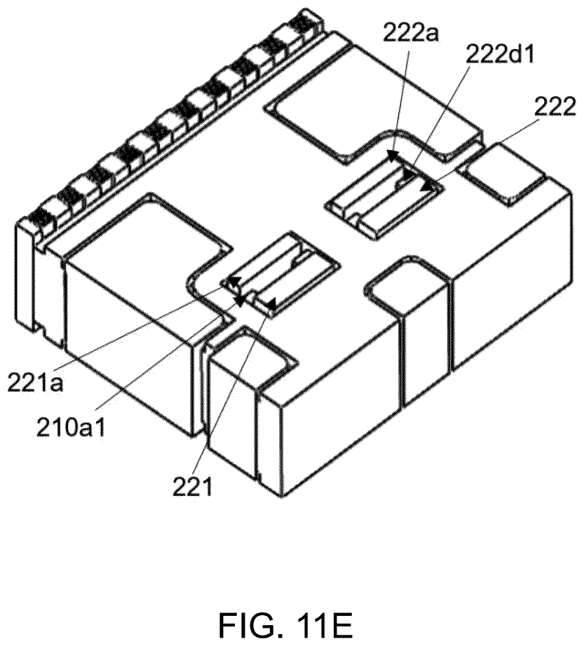

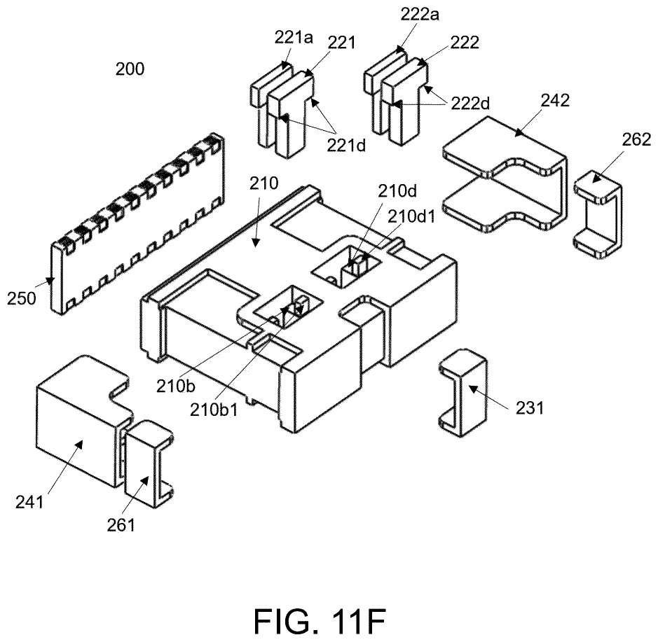

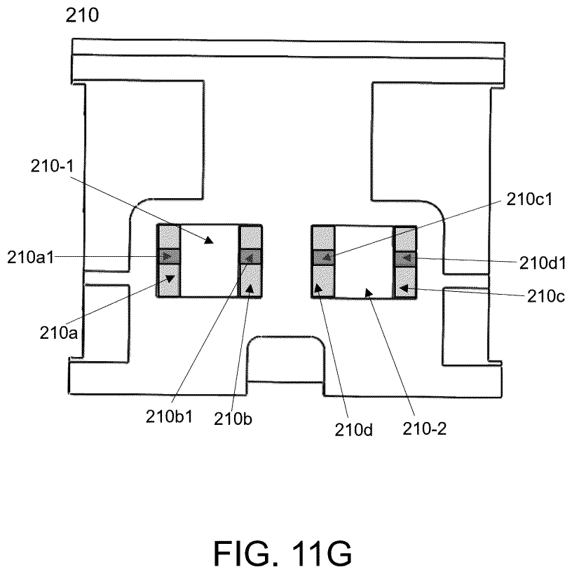

FIG. 11A illustrates another embodiment of a magnetic core and winding assembly. As shown in FIG. 11A, the first winding assembly is provided with a step 221d, the second winding assembly is provided with a step 222d, the main winding, the auxiliary winding, and the insulation between the main winding and the auxiliary winding are all provided with steps of the same height, and the arrangement of the step enables the pins on the top surface of the main winding and the auxiliary winding to have a large area, which helps to increase the welding area with the IPM SW Pad, reduce the welding impedance, and improve the efficiency. The circumference of the winding below the step is relatively small, so that the circumference of the magnetic core window is small, the length of the magnetic circuit is reduced, the inductance is improved, the loss of the magnetic core is reduced, and the light load efficiency of the module is improved. Optionally, the windows 211 and 212 of the magnetic core may also be correspondingly provided with steps 211d and 212d. The purpose of the magnetic core window setting step is to simplify the mounting of the winding assembly and the magnetic core, for example, glue dispensing can be facilitated on the step of the magnetic core window, then the winding assembly is inserted into the magnetic core window, the glue is bonded to the winding assembly and the magnetic core, and the magnetic core step also functions to fix and limit the winding assembly; and the assembly of the winding assembly is simple and convenient.

FIG. 11B to FIG. 11D show another embodiment of a magnetic core and a winding assembly. FIG. 11B is a schematic diagram of the middle assembly 200, FIG. 11C is an exploded schematic diagram of the middle assembly 200, and FIG. 11D is a schematic top view of the magnetic core 210. As shown in FIG. 11C, the first winding assembly is provided with a step 221d, and the second winding assembly is provided with a step 222d; a main winding, an auxiliary winding and an insulation material in each winding assembly are both “T”-shaped, the first winding assembly comprises a step 221d, and the second winding assembly comprises a step 222d. Correspondingly, as shown in FIG. 11D, a step 210a and a step 210b are provided in a window 210-1 of the magnetic core 210, and steps 210c and 210d are provided in the window 210-2; The presence of the step is such that the windows 210-1 and 210-2 are both “T” shaped, which are the same with the shape of the first winding assembly and the shape of the second winding assembly for accommodating the first winding assembly and the second winding assembly. The position of the step is used as a dispensing position for securing the magnetic core and the winding assembly. The main winding, the auxiliary winding, and the insulation material herein may be manufactured by a printed circuit board process, or may be assembled with the magnetic core 210 after the two copper blocks and the insulation material are assembled.

FIG. 11E to FIG. 11G show another embodiment of a magnetic core and winding assembly. FIG. 11E is a schematic diagram of the middle assembly 200, FIG. 11F is an exploded view of the middle assembly 200, and FIG. 11G is a schematic top view of the magnetic core 210. Referring to FIG. 11E to FIG. 11G, this embodiment differs from the embodiment shown in FIG. 11B to FIG. 11D in that the first winding assembly and the second winding assembly only include a main winding and an auxiliary winding, and do not include an insulator; and the main winding and the auxiliary winding are in a “T” shape, but are not limited thereto. As shown in FIGS. 11F and 11G, a window 210-1 of the magnetic core 210 comprises steps 210a and 210b, and the steps 210a and 210b are respectively provided with bosses 210a1 and 210b1; the window 210-2 of the magnetic core 210 comprises steps 210c and 210d, and the steps 210c and 210d are respectively provided with bosses 210c1 and 210d1; the size and shape of the boss are not limited, for example, the width of the boss may be less than the width of the step; and the height of the boss may also be less than the height of the step; and the boss may be rectangular or trapezoidal. The boss is configured to limit and insulate the main winding and the auxiliary winding in each window, and the setting of the boss simplifies the manufacturing process of the middle assembly 200, which is more conducive to mass production.

### Embodiment 2

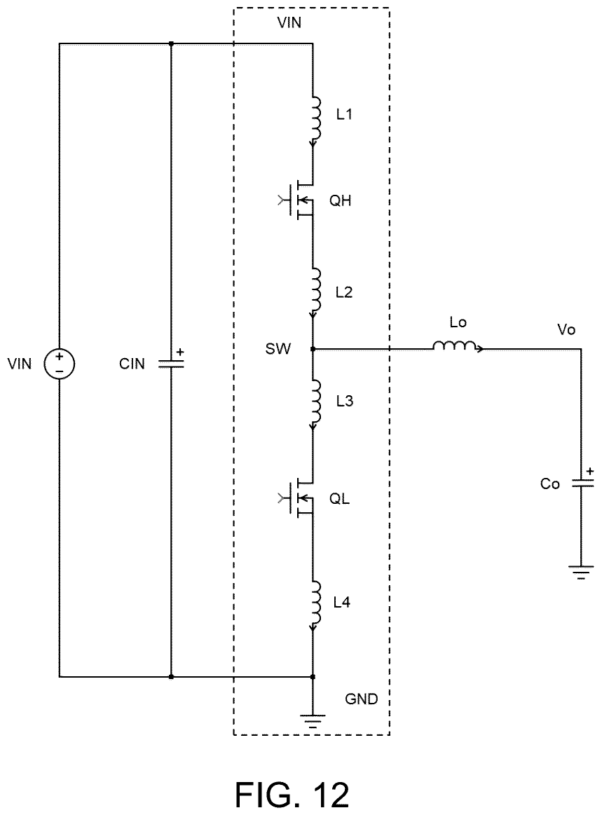

The IPM in the present embodiment uses a chip scale package (CSP) package. FIG. 12 is a simplified equivalent model of a BUCK circuit. A portion of a dashed line in FIG. 12 is a power portion in an IPM, and is mainly comprises a high-side MOSFET switching device QH and a low-side MOSFET switching device QL, and a drain electrode of QH is connected to the input VIN of the module.; a source electrode of QH is connected to a drain electrode of the low side switch QL, and served as an output end SW (Switching Node) of an IPM to connect with an input end of an output filter inductor Lo of the VR module; a source electrode of the low-side switch QL is connected to an input GND end. The complete IPM is formed by connecting the minimum power units in a myriad of the dashed boxes in series and/or in parallel to provide a larger output current to supply load; the inductors L1, L2, L3 and L4 inside the dashed box are parasitic inductances connected in series between the switching device and the VIN, and the GND, and the high-side switching device and the low-side switching device; due to the parasitic inductances, when the high-side switching device QH and the low-side switching device QL are turned off/turned on, the voltage waveform at the SW generates a spike, thereby generating electromagnetic interference (EMI), especially when the inductance of the parasitic inductance is large, the high-side switching device is subjected to high voltage stress and is prone to breakdown, resulting in problems such as poor reliability of the VRM module;

The common solution is to shorten the packaging wiring distance between the switching device and the VIN, between the high-side switching device and the low-side switching device, between the low-side switching device and GND, to reduce the inductance of the parasitic inductance; and, in the packaging, a high-frequency filtering capacitor is provided between VIN and GND, so as to reduce the influence of parasitic inductance; however, these methods may be limited as the physical size is reduced;

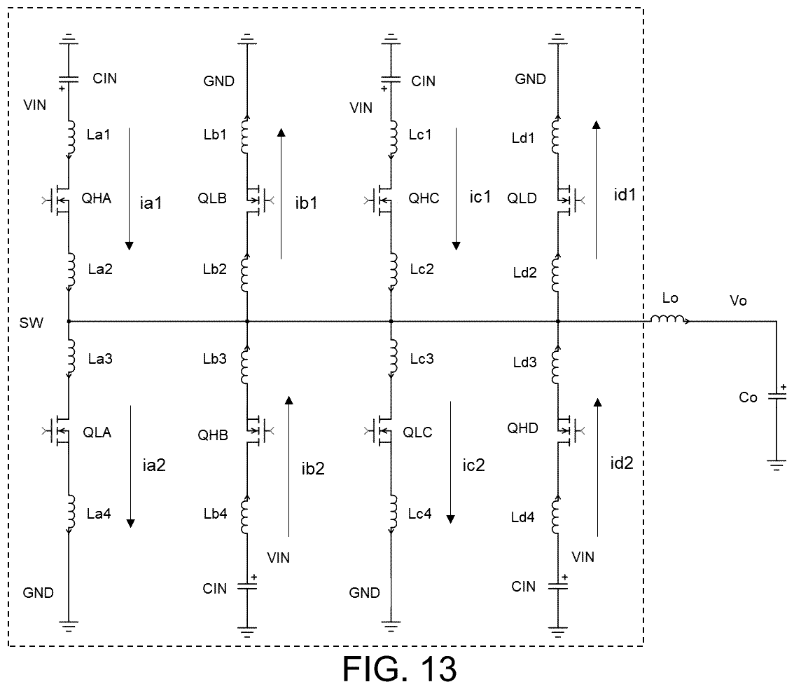

FIG. 13 is a scheme for reducing parasitic inductance inside an IPM according to an embodiment, the dashed box is the smallest unit of the power switching device. As shown in FIG. 13, the first power sub-unit comprises a first high-side switching device QHA and a first low-side switching device QLA; the second power sub-unit comprises a second high-side switching device QHB and a second low-side switching device QLB; the third power sub-unit comprises a third high-side switching device QHC and a third low-side switching device QLC; the fourth power sub-unit comprises a fourth high-side switching device QHD and a fourth low-side switching device QLD; the switching devices of the first power sub-unit and the third power sub-unit are arranged in the same direction, and the switching devices of the second power sub-unit and the fourth power sub-unit are arranged in the same direction; and the direction of the switching devices in the first and third power sub-units is set 180 degrees from the direction of the switching devices in the second and fourth power sub-units, and the SW points of the first power sub-units to the fourth power sub-units are arranged on the same horizontal line and are electrically connected together; therefore, the high-side switching device QHA in the first power sub-unit, the low-side switching device QLB in the second power sub-unit, the high-side switching device QHC in the third power sub-unit, and the low-side switching device QLD in the fourth power sub-unit are sequentially arranged horizontally; in the same method, the low-side switching device QLA in the first sub-unit, the high-side switching device QHB in the second power sub-unit, the low-side switching device QLC in the third power sub-unit, and the high-side switching device QHD in the fourth power sub-unit are sequentially arranged horizontally. The current in the high-side switching device flows from the VIN end to the SW terminal, and the current in the low-side switching device flows from the SW terminal to the GND end; the current flowing from the VIN end to the SW terminal is opposite to the current direction from the SW terminal to the GND end, and the mutual difference is 180 degrees; such a staggered arrangement (arrow shows the effect of the current direction being staggered), so that the magnetic flux generated by the currents in the high-side switch device and the connection path between VIN and SW and the magnetic flux generated by the current in the connection path cancel each other, so that the parasitic inductance in the connection path between VIN and GND is minimized; The spike of the voltage waveform at the SW is effectively improved, EMI interference is reduced, the influence on the operation of the switching device is eliminated, and reliable operation of the switching device is ensured;

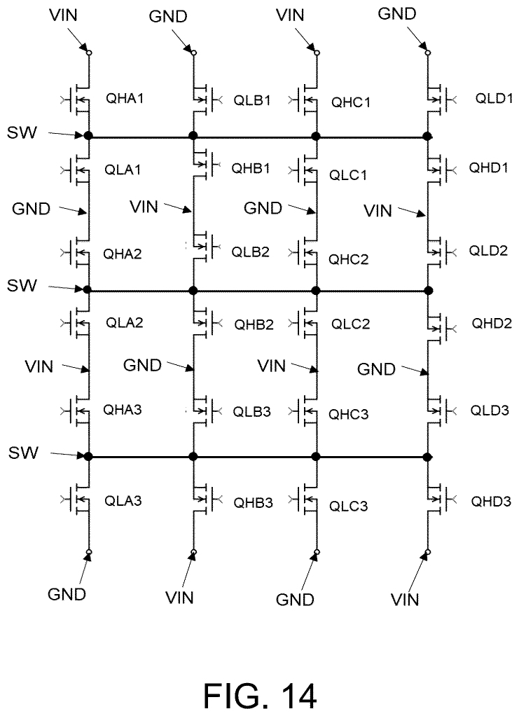

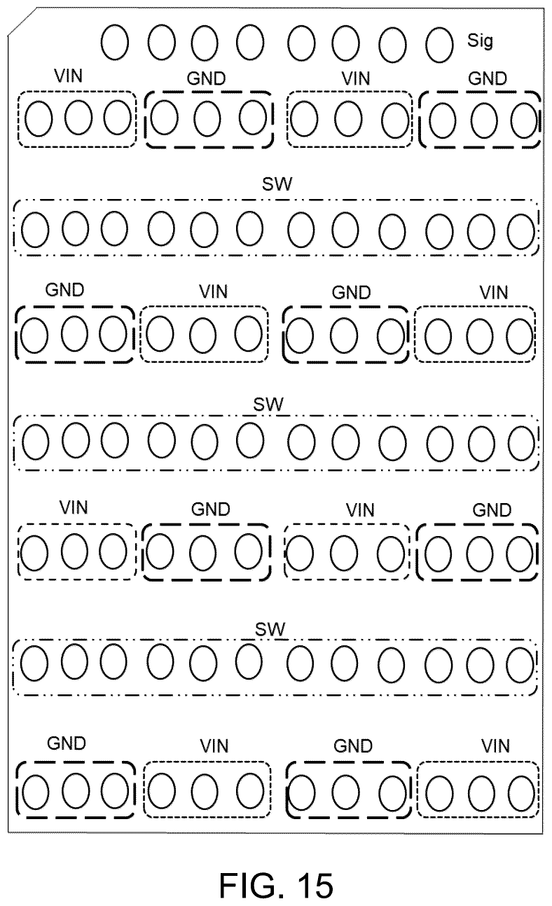

Any switching device of the minimum power units shown in FIG. 13 may be any multiple wafer-level MOSFETs connected in parallel; so as to improve the current processing capability; the minimum power units can be connected in any series and/or parallel connection to expand the power level or optimize efficiency. FIG. 14 is a circuit schematic diagram of an embodiment of an IPM based on this minimum power unit. As shown in FIG. 14, each column is formed by connecting three pairs of high and low side switching devices in series, and each high/low switching device is horizontally adjacent to a low/high side switching device with opposite current directions. This staggered arrangement manner can minimize the parasitic inductance of the connection path in the substrate, minimize the voltage waveform spike of SW, and improve the operation stability of the switching device; the SW points of each pair of switching devices are electrically connected together; VIN and GND are also staggered; FIG. 15 is a pin diagram of the IPM substrate, and the circles represent the pins (BUMP), the settings of VIN pins, SW pins, GND pins, and Sig pins correspond to the settings of the IPM internal switching device; and the IPM in the top assembly in Embodiment 1 uses the IPM solution of the present embodiment to achieve the most reliable operation.

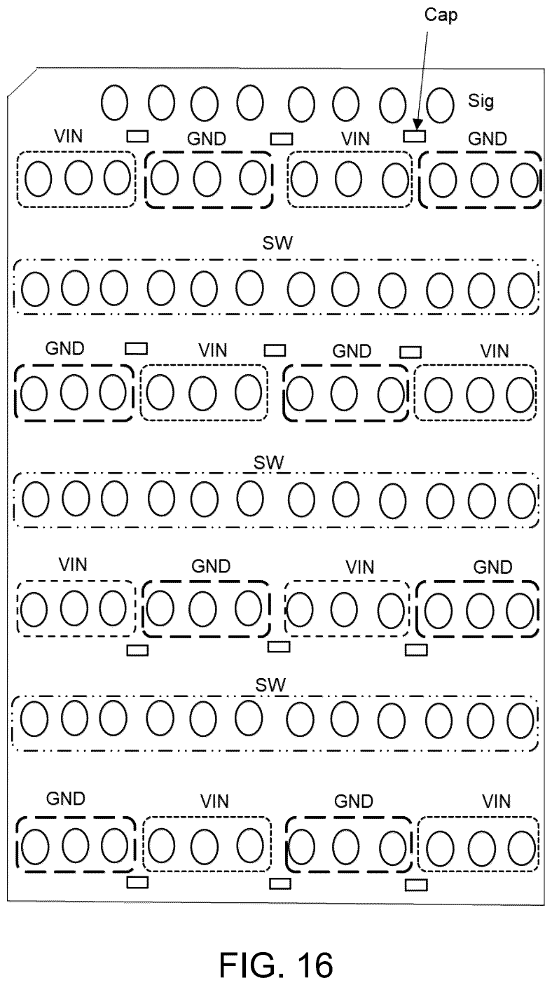

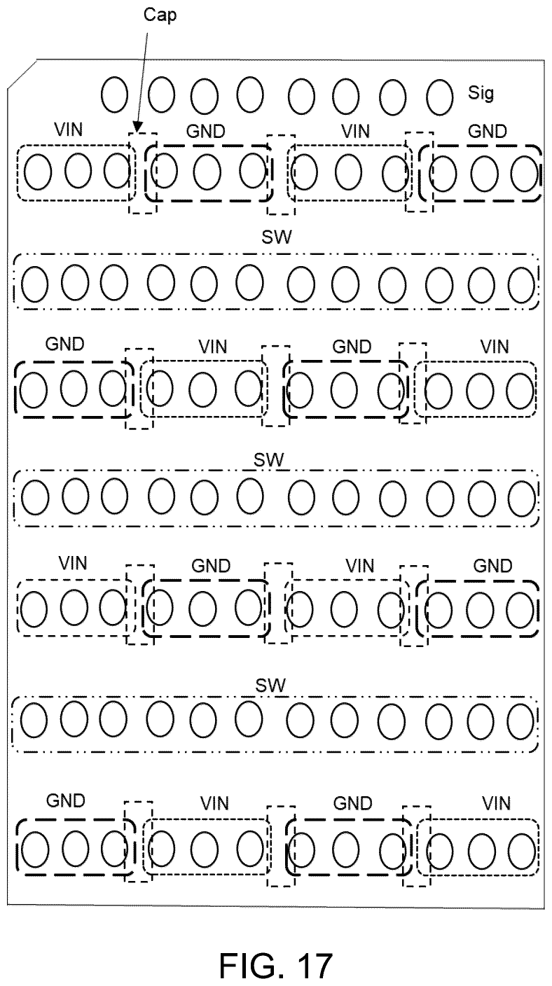

Optionally, as shown in FIG. 16 and FIG. 17, a view of setting an added high-frequency filter capacitor or illustrating a position of the added high-frequency filter capacitor; In FIG. 16, a high-frequency filter capacitor Cap is arranged near VIN and GND; or, as shown in FIG. 17, a high-frequency filter capacitor is provided at the bottom surface of the substrate, or at the position corresponding to the dashed box Cap on the substrate of the top assembly. In the configuration of the high-frequency filter capacitors, the parasitic parameters can be reduced, the oscillation can be minimized and the spikes on the SW points can be minimized, so as to ensure reliable operation of the VRM.

### Embodiment 3

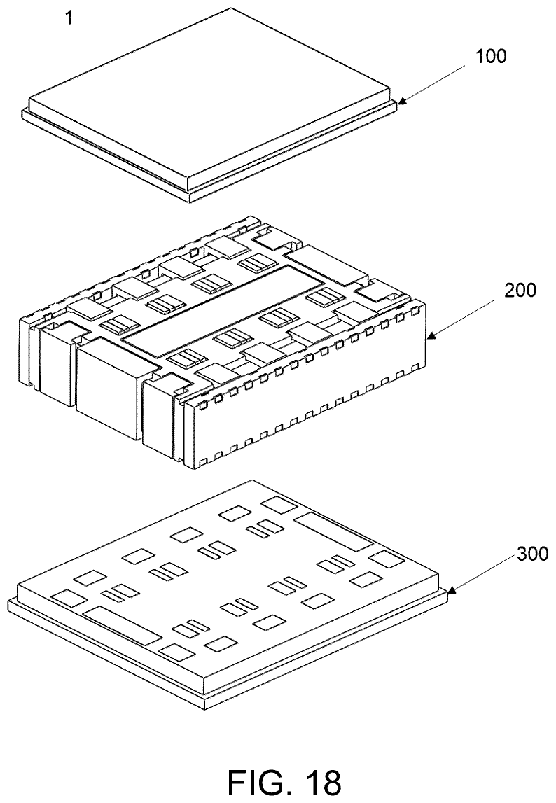

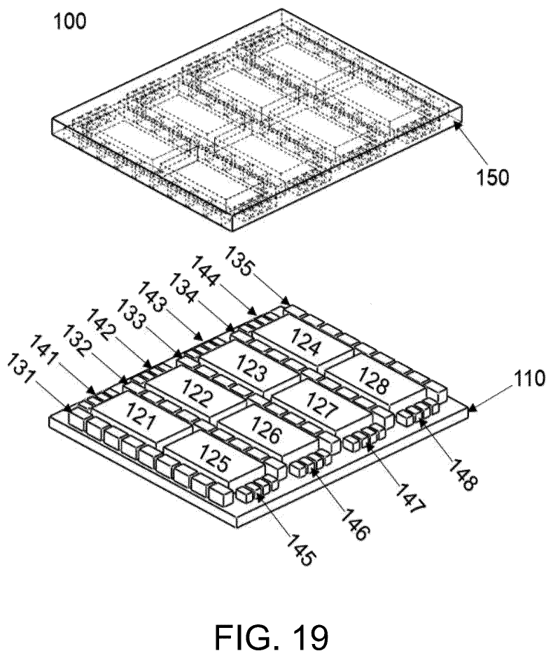

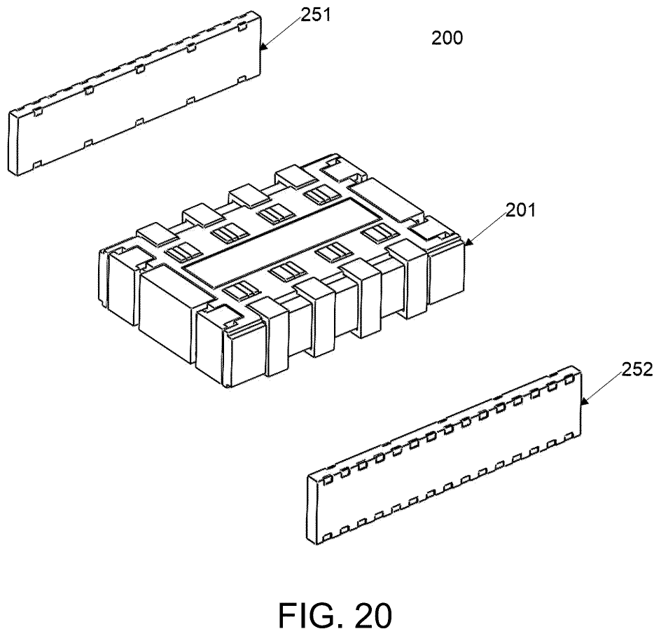

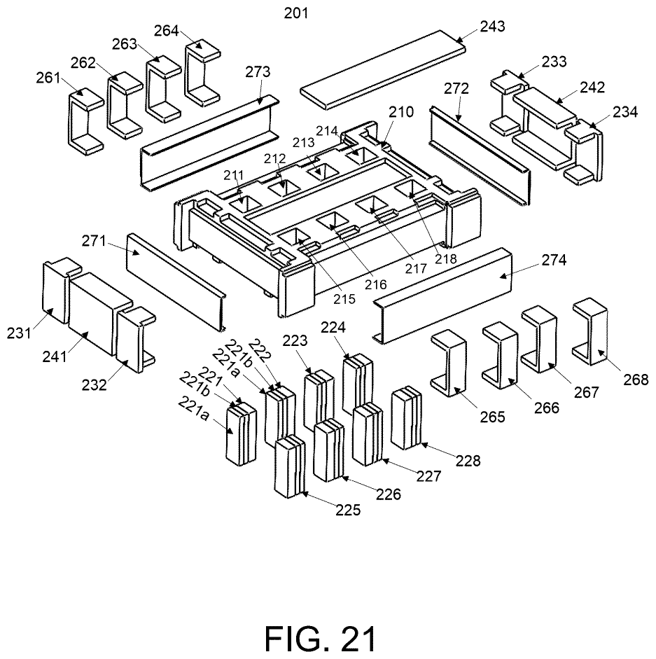

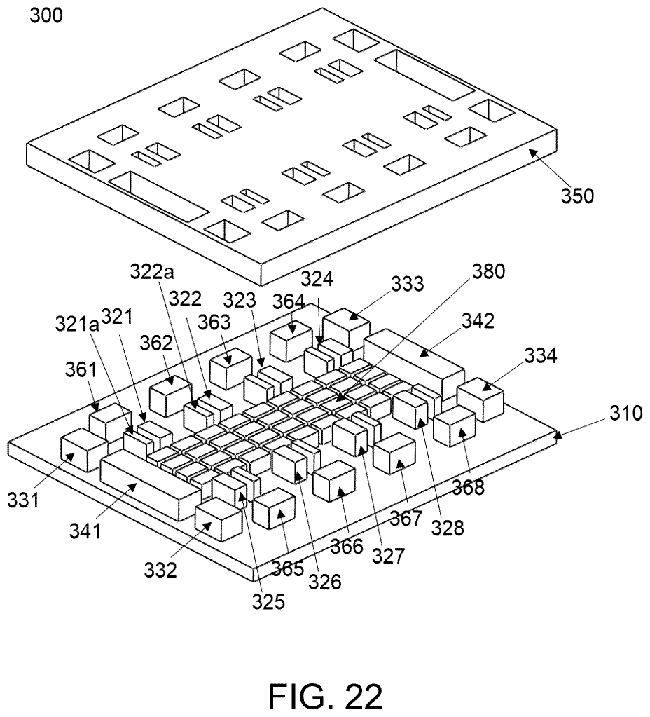

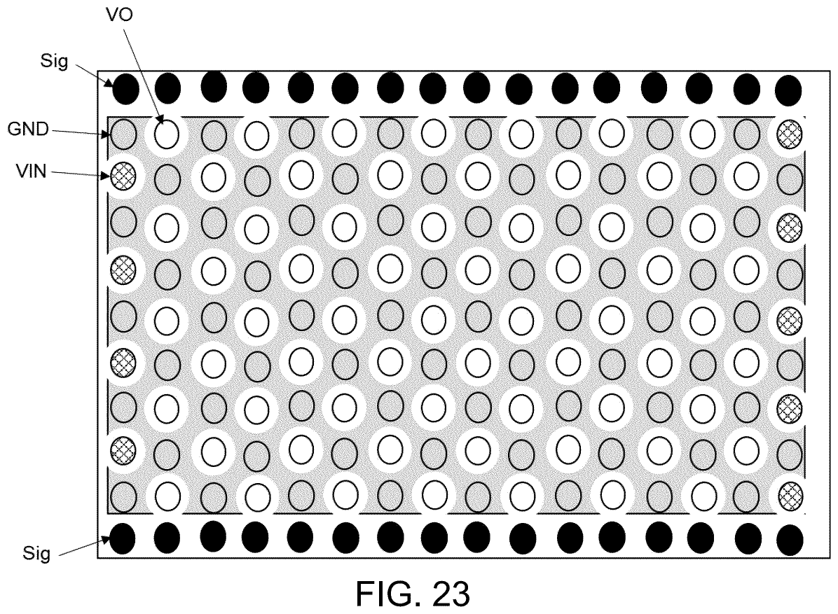

FIG. 18 is a schematic structural diagram of an eight-phase TLVR module; FIG. 19 is an exploded view of a top assembly of the present embodiment; FIG. 20 is an exploded view of a middle assembly t of the present embodiment; FIG. 21 is an exploded view of the integrated inductor according to the present embodiment; FIG. 22 is an exploded schematic diagram of a bottom assembly of the present embodiment; and FIG. 23 to FIG. 26 are schematic diagrams of a bottom pin map.

As shown in FIG. 18, the multi-phase TLVR module comprises a top assembly 100, a middle assembly 200, and a bottom assembly 300;

As shown in FIG. 19, the top assembly 100 comprises a top substrate 110, an IPM 121/122/123/124/125/126/127/128, an input capacitor 131/132/133/134/135, other passive elements 141/142/143/144/145/146/147/148, and a plastic package 150, the IPM being the same as the IPM in Embodiment 1 and Embodiment 2, and using a CSP packaging device. The IPMs are arranged in a rectangular shape, such as 2 rows*N/2 columns array. The input capacitors 131-135 are respectively arranged at two sides of the IPM and between columns and columns of the IPM. The plastic packaging method is the same as that in Embodiment 1, and will not be repeated here.

As shown in FIG. 20, the middle assembly 200 comprises an integrated inductor 201 and a vertical plate 251/252; the vertical plates 251/252 are symmetrically arranged on the first side surface and the third side surface of the magnetic core, respectively; the signal pins on the vertical plate 251/252 are provided with two rows, and the number of signal pins of one side closed to the magnetic core is less than the other side so as to keep clear of the power pins on the inductor. As shown in FIG. 21, the integrated inductor 201 comprises a magnetic core 210, 8 winding assemblies, a first power electrical connector, a second power electrical connector, an auxiliary winding electrical connector, and a copper sheet; the winding assembly comprises a main winding, an auxiliary winding and an insulation medium, for example, the first winding assembly comprises a first main winding 221, a first auxiliary winding 221a and a first insulation medium 221b; the first power electrical connector comprises a connector 231/232/233/234, the second power electrical connector comprises a connector 241/242/243, and the first power electrical connector is electrically connected to the input VIN end; the second power electrical connector is electrically connected to the GND end; the auxiliary winding electrical connector comprises electrical connectors 261/262/263/264/265/266/267/268, and the first auxiliary winding electrical connector assembly comprises auxiliary winding electrical connectors 261/262/263/264; the second auxiliary winding electrical connector assembly comprises auxiliary winding electrical connectors 265/266/267/268; the copper sheets are 271/272/273/274, respectively; the magnetic core is provided with a window 211/212/213/214/215/216/217/218, the window penetrates from the top surface of the magnetic core to the bottom surface of the magnetic core, and the magnetic core window is used for arranging the winding assembly; the main winding in the winding assembly is electrically isolated from the auxiliary winding; a first power electrical connector assembly comprises a first power electrical connector 231, a second power electrical connector 241, and a first power electrical connector 232; the first power electrical connector 231, the second power electrical connector 241, and the first power electrical connector 232 are sequentially arranged and disposed on a second side surface of the magnetic core; a second power electrical connection assembly comprises a first power electrical connector 233, a second power electrical connector 242, and a first power electrical connector 234; the first power electrical connector 233, the second power electrical connector 242, and the first power electrical connector 234 are sequentially arranged and disposed on a fourth side surface of the magnetic core; the first power electrical connector and the second power electrical connector are alternately arranged at intervals, so that the parasitic inductance of the power loop is reduced, and the resonant frequency between the input capacitor CIN and the parasitic inductance of the input power loop is further higher than the equivalent switching frequency of the VRM; and the impact of energy loss caused by resonance of the input loop and the working stability of the VRM is reduced or avoided, so as to improve the efficiency and reliability of the VRM module.

As shown in FIG. 21, the first copper sheet 271 is provided as “C”-shaped and is arranged on the second side surface of the magnetic core, and is located between the magnetic core and the first power electrical connector assembly; the second copper sheet 272 is set to be “C”-shaped and is arranged on the fourth side surface of the magnetic core, and is located between the magnetic core and the second power electrical connector assembly; the third copper sheet 273 is provided as “C”-shaped and is arranged on the third side surface of the magnetic core, and is located between the magnetic core and the first auxiliary winding electrical connector assembly; the fourth copper piece 274 is provided as “C”-shaped and is arranged on the first side surface of the magnetic core, and is located between the magnetic core and the second auxiliary winding electrical connector assembly; the copper sheets 271/272/273/274 may be provided by means of assembly, or may be integrally formed with the magnetic core 210, and electrical isolation is required between the copper sheet and the power electrical connector; the manner of insulating between the copper sheet and the power electrical connector is the same as that in Embodiment 1, and details are not described herein again. After the copper sheets 271 and 272 are arranged, the magnetic flux generated by the current on the power electrical connector cuts the copper sheet and induces eddy current effects on the copper sheet, and the eddy currents on the copper sheet also generate magnetic flux which can cancel the magnetic flux generated by the current on the power electrical connector. Therefore, the arrangement of the copper sheets 271 and 272 further reduces the parasitic inductance on the input power loop, such that the resonance frequency between the input capacitor CIN and the parasitic inductance of the input power loop is further higher than the equivalent switching frequency of the VRM; energy loss caused by input loop resonance and impact on VRM operating stability are reduced or avoided to improve the efficiency and reliability of the VRM module.

The arrangement of the copper sheets 273 and 274 enables the current on the auxiliary winding electrical connector to induce eddy currents on the copper sheet 273/274, and the magnetic flux generated by the eddy current counteracts the magnetic flux generated by the current in the auxiliary winding electrical connector, such that the parasitic inductance of the auxiliary winding electrical connector loop is reduced, the compensation inductance integrated by the VRM module is equivalently reduced, and the equivalent dynamic inductance of the multi-phase TLVR is reduced, so as to improve the dynamic performance of the TLVR module.

The copper sheet 271/272 may also be an “I”-shaped structure, as in Embodiment 1, which is not limited herein;

The copper sheet 273/274 may also be provided as an “I”-shaped structure, and the height of the “I”-shaped copper sheet may be arbitrarily adjusted so as to adjust the parasitic inductance on the auxiliary winding electrical connector. The parasitic inductance on the auxiliary winding electrical connector acts as a compensation inductor, that is, the TLVR inductor structure in the present embodiment integrates a compensation inductor, and adjusting the height of the “I”-shaped copper sheet is equivalent to adjusting the compensation inductance of the multi-phase TLVR module, so as to meet the requirements for dynamic inductance and steady-state efficiency in different application scenarios.

As shown in FIG. 21, a second power electrical connector 243 is provided on the top of the magnetic core 210, a second power electrical connector GND of the VRM module is disposed on the second side surface and the fourth side surface of the magnetic core, and the second power electrical connector 241/242 is used for electrically connecting the GND pin on the bottom substrate to the GND pin of the IPM. The distances between the GND pin of the IPM close to the second side and the fourth side of the magnetic core and the GND pin of the bottom substrate are the same, but the distance between the GND pin of the IPM provided in the middle of the magnetic core and the GND pin of the bottom substrate are long; such arrangement can cause the VRM corresponding to the IPM at the intermediate position to be large in loss, low in efficiency, unbalanced in hot spots, and reduced the reliability of the multi-phase TLVR module. The arrangement of the second power electrical connector 243 reduces the difference in the direct current impedance between the GND pins of the IPM at different positions to the GND pins of the bottom substrate, which is beneficial to eliminate the difference in the efficiency of the VRM phase corresponding to the IPM at different positions, which is beneficial to the improvement of the overall efficiency.

FIG. 22 is a schematic structural exploded view of a bottom assembly according to an embodiment. As shown in FIG. 22, the bottom assembly 300 comprises a bottom substrate 310, the main winding connection copper pillars 321/322/323/324/325/326/327/328, the auxiliary winding connection copper pillars 321a/322a (323a/324a/325a/326a/327a/328a, and not identified in the FIG), he first power electrical connector connection copper pillars 331/332/333/334, the auxiliary winding electrical connectors connection copper pillars 361/362/363/364/365/366/367/368, and the process of plastic packaging of the output capacitor 380 and the plastic package 350 is the same as that described in Embodiment 1, and details are not described herein again.

In this embodiment, the electrical connection loop of the TLVR auxiliary winding is completed by means of the bottom substrate 310, the auxiliary winding connection copper pillar of the bottom substrate, the auxiliary winding electrical connector, and the wiring on the top substrate; ; of course, the manner of Embodiment 1 can be adopted, wherein the wiring is provided on the top surface of the plastic packaging material for completing the electrical connection of the auxiliary winding loop. FIG. 23 is an embodiment of the pin arrangement of the bottom surface of the bottom substrate 310, the signal pins being arranged on both sides of the long side.

As shown in FIGS. 23-26, the pin arrangement overall presents a matrix form of i rows*j columns. As shown in FIG. 23, the Sig pins are disposed on the first row and the ith row, the GND pin and the VIN pin are disposed in the first column and the jth column in the second row to the (i-1)th row, and preferably, in some embodiments, the VIN pin and the GND pin are disposed in 1, 2, j-1, and j columns in the second row to the (i-1)th row; in each row and each column in the area, the VIN pin and the GND pin both satisfy an arrangement mode of alternating distribution; the Vo pin and the GND pin are arranged in the 2nd column (or 3rd column) to the (j-1)th column (or (j-2)th column) in the 2nd row to the (i-1)th row, and the Vo pin and the GND pin are arranged in a staggered manner. The advantage of such a configuration is that the parasitic inductance of the input loop formed by VIN and GND on the bottom substrate is minimized, so as to reduce the parasitic inductance of the entire input power loop, so that the resonance frequency between the input capacitor CIN and the parasitic inductance of the input power loop is much higher than the equivalent switching frequency of the VRM; the energy loss caused by resonance of the input loop and the influence on the working stability of the VRM are reduced or avoided, so as to improve the efficiency and reliability of the VRM module. And, the capacitor 380 on the top surface of the bottom substrate 310 is connected to the output terminal and GND end of the inductor on the top surface of the substrate 310, and is used for energy storage at the load terminal and improves the dynamic performance of the output voltage. After connecting with the capacitor, Vo and GND are connected to the load, and the Vo and GND wirings are staggered with each other between the capacitor and the load, so that the inductance of the parasitic inductance of the wiring between the capacitor and the load is minimized, and the dynamic performance is improved. In the bottom substrate pin of FIG. 23, the TLVR function extension pin TLG and the TLC are not provided, so that the TLVR auxiliary winding loop is electrically connected inside the VRM module.

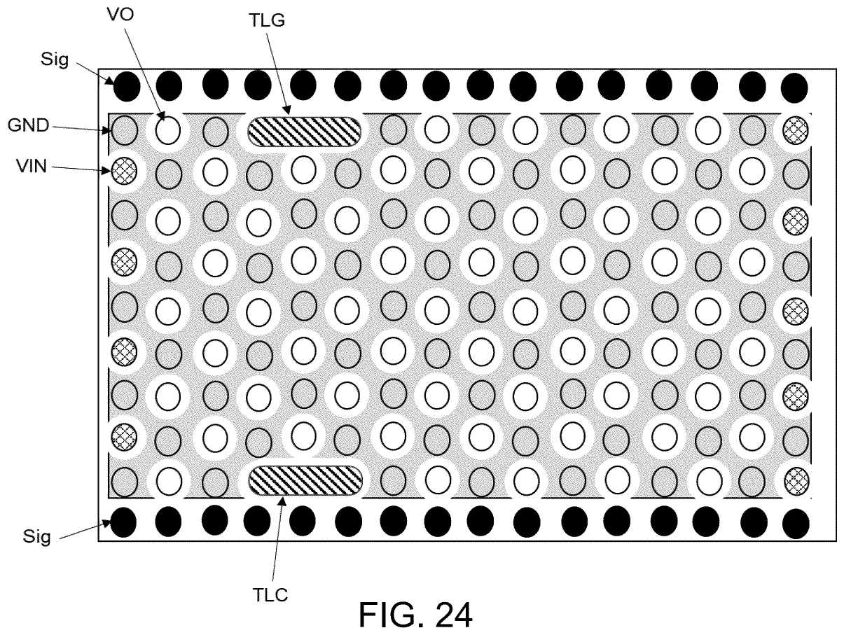

As shown in FIGS. 24-26, the bottom substrate 310 is further configured with TLVR function extension pins TLG and TLC.

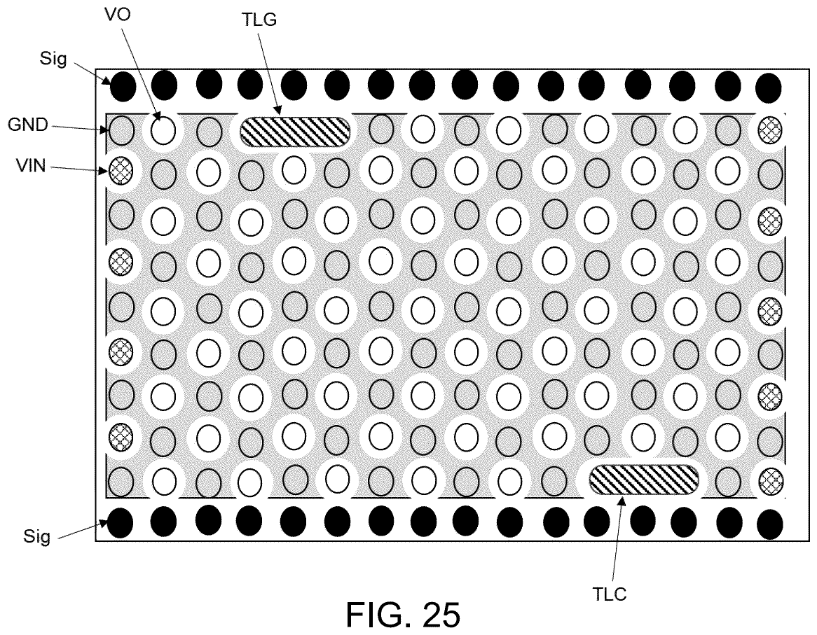

As shown in FIG. 24 to FIG. 25, the TLG pin is configured in a second row, and the TLC pin is configured in the (i-1)th row, that is, the second row from the bottom. The TLG pin and the TLC pin can be arranged opposite to each other (as shown in FIG. 24), which facilitates the extension of the more phase TLVR, and can also be symmetrically arranged at a certain point (generally the center point of the bottom substrate 310) on the bottom substrate 310 (as shown in FIG. 25), so as to facilitate the extension of the multi-phase TLVR and the connection of a more convenient auxiliary winding loop.

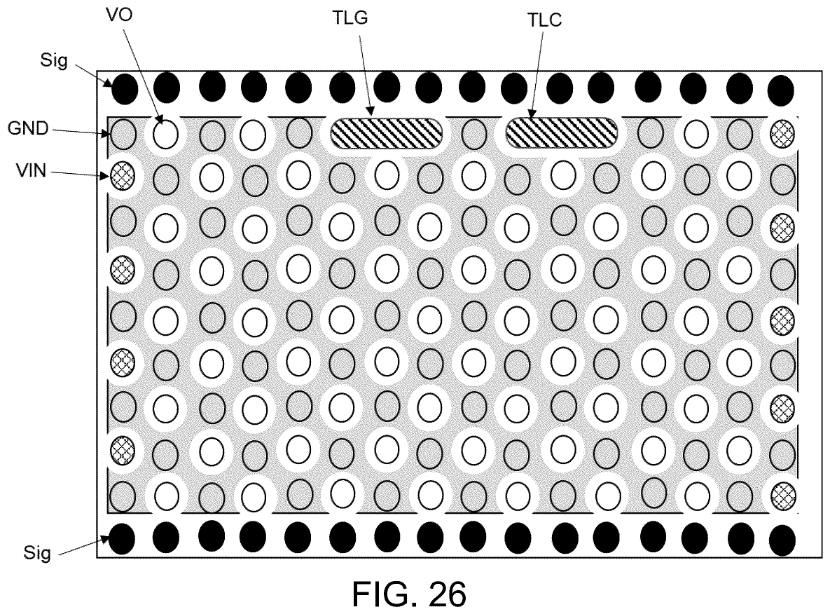

FIG. 26 is another embodiment of FIG. 23. The difference between FIG. 26 and FIG. 23 is to increase the TLG and TLC of the TLVR function extension pin, and both the TLG pin and the TLC pin are disposed in the second row, that is, the same row, and the TLG pin and the TLC pin are symmetrically arranged; the extension of the more phase TLVR and the connection of the smaller loop are facilitated, and the dynamic inductance is further reduced to improve the dynamic performance.

It should be noted that the arrangement of the pins is merely illustrative and is not limited thereto.

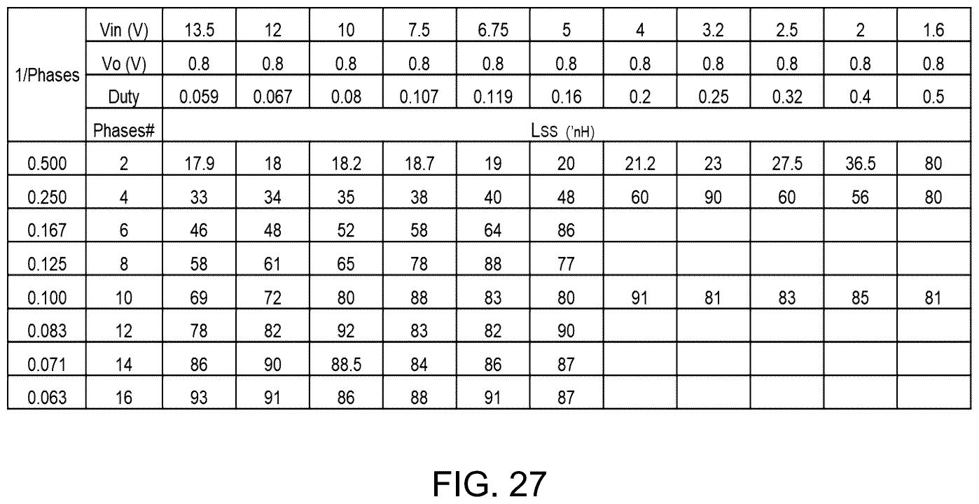

FIG. 27 is a schematic diagram of a simulation result according to an embodiment. FIG. 27 is the simulation results of equivalent steady-state inductance of TLVR under different input and output working conditions; the simulation result of the equivalent steady-state inductance in FIG. 27 is based on the inductance of the main winding of each phase is 100 nH, the inductance of the auxiliary winding of each phase is also 100 nH, the coupling coefficient between the main winding and the auxiliary winding is 0.95, the coupling coefficient between main windings of any two phases is 0.2, the coupling coefficient between auxiliary windings of any two phases is also 0.2, and there is no compensation inductor setting (with the condition of compensating the inductance setting, and the coupling coefficient is different, and the law of the simulation result is not changed (except for the case that there is anti-coupling between the main windings)). Each equivalent dynamic inductance obtained by simulation is 9.8 nH, and the dynamic inductance is not affected by the number of phases and the input and output working conditions. It can be seen from FIG. 27 that the steady state inductance Lss under different phases and different input and output conditions is different; and the following conclusion can be obtained:

For a given number of phases, when Duty is equal to the reciprocal of the number of phases, or equal to the integer multiple of the reciprocal of the number of phases, the steady state inductance is the maximum; the TLVR module has the best effect, that is, the steady state inductance is the maximum and the efficiency is highest in the case of the same dynamic inductance.

When the total number of phases of the TLVR module is greater than or equal to 8, the steady-state inductance under different input and output conditions has an ideal absolute value, so that a better steady-state efficiency can be achieved.

When the total number of phases of the TLVR module is less than 8, at the same 0.8 V output condition, reducing the input voltage to 7.5 V and below may obtain a relatively ideal steady-state inductance, so as to maintain a reasonable steady-state efficiency;

The above conclusions are equally effective for a multi-phase TLVR power supply scheme consisted by a multi-phase integrated TLVR module or a two-phase TLVR module.

On the basis of the analysis of the simulation data in FIG. 27, the pin configuration diagram of the multi-phase TLVR module shown in FIG. 23 does not set a TLVR function extension pin TLC/TLG, and is suitable for a TLVR module having a phase number greater than or equal to 8, the connection of the auxiliary winding loop thereof is completed inside the TLVR module, and the compensation inductor is integrated; the arrangement of the TLVR auxiliary winding loop on the load mainboard is eliminated, and the interference of high-frequency ripple on the auxiliary winding loop on the signal circuit of the load mainboard is reduced; the present application also reduces the difficulty in designing the load mainboard due to the presence of high voltage in the loop of the auxiliary winding. While the pin setting diagram of the multi-phase TLVR module shown in FIGS. 24-26 is provided with a TLVR function extension pin TLC/TLG, which is suitable for a TLVR module with a number of phases less than or equal to 8, and the TLC/TLG can be arranged at different positions, so that the connection of the multi-phase extension loop can be easily implemented on the load mainboard. The above description is only one embodiment of the optimal design, that is, when the number of phases is less than 8, the method shown in FIG. 23 can also be used to implement the connection of the TLVR auxiliary winding loop inside the VRM; and when the number of phases is greater than 8, the method described in FIGS. 24-26 can also be used, so as to realize the TLVR function with a greater number of phases.

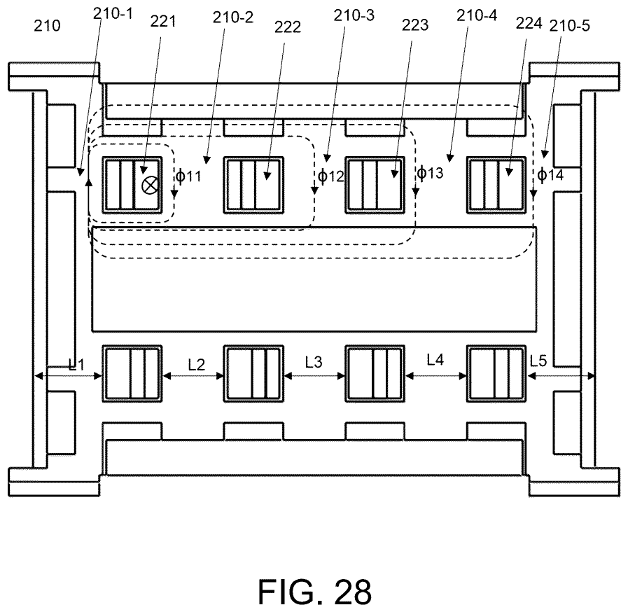

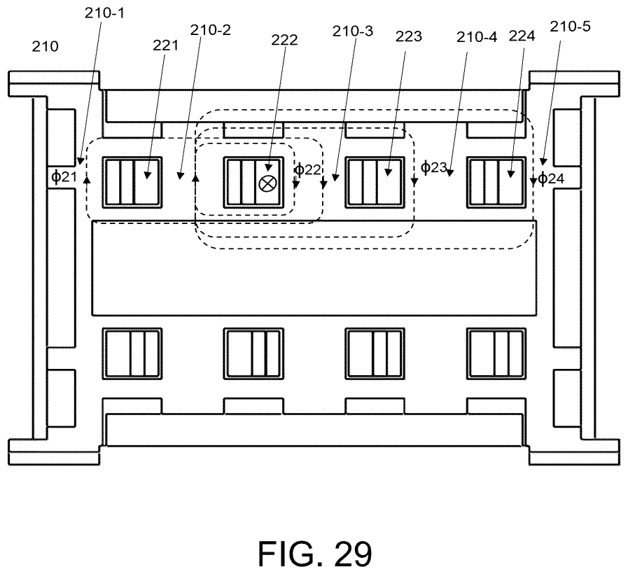

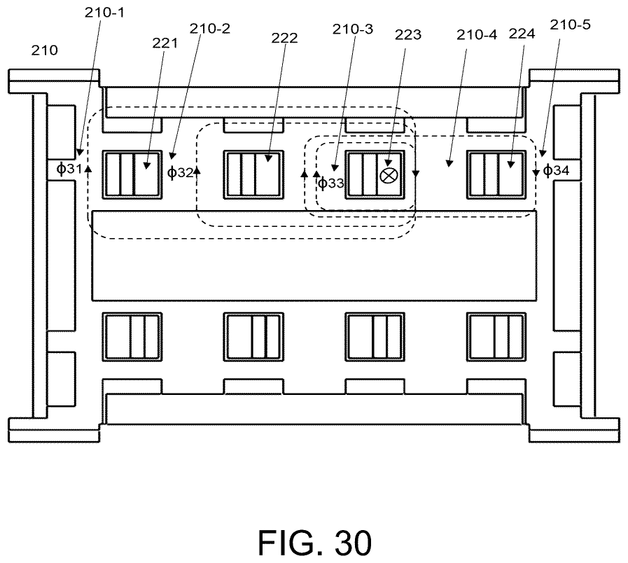

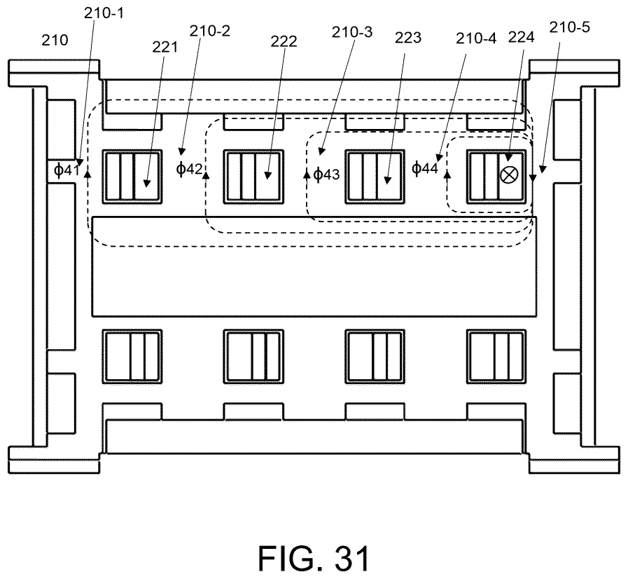

FIG. 28 to FIG. 31 are schematic diagrams of the magnetic flux generated by the currents in the first main winding, the second main winding, the third main winding and the fourth main winding of the magnetic core 210 in FIG. 21. As shown in FIG. 28 to FIG. 31, the magnetic core is provided with a first magnetic column 210-1, a second magnetic column 210-2, a third magnetic column 210-3, a fourth magnetic column 210-4 and a fifth magnetic column 210-5, the length of the first magnetic column is denoted as L1, the length of the second magnetic column is denoted as L2, the length of the third magnetic column is denoted as L3, the length of the fourth magnetic column is denoted as L4, and the length of the fifth magnetic column is denoted as L5. The current in the main winding is flowing from the SW point of the IPM to the Vo of the bottom assembly, so the current in the main winding flows from the top surface of the magnetic core to the bottom surface of the magnetic core; the magnetic fluxes generated by the any two main windings are directly coupled to each other, that is, the magnetic flux generated by the currents in any two main windings is superimposed on each other in the magnetic columns except for the column between the two main windings, and is cancelled each other out in the magnetic column between the two main windings; therefore, direct current magnetic flux generated by the current in the first main winding to the fourth main winding is completely superimposed in the first magnetic column and the fifth magnetic column; direct current generated by the current in the first main winding to the fourth main winding is partially cancelled out in the second magnetic column and the fourth magnetic column; direct current magnetic flux generated by the current in the first main winding to the fourth main winding is completely cancelled in the third magnetic column. Different magnetic columns of the magnetic core are subjected to different degrees of magnetic flux bias, and in order to equalize the inductance of different phases, the design of a better magnetic column length may be configured according to L1=L5, L2=L4, and L1 and L5 are greater than L2 and L4; and L2 and L4 are greater than L3. In the present embodiment, only 8-phase TLVR is used as an example, and the cases of more phases are similar in sequence.

### Embodiment 4

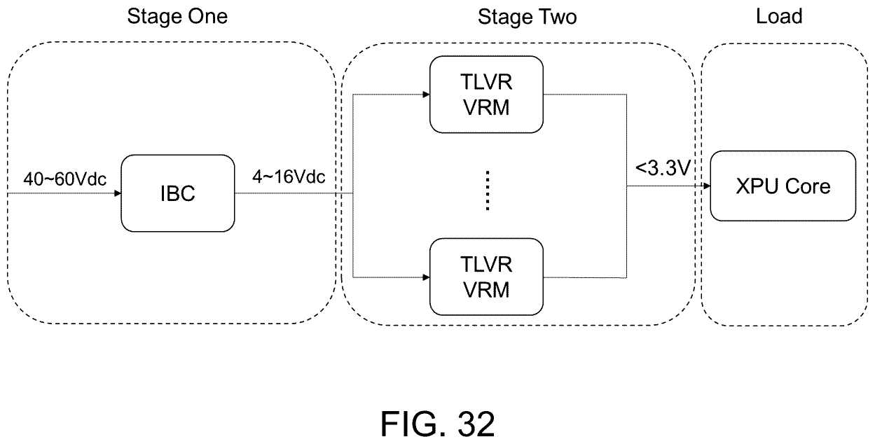

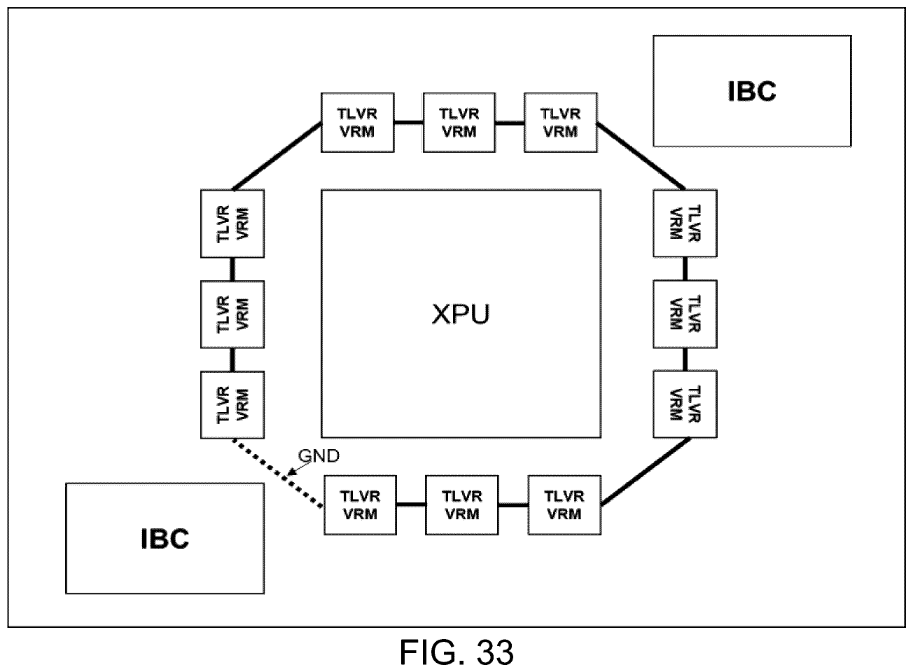

FIG. 32 is a schematic diagram of a core power supply system of an XPU processor, and FIG. 33 is a schematic structural diagram of a core power supply system of an XPU processor. As shown in FIG. 32, the power supply system comprises a first stage and a second stage connected in sequence, and the first stage converts a 48 VDC input voltage into an intermediate voltage of 4-16 VDC by means of an Intermediate Bus Converter; the IBC may be an LLC converter, which may be a Switched Tank Converter (STC), or may be a Hybrid Switched Capacitor Converter (HSC), which is not limited herein. The second stage is converted from a voltage of 4-16 VDC to a DC voltage around 1V by the TLVR module of the present embodiment to supply power to the core of the XPU processor. Generally, the second stage employs a two-phase or multi-phase interleaved Buck circuit; the number of TLVR modules is selected according to the power size of the XPU core processor, typically in parallel by a plurality of TLVR module input outputs to increase power output capability. FIG. 33 to FIG. 37B are horizontal power supply embodiments. As shown in FIG. 33, IBC is arranged on the same side of the XPU and is arranged at the position of the XPU pair. The two-phase TLVR module is uniformly arranged around the XPU, and the plurality of TLVR modules are connected end to end by means of the TLVR function extension pins to form a loop. The TLG pin of the first TLVR module and the TLC of the last TLVR module can also be connected to the GND end, as shown in the dotted line GND. 12 TLVR modules are shared in FIG. 33, therefore, after the pins are connected in series into one loop by means of the TLVR function extension pins, a 24-phase TLVR is realized. The advantage of this configuration is that the TLVR module is uniformly arranged around the XPU, so that the power supply pins around the XPU can be balanced, and when the number of the two-phase TLVR modules required by the XPU is less than 8, the connection method in FIG. 33 can achieve better performance;

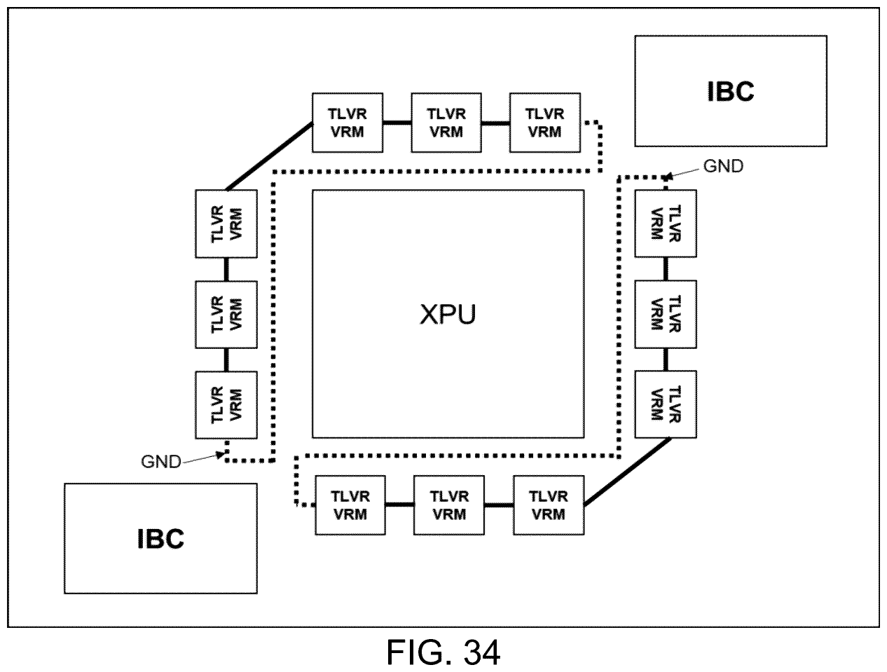

FIG. 34 is another embodiment of FIG. 33, the difference between FIG. 34 and FIG. 33 is that FIG. 34 bisects the TLVR module around the XPU, and connects TLVR modules on the left and upper sides of the XPU in series by means of the TLVR function extension pins; the TLVR modules on the right side and the lower side of the XPU is connected in series by means of a TLVR function extension pin; two TLVR loops are formed, that is, a TLVR power supply solution of two 12 phases is formed respectively; when the number of two-phase TLVR modules required by the XPU is greater than or equal to 8, the connection method in FIG. 34 may achieve better performance.

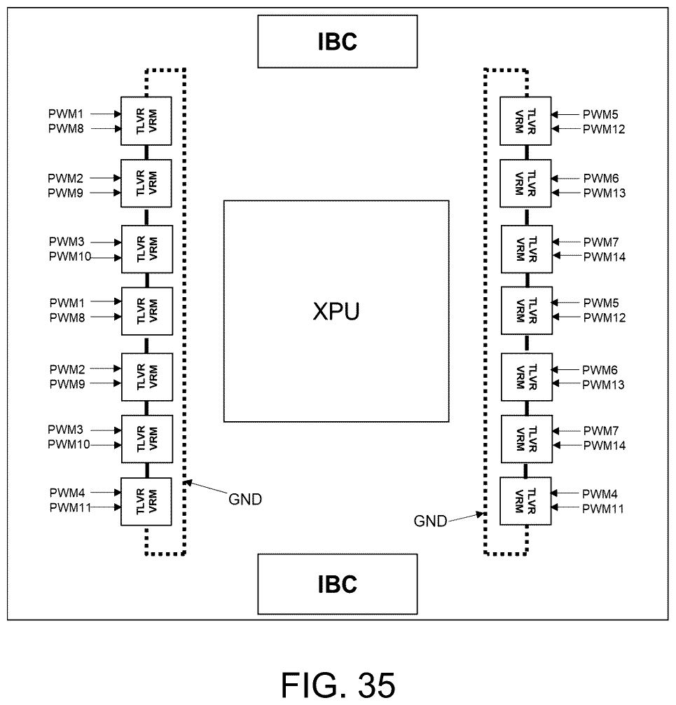

FIG. 35 shows another preferred embodiment, the IBC is disposed at the upper side and the lower side of the XPU, the TLVR module is disposed on the left side and the right side of the XPU, and the controller uses a driven mode of “one-drive-two” (the controller is not shown), that is, the controller outputs one set of PWMs to simultaneously drive two two-phase TLVR modules; the N TLVR modules on the left side of the XPU may be connected in series to form a loop to implement a 2N-phase TLVR function; the N TLVR modules on the right side of the XPU may be connected in series to form a loop, and also achieve a 2N-phase TLVR function. As shown in FIG. 35, when one-drive-two PWM control is used, the N TLVR modules on the left of the XPU require N/2 sets of PWM drives (N is an even number), or (N+1)/2 sets of PWM drives (N is an odd number); the right side is also the same. The left 7 TLVR modules as shown in FIG. 35 require four sets of PWM drives, namely a first set (PWM 1 & PWM 8), a second set (PWM 2 & PWM 9), a third set (PWM 3 & PWM 10), a fourth set (PWM 4 & PWM 11); the right 7 TLVR modules shown in FIG. 35 require four sets of PWM drives, namely a first set (PWM 5 & PWM 12), a second set (PWM 6 & PWM 13), a third set (PWM 7 & PWM 14), a fourth set (PWM 4 & PWM 11); the left first, second and third sets of PWMs respectively drive two TLVR modules on the left, and the first, second and third sets of PWMs on the right respectively drive two TLVR modules on the right; the fourth group of PWM on the left and the fourth group of PWM on the right are the same, that is, the PWM 4 & PWM 11 simultaneously drives one module on the left and one module on the right. The TLVR module in FIG. 35 is simple in connection manner, such that the parasitic inductance of the connection loop of the TLVR auxiliary winding can be minimized, which is beneficial to the reduction of the dynamic inductance; however, in the control mode of one drive two, in the loop on the same side, there are two two-phase VRMs have the same PWM phase, and actually equivalent phases are less than twice the number of VRMs; it is not conducive to the improvement of steady-state inductance;

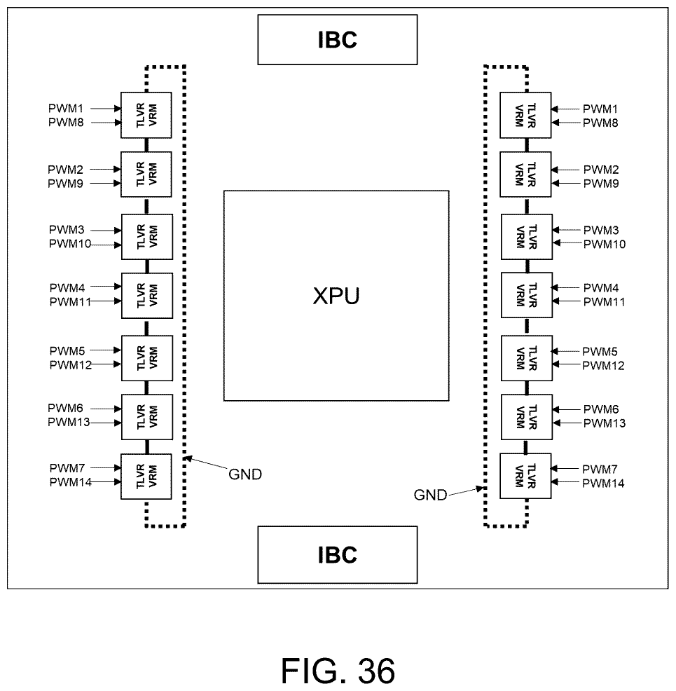

FIG. 36 is an improved manner of FIG. 35, as shown in FIG. 36, the N TLVR modules on the left are driven by N groups of PWMs, and the N TLVR modules on the right are also driven by N sets of PWMs, because of the drive control of one drive two, the N sets of PWMs on the left drive the N VRMs on the right at the same time, as shown in FIG. 36, that is, the first set (PWM 1 & PWM 8) drives the left first VRM and the right first VRM, and the second set (PWM 2 & PWM 9) drives the left second VRM and the right second VRM, the third set (PWM 3 & PWM 10) drives the left third VRM and the right third VRM, the fourth set (PWM 4 & PWM 11) drives the left fourth VRM and the right fourth VRM, the fifth set (PWM 5 & PWM 12) drives the left fifth VRM and the right fifth VRM, the sixth set (PWM 6 & PWM 13) drives the left sixth VRM and the right sixth VRM, and the seventh set (PWM 7 & PWM 14) drives the left seventh VRM and the right seventh VRM. The connection mode and control mode shown in FIG. 36 can simplify the electrical connection of the TLVR auxiliary winding loop, realize the left 2N-phase TLVR function, and the right-side 2N-phase TLVR function, but all drive control signals need to be connected to the left side and the right side, and the signal wiring is complex and susceptible to interference.

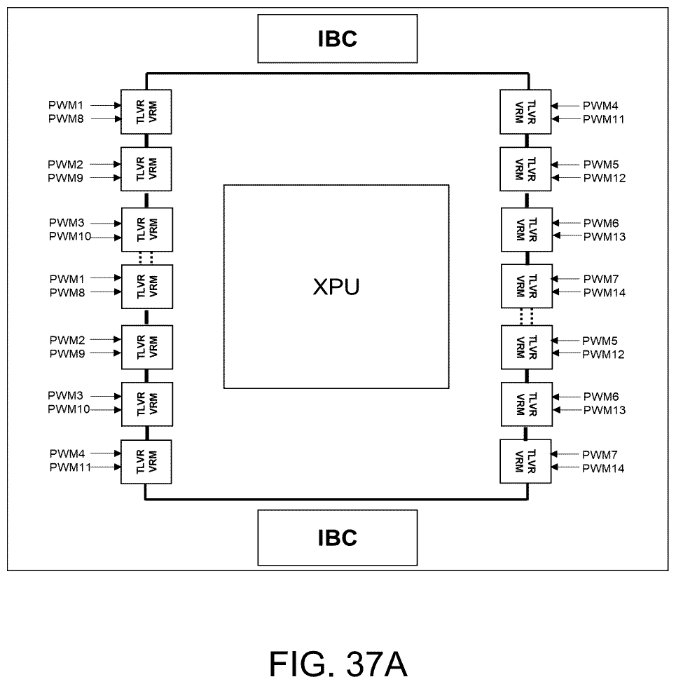

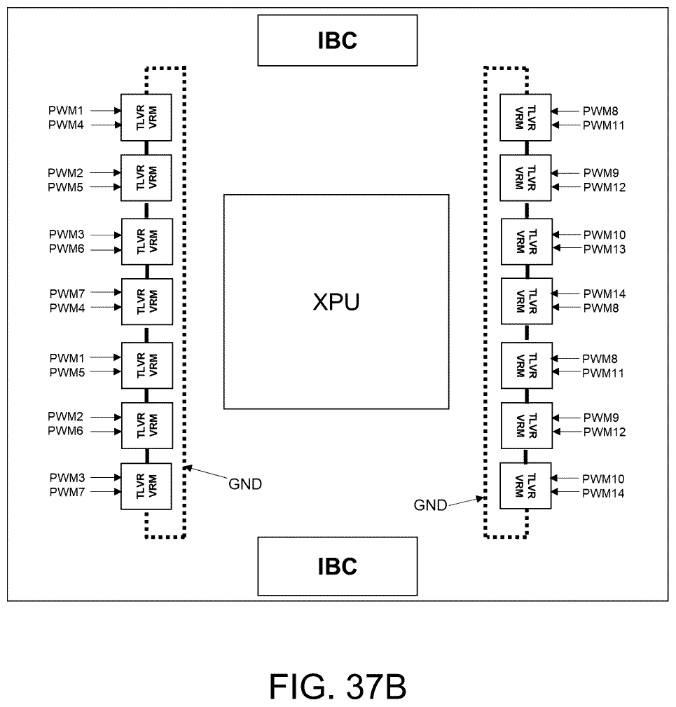

FIG. 37A is an improved manner of FIG. 36, a half VRMs on the left and a half VRMs on the right are connected in series by means of a TLVR function extension pin to form a TLVR loop, and the dashed line represents a connection GND end; the other half VRMs on the left and the other half VRMs on the right are connected in series by means of a TLVR function extension pin to form another TLVR loop; N VRM modules on the left are required to be driven by N/2 sets of PWMs, and the N VRM modules on the right also require N/2 sets of PWMs. However, in the same TLVR loop, the phases all differ by 360/N degrees, that is, the same set of PWMs both drive one module in the first TLVR loop and drive the VRM in the other TLVR loop; ensure the drives in one N-phase TLVR loop have a phase difference of 360/N degrees; in the same TLVR loop, the phases of VRMs disposed on the same side differ by 180/N degrees, ensuring that the phase is more balanced. And, two VRMs driven by the same set of PWMs are arranged on the same side of the XPU, and (each side is provided with only an odd number of VRMs, a set of PWMs both drive one VRM module on the left and a VRM module on the right) as shown in FIG. 37A, and the upper three VRM modules on the left side of the XPU and the upper four VRM modules on the right side are connected together in series by means of TLVR function extension pins; the lower four VRM modules on the left side of the XPU and the lower three VRM modules on the right side are connected together in series by means of the TLVR function extension pins; a first set (PWM1 & PWM8) drive a first VRM module and a fourth module on the left side of the XPU.; a second set (PWM 2 & PWM9) drive a second VRM module and a fifth module on the left side of the XPU; a third set (PWM 3 & PWM10) drive a third VRM module and a sixth module on the left side of the XPU; a fourth set (PWM 4 & PWM11) drives the seventh VRM module on the left side of the XPU and the first module on the right side of the XPU; a fifth set (PWM 5 & PWM 12) drive a second VRM module and a fifth module on the right side of the XPU; a sixth set (PWM 6 & PWM 13) drive a third VRM module and a sixth module on the right side of the XPU; a seventh set (PWM 7 & PWM14) drive a fourth VRM module and a seventh module on the right side of the XPU. Therefore, the upper three VRMs on the left and the upper four VRMs on the right constitute a 14-phase TLVR technology; the lower four VRM modules on the left side and the lower three VRM modules on the right side form a 14-phase TLVR technology; the dynamic inductance is reduced, the steady-state inductance is improved, and a one-drive-two control mode is used, so that the wiring of the control line is simplified, the cost is saved, and the wiring space on the mainboard is saved. The method of the present embodiment ensures that the 2N-phase TLVR module reduces the dynamic inductance, improves the technical effect of the steady-state inductance, reduces the control signal wiring of the one-drive-two, saves costs, and saves the wiring space of the mainboard.

FIG. 37B is another improved manner of FIG. 36, as shown in FIG. 37A, the left N TLVR modules are driven by N PWMs, the right N TLVR modules are also driven by N PWMs, because of the drive control of one drive two, in order to achieve phase equalization between every two phases, each PWM drives a two-phase IPM in different VRM modules as shown in FIG. 37A, i.e. the first PWM 1 drives a first phase IPM in a first VRM on the left and a first phase IPM in a fifth VRM on the left; the second PWM 2 drives a first phase IPM in a second VRM on the left and a first phase IPM in a sixth VRM on the left; the third PWM 3 drives a first phase IPM in a third VRM on the left and a first phase IPM in a seventh VRM on the left; the fourth PWM 4 drives a second phase IPM in the first VRM on the left and a second phase IPM in the fourth VRM on the left; the fifth PWM 5 drives a second phase IPM in the left second VRM and a second phase IPM in the fifth VRM on the left; the sixth PWM 6 drives a second phase IPM in the third VRM on the left and a second phase IPM in the sixth VRM on the left; the seventh PWM 7 drives a first phase IPM in the fourth VRM on the left and a second phase IPM in the seventh VRM on the left; when N is an even number, the driving PWM phases of the two phase IPMs in the same module differ by (360/N)*(N/2) degrees; when N is an odd number, the driving PWM phase of the two phase IPMs in the same module is different (360/N)*((N-1)/2) degrees; the control mode of the N TLVR modules on the right is the same as the driving of the N TLVR modules on the left, which will not be repeated here; by means of the above arrangement, the PWM phase of the IPM in the 2N-phase VRM in one TLVR loop is balanced, and the wiring of the control signal is simple.

The smaller the area of the loop of the TLVR auxiliary winding in the present embodiment, the better the parasitic inductance of the loop is reduced, so as to reduce the dynamic inductance. An effective embodiment is that the GND end is realized by covering the auxiliary winding loop with a large area of copper.

### Embodiment 5

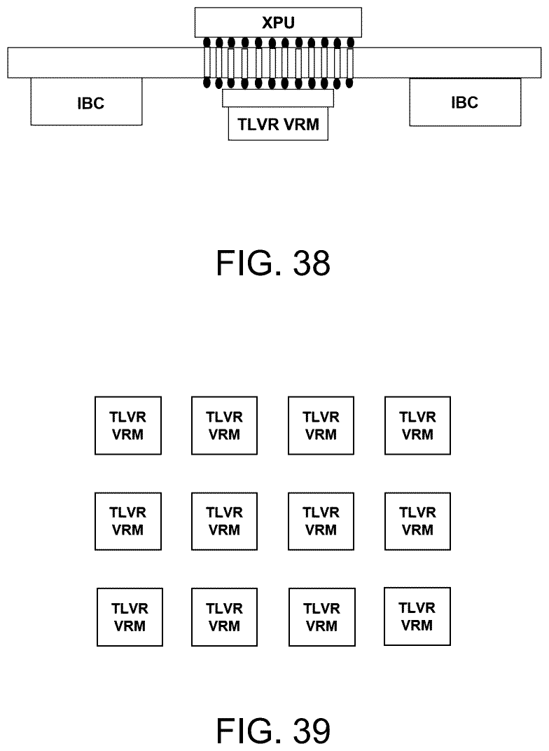

FIG. 38 is a schematic diagram of a vertical power supply structure for supplying power to an XPU processor; as shown in FIG. 38, in the vertical power supply structure, IBC is also provided on the other outer side of the main board opposite to the XPU, that is, the XPU is provided on the top surface of the mainboard, and IBC and TLVR module are provided on the bottom surface of the mainboard; since it is the bottom surface of the XPU, the TLVR module can have a large centralized area for placement; and FIG. 39 shows a rectangular arrangement mode in which the two-phase TLVR module is arranged into m rows*n columns, which is arranged on the bottom surface of the mainboard and supplies power to the XPU.

Optionally, the two-phase TLVR module integrates the output capacitor Co; a preferred embodiment is to set the M*n modules on one adapter board to form an integral 2*M*N-phase TLVR module, then soldered on the bottom surface of the mainboard, and supply power to the XPU.

Another preferred embodiment is that the bottom substrate 310 of the bottom assembly 300 of the m*n two-phase TLVR modules is physically connected together, that is, the top assembly and the middle assembly of the m*n TLVR modules share one bottom substrate to form 2*m*n-phase TLVR with integrated output capacitor, such integration is convenient for customer applications, and during application, the number of the welding process is reduced by one.

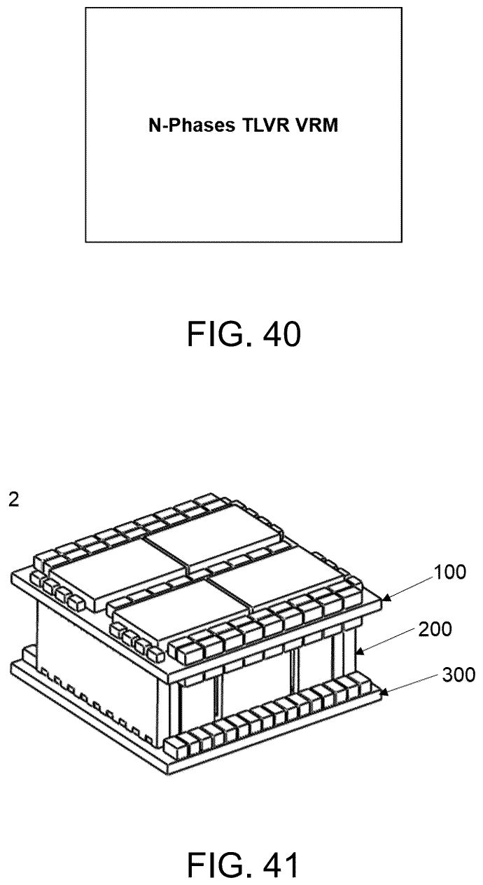

FIG. 40 is the integrated N-phase TLVR module of FIG. 2, which can be directly welded to the bottom surface of the mainboard and used for supplying power to the XPU to realize N-phase TLVR module; of course, m integrated N-phase TLVR modules described in FIG. 18 can also be used to be soldered on the bottom surface of the mainboard to supply power to the XPU, so as to realize a m*N phase TLVR power supply scheme or m N-phase TLVR parallel solutions.

It should be noted that the above embodiments are merely illustrative and are not limited thereto, and the present embodiments may also be combined with different embodiments, which are not listed one by one herein.

### Embodiment 6

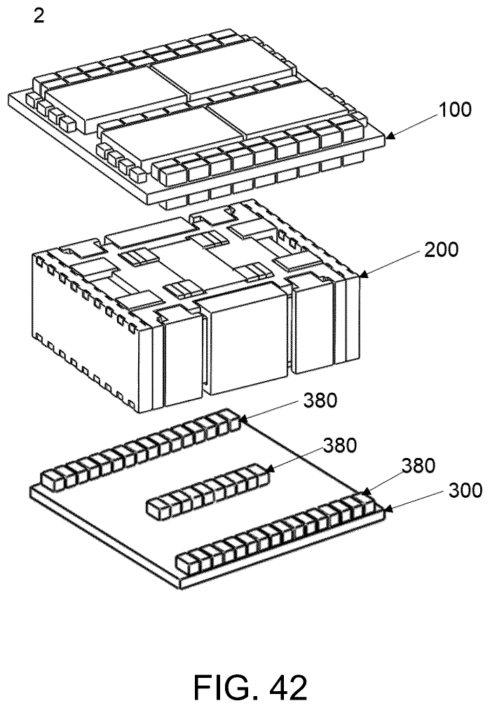

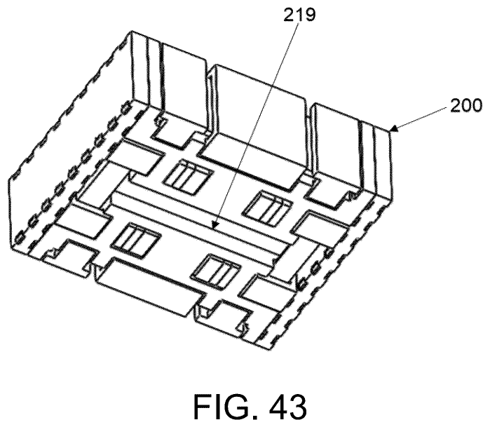

FIG. 41 is another embodiment of a multi-phase TLVR module, which is described by taking a 4-phase TLVR module as an example; FIG. 42 is a structural exploded view of FIG. 41, and FIG. 43 is a schematic structural diagram of the middle assembly 200 in FIG. 42. The embodiment of the present embodiment has the same technical effect as the embodiment described in FIG. 18. The difference between this embodiment and the embodiment shown in FIG. 18 is that the length and width of the middle assembly 200 is reduced, and the middle assembly and the substrate of the bottom assembly 300 are directly electrically connected, thereby eliminating the copper pillar connection between the bottom substrate and the middle assembly; the middle assembly has a reduced size space and can be used to provide an output capacitor 380 on the bottom substrate, and, the bottom of the magnetic core in the middle assembly is provided with a groove 219 for accommodating the output capacitor 380 on the bottom substrate, so that more output capacitors are provided on the bottom substrate; and the copper pillar on the bottom substrate is removed, so that the connection point of the large current is reduced, the direct current impedance of the large current path is reduced, and the efficiency is improved. Because the size of the middle component is reduced, more input capacitors may also be provided at the bottom of the top substrate to improve efficiency.

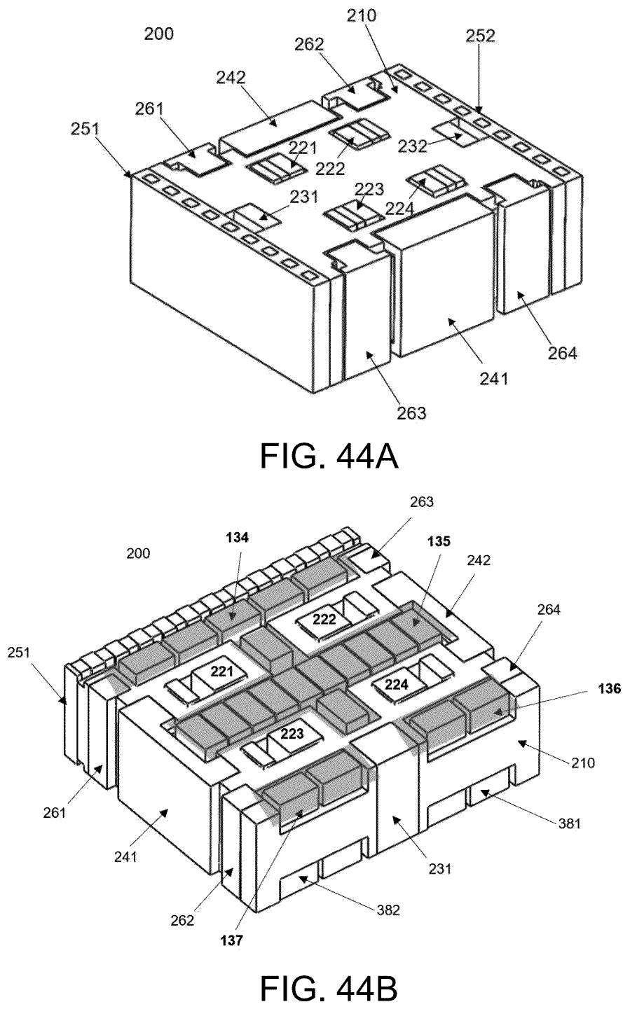

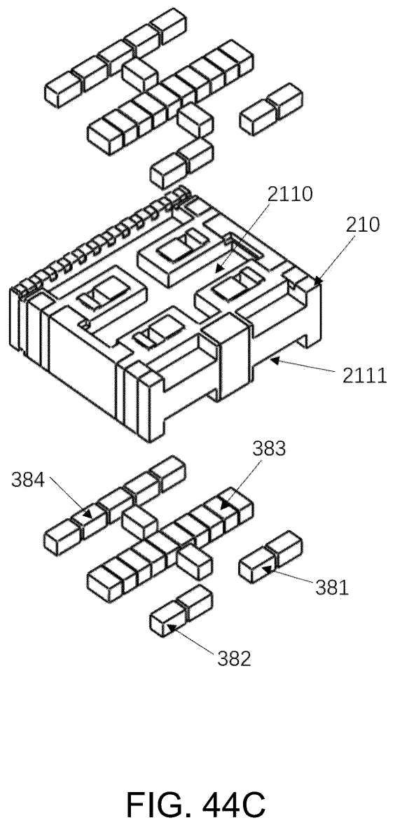

FIG. 44A is another preferred embodiment of FIG. 43, as shown in FIG. 44A, the difference from FIG. 43 is that the position setting of the power electrical connector is different: the first power electrical connector 231/232 is respectively disposed on the second side surface and the fourth side surface of the magnetic core; the second power electrical connectors 241/242 are respectively arranged on the third side surface and the first side surface of the magnetic core; the first auxiliary winding electrical connector 261 and the second auxiliary winding electrical connector 262 are both disposed on a third side surface of the magnetic core, and the first auxiliary winding electrical connector 261 and the second auxiliary winding electrical connector 262 are staggered with the second power electrical connector 242, so that the coupling coefficient between the main winding and the auxiliary winding loop is higher; the third auxiliary winding electrical connector 263 and the fourth auxiliary winding electrical connector 264 are disposed on the first side surface of the magnetic core, and the third auxiliary winding electrical connector 263 and the fourth auxiliary winding electrical connector 264 are staggered with the second power electrical connector 241, so that the coupling coefficient between the main winding and the auxiliary winding loop is higher. When the number of phases is greater than four phases, the number of auxiliary winding electrical connectors and the number of second power electrical connectors are increased, and the increased auxiliary winding electrical connector and the second power electrical connector are still staggered, so that the coupling coefficient between the main winding and the auxiliary winding loop is high. The first power electrical connector 231 and the second power electrical connector in the present embodiment are respectively disposed on different sides of the magnetic core, such that the parasitic inductance of the input loop is increased, and the resonant frequency between the capacitance in the input loop and the parasitic inductance is much lower than the equivalent switching frequency of the module, thereby facilitating the improvement of the efficiency of the module pair and enabling the module to operate stably and reliably.

FIG. 44B and FIG. 44C are another preferred embodiment of FIG. 44A, and FIG. 44C is an exploded view of FIG. 44B. As shown in FIG. 44B, the difference between FIG. 44B and FIG. 44A is that the top surface and the bottom surface of the magnetic core 210 are each provided with a groove for accommodating the input capacitor Cin and the output capacitor Co, and the shape and position of the groove are not limited; however, the shortest distance between the side wall or the bottom surface of the groove and the adjacent winding needs to be greater than or equal to 0.5 mm, so as to reduce the influence of the groove on the inductance performance. In detail, the groove 2110 on the top surface of the magnetic core 210 is used for accommodating the input capacitors 134, 135, 136, 137, etc. welded to the bottom surface of the substrate 110 in the top assembly, so as to increase the capacitance value of the input capacitor Cin, reduce the ripple of the input current, and improve the efficiency and reliability of the module. The groove 2111 on the bottom surface of the magnetic core 210 is used for accommodating the output capacitors 381, 382, 383, 384, etc. provided on the substrate 310 in the bottom assembly, so as to increase the capacitance value of the output capacitor so as to improve the dynamic performance of the output voltage of the module. Each part in the groove 2110 may be integrally connected, or may be independent of each other. Similarly, each part in the groove 2111 may be integrally connected, or may be independent of each other.

### Embodiment 7

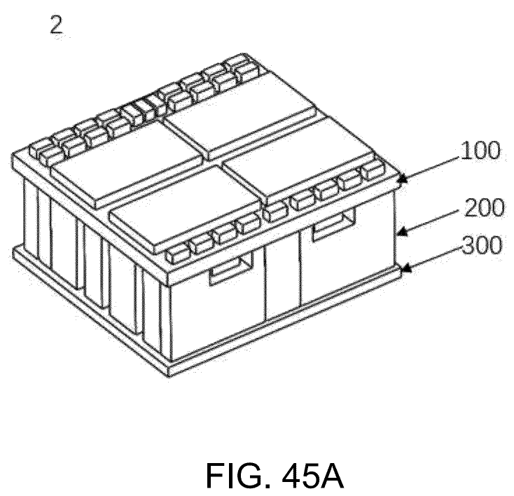

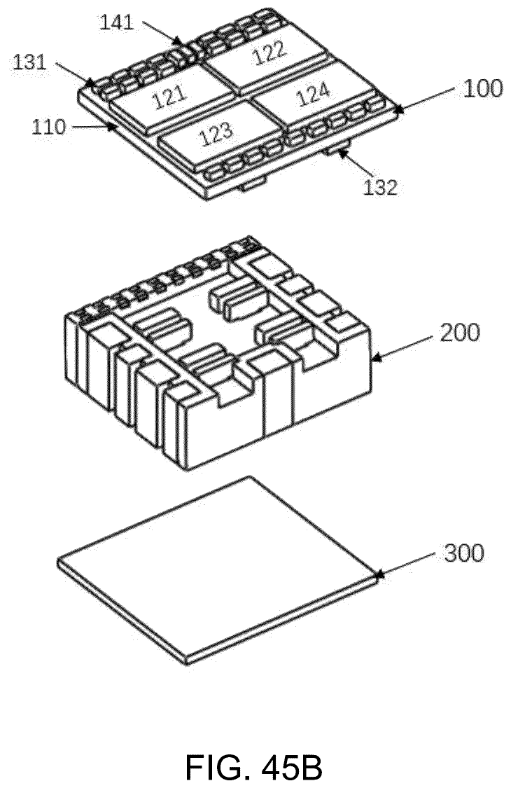

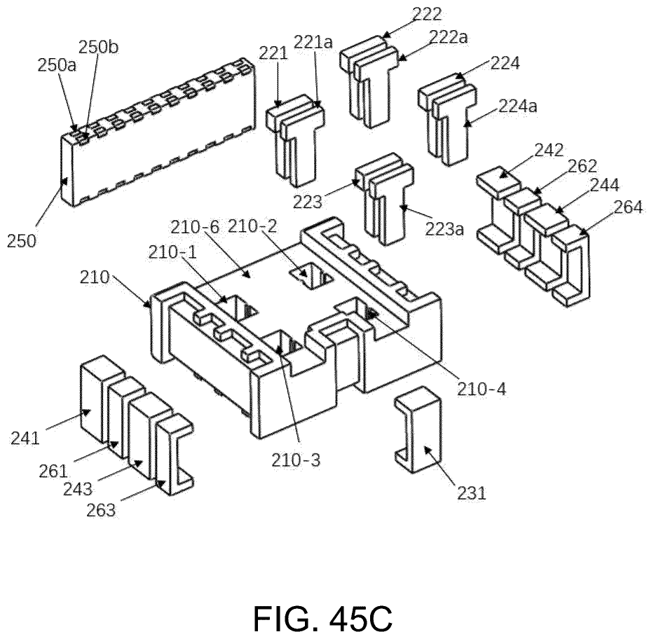

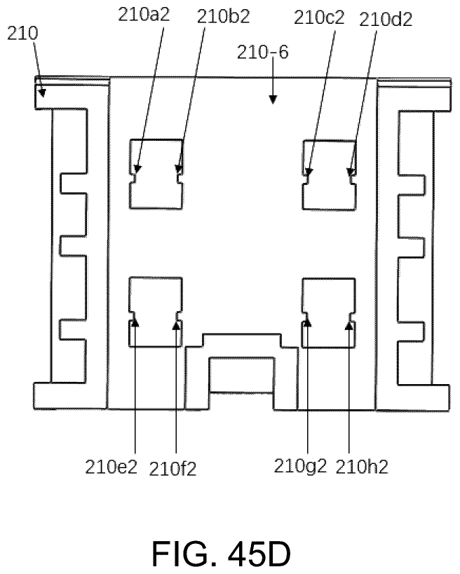

FIG. 45A to FIG. 45D are another embodiment of a multi-phase TLVR module, and the present embodiment is described by taking a 4-phase TLVR module as an example; FIG. 45A is a three-dimensional structure schematic diagram, and FIG. 45B is an exploded schematic diagram. Referring to FIG. 45A and FIG. 45B, the multi-phase TLVR module comprises a top assembly 100, the middle assembly 200 and the bottom assembly 300, top assembly 100 comprises a top substrate 110, a first IPM 121, a second IPM 122, a third IPM 123, a fourth IPM 124, an input capacitor 131/132, and other passive elements 141; the IPMs 121/122/123/124 are arranged on the top surface of the top substrate 110 by using a 2×2 array; the input capacitor 131 is arranged on the top surface of the top substrate 110 and is arranged on two opposite sides of the IPM array, and the input capacitor 132 is arranged on the bottom surface of the top substrate 110. A certain gap is reserved between the IPMs and between the input capacitor and the IPM, and the gap has a certain width, such as greater than 600 μm; in the underfill process, the gap width can ensure that the glue needle penetrates into the surface of the substrate; in addition, the pad can be prevented from contaminating the input capacitor by the underfill, and the soldering defect rate is reduced.

FIG. 45C is an exploded view of the middle assembly, and FIG. 45D is a schematic top view of the magnetic core 210 in FIG. 45C. As shown in FIG. 45C and FIG. 45D, the middle assembly 200 comprises a magnetic core 210, a first main winding 221, a first auxiliary winding 221a, a second main winding 222, a second auxiliary winding 222a, a third main winding 223, a third auxiliary winding 223a, a fourth main winding 224, a fourth auxiliary winding 224a, a first power electrical connector 231, a second power electrical connector 241/242/243/244, an auxiliary winding electrical connector 261/262/263/264 and a signal electrical connector 250.

The magnetic core 210 comprises a window 210-1/210-2/210-3/210-4 and a groove 210-6. The groove 210-6 is formed by recessing the top surface of the magnetic core, and is used for accommodating the input capacitor 132. Windows 210-1/210-2/210-3/210-4 all penetrating through the bottom surface of the groove and the bottom surface of the magnetic core. Each window is provided with a protrusion, a protrusion 210a2/210b2 is arranged in the window 210-1, a protrusion 210c2/2210d2 is arranged in the window 210-2, a protrusion 210e2/210f2 is arranged in the window 210-3, the protrusion 210g2/210h2 is arranged in the window 210-4. These protrusions are arranged on the inner side wall of the window, and can extend from the bottom surface of the groove to the bottom surface of the magnetic core, or extend from the bottom surface of the groove to a part of the entire window depth.

One main winding and one auxiliary winding are disposed in the same window, and the protrusion is used for physically isolating the main winding and the auxiliary winding to ensure electrical isolation between the main winding and the auxiliary winding. The main winding and the auxiliary winding are both in “T”-shape, the T-shaped winding comprises a horizontal portion and a vertical portion, the vertical portion of the winding passes through the window, and the length of the horizontal portion of the winding is greater than the width of the window; this ensures that the of the magnetic core window and the protrusion in the window can play a role of limiting the winding. The main winding horizontal part and the auxiliary winding horizontal part are attached to the bottom surface of the groove, and can be used for dispensing glue, so as to fix the winding and the magnetic core.

The first power electrical connector 231 is provided with the first side surface of the magnetic core; the second power electrical connector 241/243 and the auxiliary winding electrical connector 261/263 are disposed on the second side surface of the magnetic core; and the second power electrical connector 242/244 and the auxiliary winding electrical connector 262/264 are disposed on the fourth side surface of the magnetic core. The second power electrical connector and the auxiliary winding electrical connector in the same phase Buck circuit are arranged together, thereby improving the coupling between the main winding loop and the auxiliary winding loop, reducing the dynamic inductance by means of the TLVR technology, and improving the dynamic performance of the TLVR module.

The signal electrical connector 250 is provided on the third side surface of the magnetic core, the signal electrical connector is a signal electrical connection plate and the signal electrical connection plate is provided with a double-row signal pin, such as 250a and 250b in FIG. 45C, so that the signal electrical connection plate can transmit more signals.

### Embodiment 8

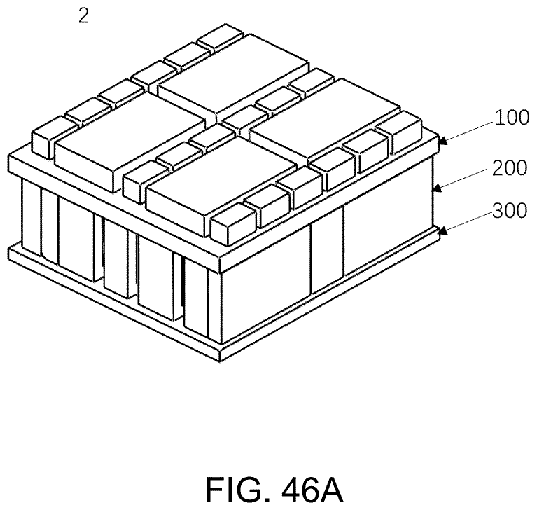

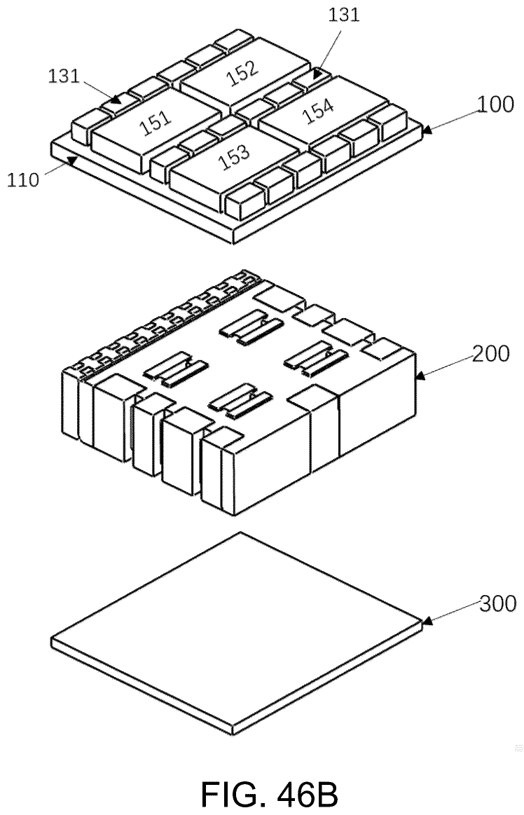

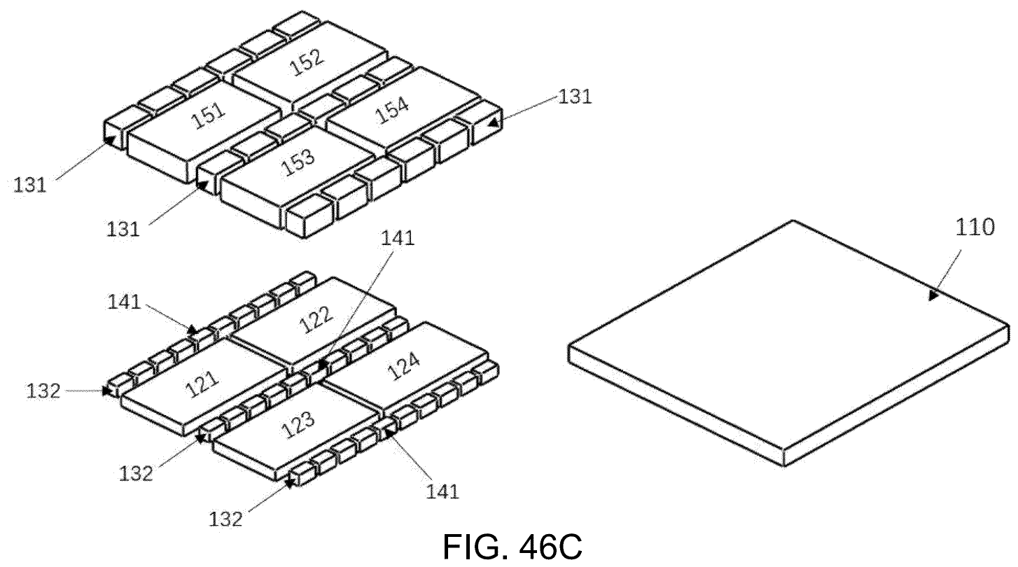

FIG. 46A to FIG. 46C are another embodiment of a multi-phase TLVR module, FIG. 46A is a three-dimensional structure diagram of a VRM, FIG. 46B is an exploded schematic diagram, and FIG. 46C is an exploded schematic diagram of a top assembly. The present embodiment differs from Embodiment 7 in that the structure of the top assembly, as shown in FIG. 46A to 46C, the top assembly comprises a top substrate 110, a first IPM 121, a second IPM 122, a third IPM 123, a fourth IPM 124, an input capacitor 131/132, other passive elements 141 and a heat dissipation metal block 151/152/153/154. Top substrate 110 comprises a top surface and a bottom surface opposite to each other; an input capacitor 131, and a heat dissipation metal block 151/152/153/154 are provided on the top surface of the top substrate 110. The heat dissipation metal blocks 151/152/153/154 are arranged in a 2×2 array. The input capacitors 131 are arranged in three rows parallel to each other, and are respectively arranged between the heat dissipation metal blocks and two opposite sides of the heat dissipation metal array.

The first IPM 121, the second IPM 122, the third IPM 123, and the fourth IPM 124 are all MOSFETs of a horizontal channel technology. The input capacitor 132, the first IPM 121, the second IPM 122, the third IPM 123, and the fourth IPM 124 are embedded in the top substrate. The four IPMs are arranged in a 2×2 array. The input capacitors 132 are arranged in three rows parallel to each other, and are respectively disposed between the IPMs and two opposite sides of the IPM array. Projections of the IPM and the corresponding heat dissipation metal blocks on the top surface of the top substrate at least partially overlap; and the projections of the input capacitors 131 and the corresponding input capacitors 132 arranged on the top surface of the top substrate at least partially overlap.

### Embodiment 9

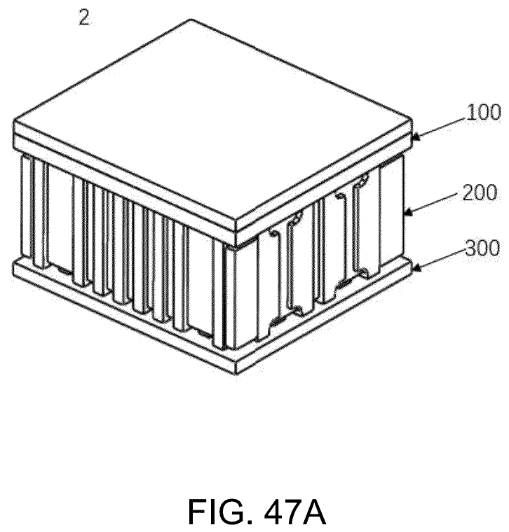

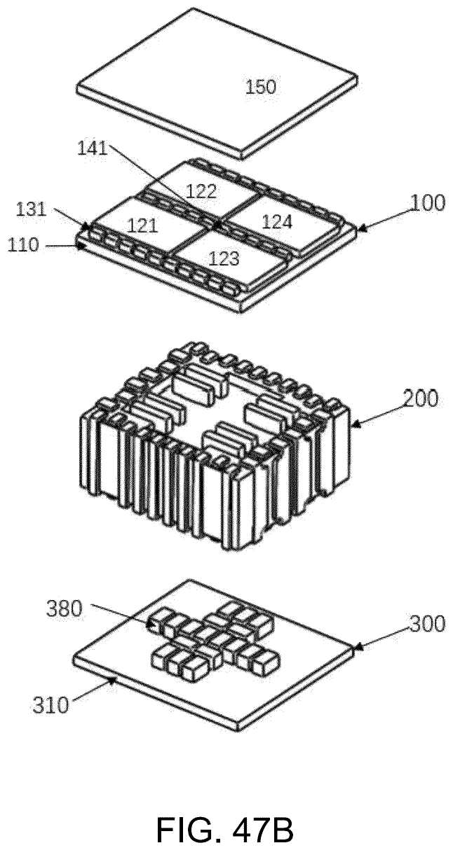

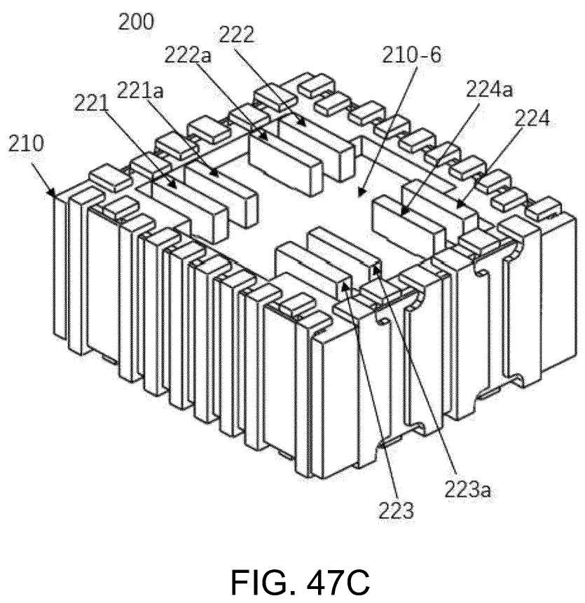

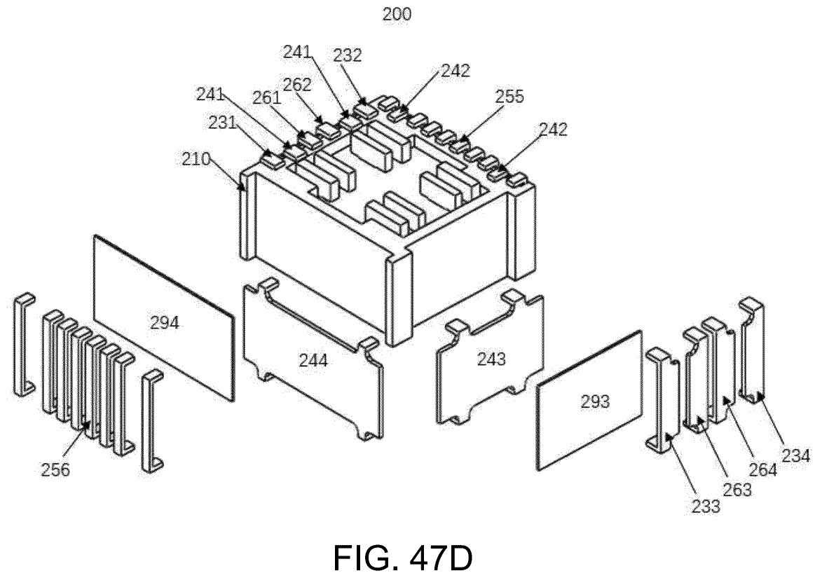

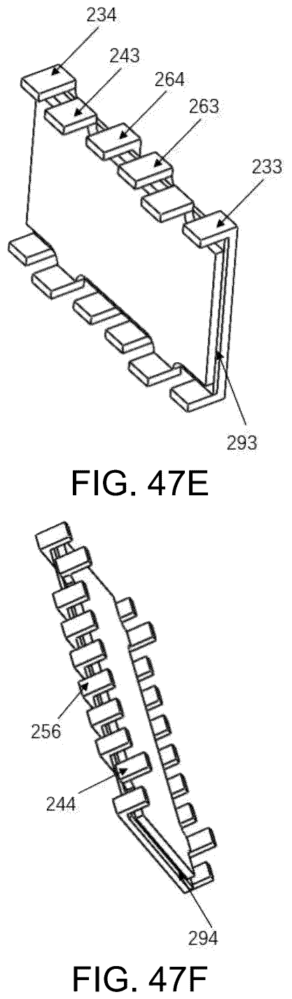

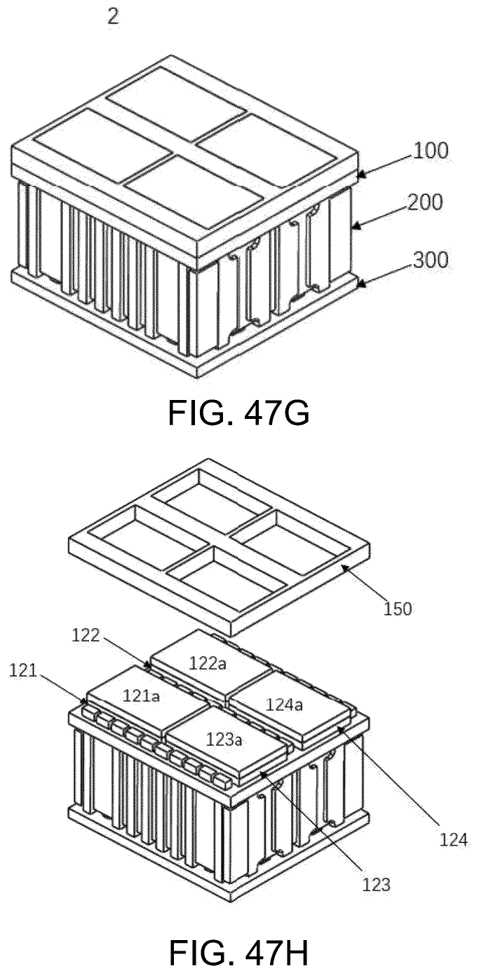

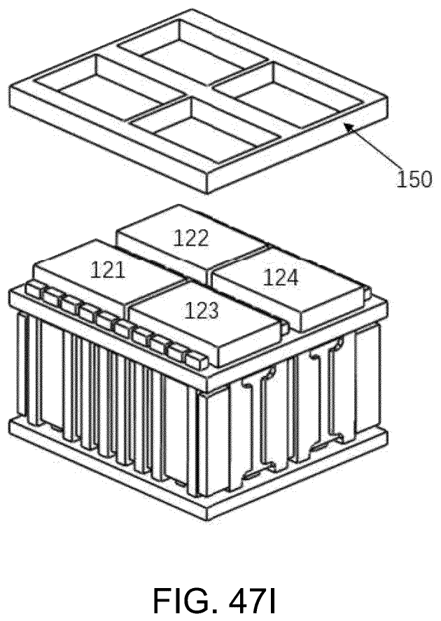

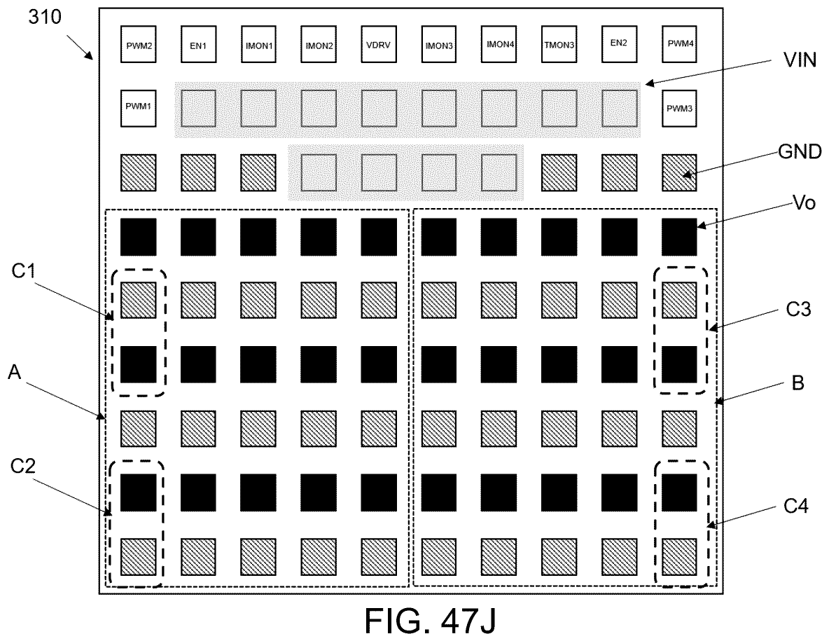

FIG. 47A to FIG. 47J are another implementation of a multi-phase TLVR module, and this embodiment is described by taking a 4-phase TLVR as an example; FIG. 47A is a schematic perspective view, and FIG. 47B is an exploded schematic diagram. Referring to FIG. 47A and FIG. 47B, the multi-phase TLVR module comprises a top assembly 100, a middle assembly 200 and a bottom assembly 300. Top assembly 100 comprises a top substrate 110, a first IPM 121, a second IPM 122, a third IPM 123, a fourth IPM 124, an input capacitor 131/132, and other passive elements 141. The IPM unit 121/122/123/124 is arranged on the top surface of the top substrate 110 by using a 2×2 array. The IPM unit in the present embodiment can be a bare silicon wafer. The input capacitor 131 is arranged on the top surface of the top substrate 110, and is divided into three columns arranged in parallel on two opposite sides of the IPM array and in the middle of the IPM array. The input capacitor 132 is disposed on a bottom surface (not shown) of the top substrate. Other passive elements 141 are provided on the top surface of the top substrate. The top surface of the top substrate and all devices disposed on the top surface are packaged to form a plastic package 150. In order to ensure that the plastic molding material flows sufficient and without resistance in the mold, a certain space (such as greater than 200 μm) can be reserved between the IPM units and between the IPM unit and the capacitor, thereby ensuring the quality and reliability of the plastic package. The bottom assembly 300 comprises a bottom substrate 310 and an output filter capacitor 380 disposed on a top surface of the bottom substrate 310.

FIG. 47C is a three-dimensional structure diagram of the middle assembly, and FIG. 47D is an exploded schematic diagram of the middle assembly. Referring to 47C and FIG. 47D, the middle assembly 200 comprises a magnetic core 210, a first main winding 221, a first auxiliary winding 221a, a second main winding 222, a second auxiliary winding 222a, a third main winding 223, a third auxiliary winding 223a, a fourth main winding 224, a fourth auxiliary winding 224a, a first power electrical connector 231/232/233/234, a second power electrical connector 241/242/243/244, an auxiliary winding electrical connector 261/262/263/264 and a signal electrical connector combination 255/256. Magnetic core 210 is provided with a groove 210-6 for accommodating the input capacitor 132; a groove 210-7 (not shown) is provided on the bottom surface of the magnetic core 210, and is used for accommodating the output filter capacitor 380. The magnetic core 210 further comprises a window 210-1/210-2/210-3/210-4, the window penetrates from the top surface groove 210-6 to the bottom surface groove 210-7. The protrusion provided in window are the same as the aforementioned embodiment, which will not be repeated here. The main winding and the auxiliary winding are all arranged in a “T” shape. The T-shaped winding comprises a horizontal portion and a vertical portion. The length of the horizontal portion is greater than the width of the magnetic core window so as to ensure the limitation to the windings from the magnetic core window and the protrusion in the window. The area where the horizontal part of the main winding and the horizontal part of the auxiliary winding attached to the bottom surface of the groove can be used for dispensing glue, so as to fix the winding and the magnetic core.

As shown in FIG. 47D, the second power electrical connector 241/242/243/244 is respectively provided on the third side surface, the fourth side surface, the first side surface and the second side surface of the magnetic core, and the second power electrical connector here is a large piece of metal sheet, respectively covering most of the third side surface, the fourth side surface, the first side surface and the second side surface; each of the second power electrical connectors extends a large sheet of metal to the top surface and the bottom surface to form a pin respectively, which is used for being fixed and electrically connected to the top assembly and the bottom assembly, respectively. And preferably, the metal sheet is a copper sheet. A first electrical connector layer comprises a first power electrical connector 231/232 and an auxiliary winding electrical connector 261/262, the first power electrical connector 231/232 and the auxiliary winding electrical connector 261/262 are spaced apart from each other at a third side surface of the magnetic core, and the auxiliary winding electrical connector 261/262 is disposed between the first power electrical connector 231 and 232. The first electrical connector layer is disposed on the outer side of the second power electrical connector 241, and a sheet insulating material 291 is provided between the second power electrical connector 241 and the first electrical connector layer, so as to achieve electrical isolation between the electrical connectors. A second electrical connector layer comprises a first power electrical connector 233/234 and an auxiliary winding electrical connector 263/264, the first power electrical connector 233/234 and the auxiliary winding electrical connector 263/264 are disposed at intervals on a first side surface of the magnetic core, and the auxiliary winding electrical connector 263/264 is disposed between the first power electrical connector 233 and 234. The second electrical connector layer is disposed on an outer side of the second power electrical connector 243, and a sheet-shaped insulating material 293 is provided between the second power electrical connector 243 and the second power electrical layer, so as to achieve electrical isolation between the electrical connectors. The arrangement of the inner and outer stacks of the power electrical connector reduces the parasitic inductance between the first power electrical connector and the second power electrical connector; helps to reduce the LC oscillation of the input loop; also reduces the parasitic inductance between the auxiliary winding electrical connector and the second power electrical connector; improves the coupling between the main winding loop and the auxiliary winding loop; and reduces the dynamic inductance by means of the TLVR technology, and improves the dynamic performance of the VRM module.

The signal electrical connector combination 255 and 256 both comprise a plurality of signal electrical connectors, and adjacent signal electrical connectors are spaced apart from each other. The signal electrical connector assembly 255 is provided on the outer side of the second power electrical connector 242, and a sheet insulating material 292 is provided between the second power electrical connector 242 and the signal electrical connector assembly 255 and is used for achieving electrical isolation between the electrical connectors. The signal electrical connector combination 256 is provided on the outer side of the second power electrical connector 244, and a sheet-shaped insulating material 294 is provided between the second power electrical connector 244 and the signal electrical connector combination 256 and is used to achieve electrical isolation between the electrical connectors. The signal electrical connector and the second power electrical connector are stacked inside and outside, so that the second power electrical connector can achieve the effect of shielding electric field interference and magnetic field interference, ensuring the signal transmitted on the signal electrical connector, and not being interfered by the noise of the jump power signal on the winding. In addition, the first power electrical connector, the auxiliary winding electrical connector, and the signal electrical connector are both in “C”-shaped, and each connector is provided with a corresponding pin on the top surface and the bottom surface of the magnetic core for being fixed and electrically connected to the top assembly and the bottom assembly respectively.

FIG. 47E and FIG. 47F show an implementation of the stacked arrangement of the side electrical connectors of the magnetic core. As shown in 47E, the second power electrical connector 243, the insulating material 293, the first power electrical connector 233/234, and the auxiliary winding electrical connector 263/264 are integrated by pressing or gluing, and then assembled with the magnetic core. As shown in 47F, the second power electrical connector 244, the insulating material 294, and the signal electrical connector combination 256 form a whole by means of pressing or gluing, and then are assembled with the magnetic core. The advantage of this implementation is to ensure that the pins of all electrical connectors on the same side of the magnetic core are on the same plane on the top surface of the magnetic core, and the pins on the bottom surface of the magnetic core are on the same plane, so as to be reliably and electrically connected to the top assembly and the bottom assembly.

FIG. 47G is another implementation of the embodiment, and FIG. 47H is a partially exploded view. As shown in FIG. 47H, different from the foregoing embodiments, the heat dissipation metal blocks 121a/122a/123a/124a are respectively provided above each IPM unit; the heat dissipation metal blocks are preferably made of copper blocks; the heat dissipation metal blocks are respectively thermally connected to the corresponding IPM units. In this embodiment, after the device disposed above the top substrate is packaged, the plastic encapsulant is ground to expose the upper surface of the heat dissipation metal block. In the present embodiment, the effective thickness of the bare silicon wafer (IPM unit) is less than the thickness of the capacitor provided on the top surface, and the thermal resistance of the heat dissipation metal block is much smaller than that of the plastic packaging material. Therefore, by providing the heat dissipation metal block on the top surface of the IPM unit, the upward thermal resistance of the IPM unit is reduced.

FIG. 47I shows another embodiment different from FIG. 47H in that there is no heat dissipation metal block above the bare silicon wafer. Directly molding the bare silicon wafer and other components on the top surface of the top substrate, and grinding and exposing the upper surface of the bare silicon wafer. The present embodiment is applicable to a small capacitor thickness of the top surface of the top substrate, or an application scenario where the top surface of the top substrate is not provided with a capacitor. In this embodiment, the bare silicon wafer on the top surface of the top substrate may have a thickness of less than 400 μm, reduce the upward thermal resistance of the IPM unit, and reduce the overall thickness of the VRM.

FIG. 47J shows a bottom surface layout of the bottom assembly 300. The multi-phase TLVR module further comprises a bottom surface pin, and the bottom surface pin is provided on the bottom surface of the bottom substrate 310. The bottom surface pins are provided as LGA pins arranged in a P*Q matrix. Both P and Q are natural numbers greater than 1, that is, the bottom surface pins comprise P rows and Q columns. As shown in FIG. 47J, a pin in a gray area is an input VIN pin, a pin marked as an oblique line is a GND pin, a pin marked as black is an output Vo pin, and a pin labeled with a letter is a signal Sig pin.

In detail, the signal Sig pin is disposed adjacent to the third side of the bottom substrate 310 and is disposed adjacent to the edge of the bottom substrate. In the present embodiment, the signal Sig pin comprises a PWM pin, an EN pin, a current detection IMON pin, a temperature detection TMON pin, and a driving pin VDRV. Further, FIG. 47J is a bottom surface pin layout of the four-phase TLVR module. The signal Sig pin includes four PWM control pins, two EN pins, four current detection IMON pins, a temperature detection TMON pin, and a driving pin VDRV. The signal Sig pins are disposed at the first row and two ends of the second row adjacent to the third side, such as the first and the Qth of the second row. The layout of the signal Sig pins is suitable for a multi-phase VRM module, but the four-phase VRM module is optimal.

The input Vin pin is disposed adjacent to the signal Sig pin. In this embodiment, the input VIN pin is disposed in the middle of the second row and in the middle of the third row. For example, the second to the (Q-1)th of the second row and the fourth to the (Q-3)th of the third row. Two ends of the third row are provided with GND pins, that is, the GND pins are arranged adjacent to the signal Sig pin and the input VIN pin, so that the loops of the signal Sig pin and the GND pin, and the loop of the input VIN pin and the GND pin are the smallest, thereby reducing the parasitic inductance on the loop and improving the performance of the VRM module. Further, the parasitic inductance value on the input power loop is reduced, and the resonant frequency between the input capacitor CIN and the parasitic inductance of the input power loop is further higher than the equivalent switching frequency of the VRM; the energy loss caused by resonance of the input loop and the influence on the working stability of the VRM are reduced or avoided, so as to improve the efficiency and reliability of the VRM module.

The bottom surface pin further comprises a plurality of GND pin rows and a plurality of output Vo pin rows, and the plurality of output Vo pin rows and the plurality of GND pin rows are arranged in a staggered manner. For example, rows 4, 6, and 8 are output Vo pin rows, and rows 5, 7 and 9 are GND pin rows; a capacitor arranged on the top surface of the bottom substrate 310 is connected to an output end of the inductor and GND on the top surface of the bottom substrate 310, and is used for energy storage at the load end and improves the dynamic performance of the output voltage; and after connecting with the capacitor, Vo and GND are connected to the load, and the Vo and GND wirings are staggered with each other between the capacitor and the load, so that the parasitic inductance of the wiring between the capacitor and the load is minimized, and the dynamic performance is improved. In the present embodiment, all the output Vo pins are short-circuited to achieve one output. In another embodiment, the output Vo pin may be set to two independent outputs, i.e. the output Vo pin in the A region adjacent to the second side is shorted to achieve one output network; and the output Vo pin in the B region adjacent to the fourth side is shorted to achieve another output network. The two output networks can separately supply power to the two loads, or can supply power to the load together after being connected in parallel.

The bottom surface pin further includes an extension pin TLG and a TLC as a TLVR function, thereby implementing TLVR technology to improve the dynamic performance of the VRM module. The extension pins TLG and TLC may be provided in any one of the regions C1 to C4. The regions C 1 and C 2 are disposed adjacent to the second side surface, and regions C 3 and C4 are disposed adjacent to the fourth side surface. When the multi-phase TLVR module outputs in the plurality of embodiments are used in parallel to provide a larger output current, the auxiliary windings of the plurality of multi-phase TLVR modules need to be connected in series by means of the TLC/TLG pins to form a loop, for example, the TLC pins of the first multi-phase TLVR module are connected to the TLG pins of the second multi-phase TLVR module, the TLC pins of the second multi-phase TLVR module are connected to the TLG pins of the third multi-phase TLVR module, and so on, the TLC pins of the last multi-phase TLVR module are connected to the TLG pins of the first multi-phase TLVR module; The series connection between the inter-module TLC pins and the TLG pins is typically done on the load mainboard.

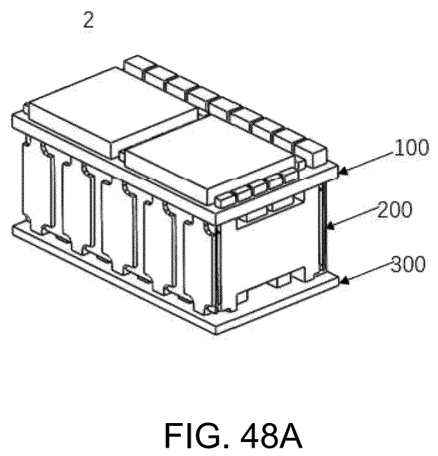

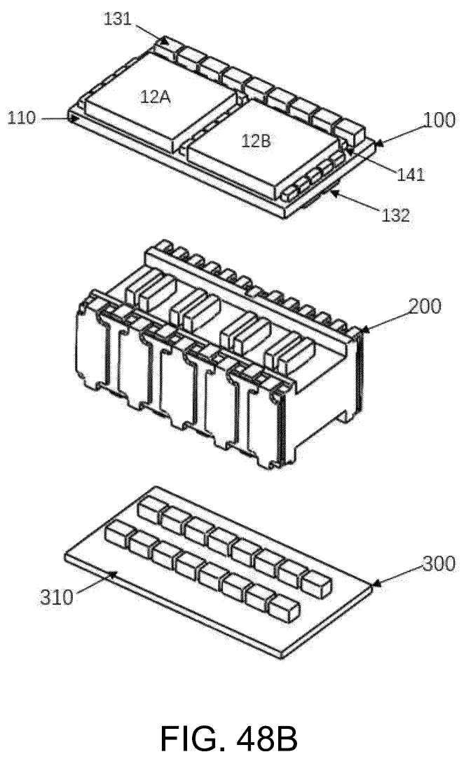

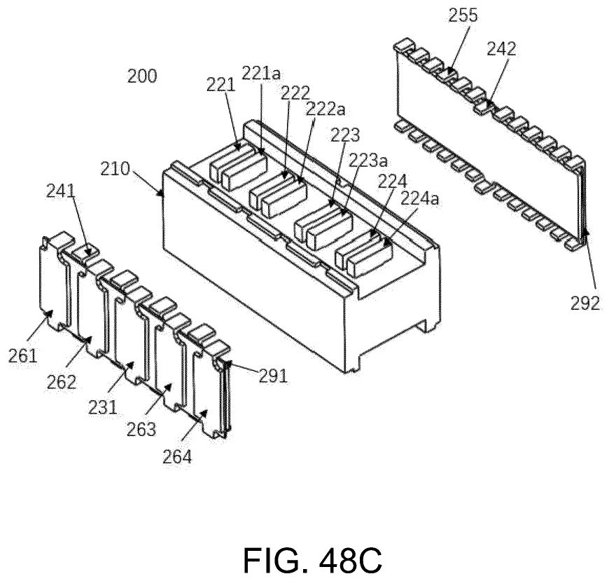

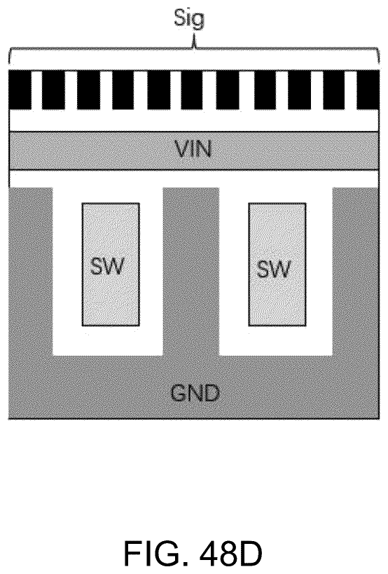

FIG. 48A and FIG. 48B are another embodiment, FIG. 48B is an exploded schematic diagram of FIG. 48A, and FIG. 48C is a structural exploded view of the middle assembly 200. In the present embodiment, all windings are arranged in a row along the second side surface or the fourth side surface of the magnetic core, and the arrangement order is that the winding and the auxiliary winding are arranged at intervals, for example, according to the first winding 221, the first auxiliary winding 221a, the second winding 222, the second auxiliary winding 222a, the third winding 223, the third auxiliary winding 223a, the fourth winding 224 and the fourth auxiliary winding 224a. The power electrical connector and the signal electrical connector are respectively disposed on the second side surface and the fourth side surface of the magnetic core. The power electrical connector and the signal electrical connector are disposed in the stacked manner. A first electrical connector layer comprises a first power electrical connector 231 and an auxiliary electrical connector 261/262/263/264, wherein the first power electrical connector 231 is disposed between the auxiliary electrical connector 261/262 and the auxiliary electrical connector 263/264. Electrical isolation is achieved between the first electrical connector layer and the second power electrical connector 241 by an insulating material 291. Likewise, electrical isolation is achieved between the signal electrical connector assembly 255 and the second power electrical connector 242 through the insulating material 292. Further, in the present embodiment, the VRM comprises two integrated IPMs 12A and 12B, each integrated IPM comprising two IPM units; for example, the first integrated IPM 12A comprises a first IPM unit 121 and a second IPM unit 122, the second integrated IPM 12B comprising a third IPM unit 123 and a fourth IPM unit 124.

FIG. 48D shows a pin distribution diagram of the integrated IPM, and the signal pin combination Sig, the first power pin VIN and the second power pin GND are sequentially arranged in the same direction. the first power pin VIN is an elongated strip; the second power pin GND is a horizontal “E”-shape, and comprises three vertical portions and one horizontal portion; the two pins SW are respectively disposed between two adjacent vertical portions. The first power pin VIN and the second power pin GND are disposed around the pin SW; and an area of the second power pin is greater than an area of the first power pin.

All the technical features shown in the present embodiment, such as an electrical connector stack arrangement and an integrated IPM, can be flexibly applied to the foregoing embodiments, and the same technical effect can be obtained.

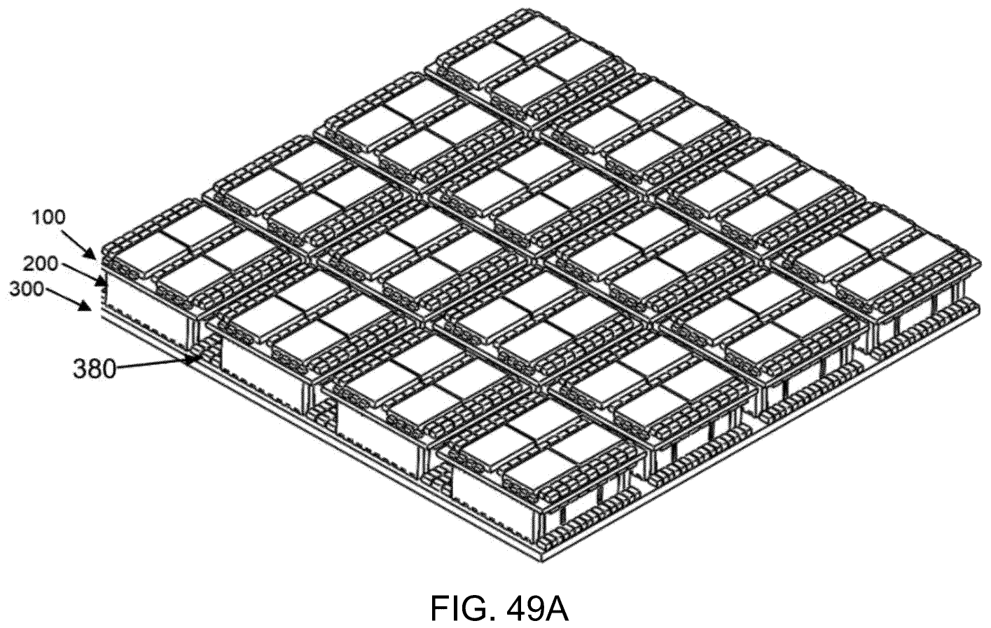

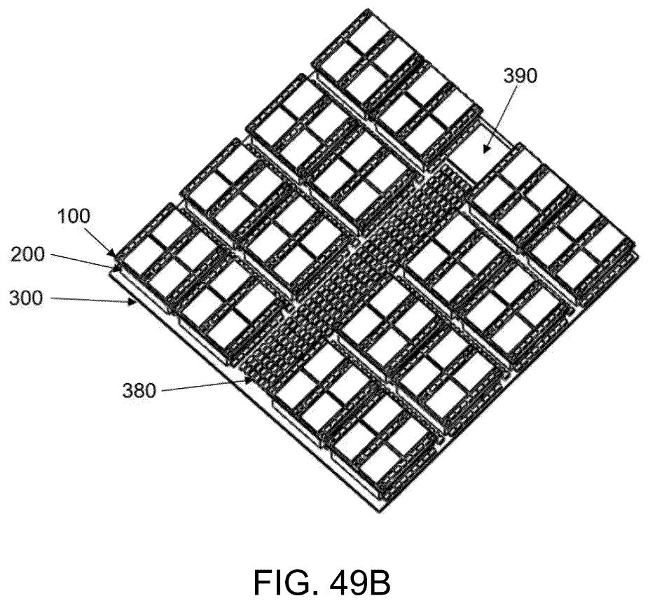

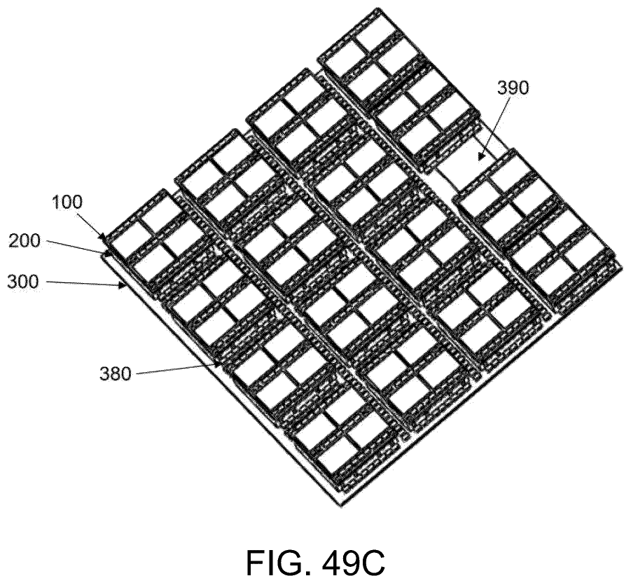

FIG. 49A is an embodiment of a multi-phase TLVR module for a vertical power supply scenario; the bottom assembly 300 of the m*n four-phase TLVR modules 2 is physically connected together, that is, the top assembly and the middle assembly of the m * n four-phase TLVR modules share one bottom assembly 300 to form a 4*m*n-phase VRM integrated output capacitor. 4*4 4-phase VRMs is shown in FIG. 49A, that is a 64-phase VRM for a vertical power supply scenario; the bottom substrate 300 is further provided with an output capacitor 380 between the VRM and the VRM, thereby further improving the dynamic performance of the output voltage; the VRM module can be configured as a 4-phase TLVR, that is, the configuration of sixteen 4-phase TLVR loops; the VRM module can also be configured as a configuration of eight 8 phase TLVR loops; moreover, it can also be configured as a configuration of four 16-phase TLVR loops; and the 8-phase TLVR or 16-phase TLVR can select the number of phases of a rectangle nearby, or the number of squares of a square, so as to match a TLVR configuration having multiple phases. This is not limited herein.

FIG. 49B is another preferred embodiment of FIG. 49A, and FIG. 49B and FIG. 49A differ in that: the controller 390 is added, and the controller 390 is disposed close to the fourth side surface and is centrally disposed; The controller is configured to drive the multi-phase module to work. Half of the multi-phase modules are evenly distributed close to the first side surface, and half of the multi-phase modules are evenly distributed close to the third side surface. An output capacitor is disposed in the middle of the bottom substrate from the second side surface to the fourth side surface, so as to improve the dynamic performance of the output voltage.

FIG. 49C is another preferred embodiment of FIG. 49B, and the difference between FIG. 49C and FIG. 49B is that the arrangement mode of the multi-phase module is different. As shown in FIG. 49C, the controller 390 is arranged on the fourth side surface of the bottom substrate 300 and is centrally arranged; the controller and the multi-phase module are uniformly arranged on the bottom substrate; and an output capacitor can be arranged between the modules, so that the output capacitor is uniformly arranged on the bottom substrate to achieve better dynamic performance.

A control mode of a multi-phase TLVR module is disclosed. The control method is applicable to a multi-phase TLVR module as shown in FIG. 49A to FIG. 49C, but is not limited to the 64 phases shown, as long as a VRM module greater than or equal to two phases can adopt the control mode. In the present control mode, for the problem that the number of control signals outputted by the multi-phase TLVR module controller is insufficient, it is proposed that one N-phase TLVR module only needs one control signal to control the N IPMs in the N-phase module, thereby solving the control problem of the multi-phase VRM module.

In detail, in addition to the power switch, the IPM further comprises a logic unit, which receives a PWM control signal to generate N frequency division control signals, wherein one frequency division control signal is used for controlling the power switch in the IPM (main IPM), and the remaining (N-1) frequency division control signals are used to control the power switch in other IPMs (slave IPM) in the module. Each IPM includes a synchronous enable pin, a PWM input pin, and N (N≥1) PWM output pins. When the synchronization enable pin is in the “enable” state, the main IPM receives the input control signal and generates N frequency division control signals; the frequency of the output control signal of the main IPM is 1/N of the frequency of the input control signal; one frequency division control signal can be used for controlling the main IPM, and the remaining (N-1) frequency division control signals are used as input control signals of (N-1) slave IPM. When the synchronization enable pin is in the “disable” state, the frequency of the output control signal is the same as the frequency of the input control signal, and the PWM output pin can be suspended in actual operation.

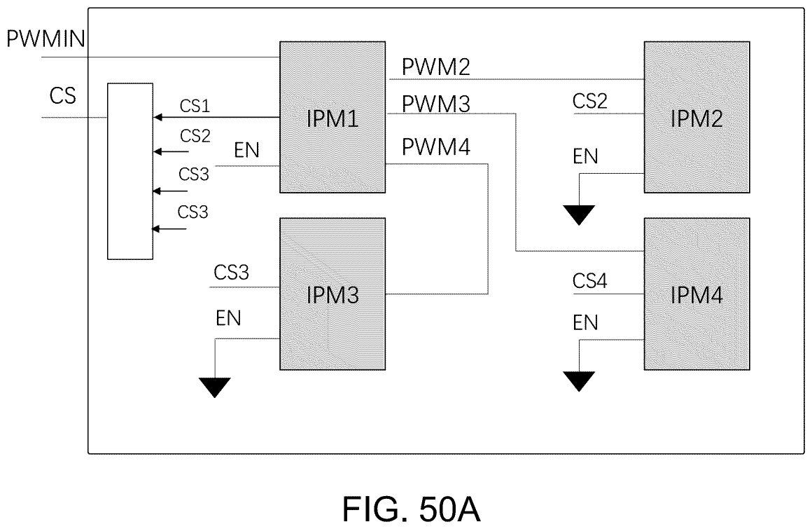

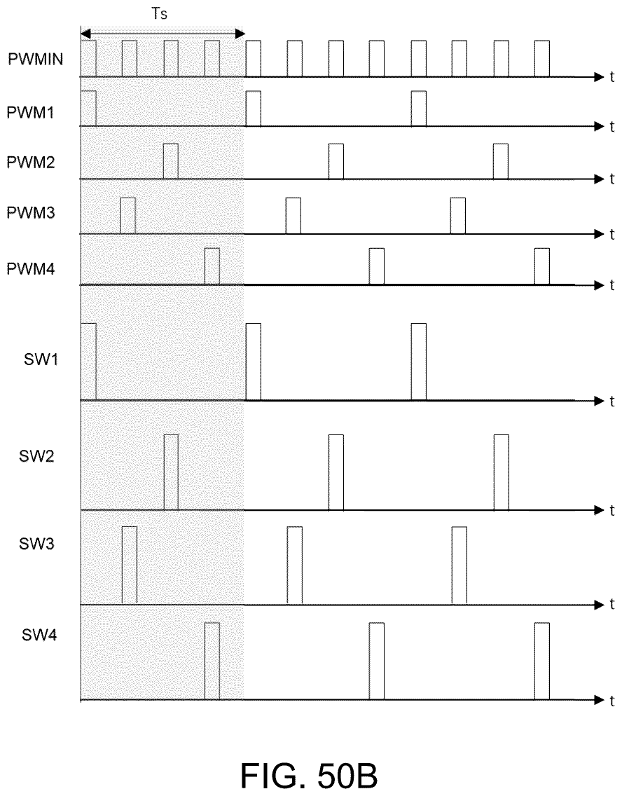

FIG. 50A shows a control mode of a four-phase TLVR module, and FIG. 50B shows a timing diagram of the control mode. Taking IPM 1 as a main IPM, and IPM 2/IPM 3/IPM 4 as an slave IPM as an example for description; the synchronous enable pin of the IPM 1 is in an “enable” state, and the PWM input pin of the IPM 1 receives the control signal PWMIN; in the internal logic unit of the main IPM 1, four frequency division control signals PWM 1/PWM 2/PWM 3/PWM 4 are generated according to the control signal PWMIN; the frequency of the four frequency division control signals is ¼ of the control signal PWMIN; the duty cycles of the four frequency division control signals are equal, and are sequentially staggered by 90 degrees. The frequency division control signal PWM 1 is used for controlling the turning on and off of the power switch in the IPM 1; the main IPM output frequency division control signal PWM 2/PWM 3/PWM 4 is respectively used for controlling the turning on and off of the power switch in the IPM 2/IPM 3/IPM 4; and the synchronous enabling pin of the IPM 2/IPM 3/IPM 4 is in a “disable” state. SW 1/SW 2/SW 3/SW 4 in FIG. 50B is a voltage waveform of SW terminals of four IPMs. The current sampling signal CSx of the four IPMs can be aggregated inside the module into a total sampling signal CS for current control of the four-phase TLVR module. Therefore, the structure of the signal connector of the module is simplified, and system wiring resources are saved. By means of the present control method, the function of one drive can be achieved, good current sharing performance between the modules is achieved, and the current sharing problem between modules caused by one drive is effectively solved.

The technical features disclosed in the present application can be combined with each other to obtain corresponding technical effects.

The “equal” or “same” or “equal to” disclosed in the present application all must consider the parameter distribution of an engineering, and the error distribution is within ±30%; two line segments or two straight lines “parallel” are defined as the included angles between the two line segments or the two straight lines being less than or equal to 45 degrees; the two line segments or the two straight lines “vertical” define the included angles of the two line segments or the two straight lines in the [60, 120] degree range; the definition of the phase “error phase” also needs to consider the parameter distribution of the engineering, and the error distribution of the error phase degree is within ±30%. In addition, relational terms, such as first and second, etc. are used herein merely to distinguish one entity or operation from another without necessarily requiring or implying any such actual relationship or order between such entities or operations. Moreover, the terms “comprise”, “comprise” or any other variation thereof are intended to cover a non-exclusive inclusion, such that a process, method, article, or device that includes a list of elements not only includes those elements, but also includes other elements not expressly listed, or further includes elements inherent to such a process, method, article, or device. Without more constraints, the statement “comprising one . . . ” defined element, which does not exclude the presence of additional identical elements in a process, method, article, or device that includes the element.

The embodiments in the present specification are described in a progressive manner, each embodiment focuses on the differences from other embodiments, and the same and similar parts between the various embodiments can be referred to each other.

The above description of the disclosed embodiments enables those skilled in the art to implement or use the present application. Various modifications to these embodiments will be readily apparent to those skilled in the art, and the general principles defined herein May be implemented in other embodiments without departing from the spirit or scope of the present application. Thus, the present application will not be limited to the embodiments shown herein but is to be accorded the widest scope consistent with the principles and novel features disclosed herein.

What is claimed is:

1. An N-phase trans-inductor voltage regulator (TLVR) integrated inductor, where N is a positive integer greater than 1, characterized by comprising:
a magnetic core, N sets of winding assemblies, a power electrical connector assembly, N auxiliary winding electrical connectors, a metal sheet and a signal electrical connector;
the magnetic core comprises a top surface, a bottom surface, a first side surface, a second side surface, a third side surface and a fourth side surface; the magnetic core is provided with N magnetic core windows, and the magnetic core window penetrates from the top surface to the bottom surface;
the winding assembly comprises a main winding and an auxiliary winding; the main winding and the auxiliary winding are electrically isolated, the winding assembly is arranged in the magnetic core window, and the main winding and the auxiliary winding are coupled to each other;
the power electrical connector assembly comprises at least one first power electrical connector and at least one second power electrical connector; the current directions of the first power electrical connector and the second power electrical connector are opposite; the power electrical connector assembly is disposed on the second side surface and/or the fourth side surface of the magnetic core;
the auxiliary winding electrical connector is disposed on the first side surface and/or the third side surface of the magnetic core;
the metal sheet is at least partially disposed on a side surface of the magnetic core, and is located between the magnetic core and the power electrical connector assembly or the auxiliary winding electrical connector; the metal sheet and at least one potential in the power electrical connector assembly are electrical isolated, and the metal sheet and the auxiliary winding electrical connector are electrical isolated;
the signal electrical connector is disposed on the first side surface and/or the third side surface of the magnetic core.

2. The N-phase TLVR integrated inductor of claim 1, wherein the second side surface is provided with two first power electrical connectors and two second power electrical connectors, and the first electrical connector and the second electrical connector are arranged in a staggered manner; and the fourth side surface is provided with two first power electrical connectors and two second power electrical connectors, and the first electrical connector and the second electrical connector are arranged in a staggered manner.

3. The N-phase TLVR integrated inductor of claim 1, wherein the second side surface is provided with two first power electrical connectors, and one second power electrical connector disposed between the two first power electrical connectors; and the fourth side surface is provided with two first power electrical connectors, and one second power electrical connector disposed between the two first power electrical connectors.

4. The N-phase TLVR integrated inductor of claim 1, wherein a second power electrical connector is disposed on the first side surface and/or the third side surface of the magnetic core, and the second power electrical connector is disposed between the auxiliary winding electrical connectors.

5. The N-phase TLVR integrated inductor of claim 1, wherein the signal electrical connector is an PCB board parallel to the third side surface.

6. The N-phase TLVR integrated inductor of claim 1, wherein the winding assembly further comprises an insulating medium, the insulating medium is disposed between the main winding and the auxiliary winding, and the main winding and the auxiliary winding are electrically isolated by the insulating medium.

7. The N-phase TLVR integrated inductor of claim 6, wherein the winding assembly is provided with a winding step, the winding step comprises a main winding step, an auxiliary winding step and an insulating medium step, the main winding step, the auxiliary winding step and the insulating medium step have the same height.

8. The N-phase TLVR integrated inductor of claim 7, wherein the magnetic core window is provided with a window step corresponding to the winding step.

9. The N-phase TLVR integrated inductor of claim 8, wherein the main winding, the auxiliary winding and the insulating medium are all in “T”-shaped, and the magnetic core window is also in “T”-shaped.

10. The N-phase TLVR integrated inductor of claim 1, wherein the winding assembly is provided with a winding step, the winding step comprises a main winding step and an auxiliary winding step, the main winding step and the auxiliary winding step have the same height, the magnetic core window is correspondingly provided with a window step, the window step is provided with a protrusion, the protrusion is located between the main winding and the auxiliary winding, and is used for limiting and insulating the main winding and the auxiliary winding.

11. The N-phase TLVR integrated inductor of claim 5, wherein the signal electrical connector comprises two rows of signal pins, and the number of signal pins close to one side of the magnetic core is less than the number of signal pins on the side away from the magnetic core.

12. The N-phase TLVR integrated inductor of claim 1, wherein the top of the magnetic core is provided with a second power electrical connector.

13. The N-phase TLVR integrated inductor of claim 1, wherein the magnetic core comprises at least one row of magnetic columns, and the length of the magnetic columns in the same row gradually decreases from the two sides to the middle.

14. The N-phase TLVR integrated inductor of claim 1, wherein a top surface and/or a bottom surface of the magnetic core is provided with a groove.

15. The N-phase TLVR integrated inductor of claim 14, wherein the shortest distance between the side wall or the bottom surface of the groove and the adjacent winding is greater than or equal to 0.5 mm.

16. An N-phase trans-inductor voltage regulator (TLVR) integrated inductor, where N is a positive integer greater than 1, characterized by comprising:
a magnetic core, N sets of winding assemblies, a first power electrical connector, two electrical connector layers, a metal sheet and a signal electrical connector;
the magnetic core comprises a top surface, a bottom surface, a first side surface, a second side surface, a third side surface and a fourth side surface; the magnetic core is provided with N magnetic core windows, and the magnetic core window penetrates from the top surface to the bottom surface;
the winding assembly comprises a main winding and an auxiliary winding; the main winding and the auxiliary winding are electrically isolated, the winding assembly is arranged in the magnetic core window, and the main winding and the auxiliary winding are coupled to each other;
the electrical connector layer is disposed on the first side surface and the third side surface opposite to each other or the second side surface and the fourth side surface opposite to each other, and the first power electrical connector and the signal electrical connector are disposed on the first side surface and the third side surface opposite to each other respectively or are disposed on the second side surface and/or the fourth side surface at the same time;
the electrical connector layer comprises at least one second power electrical connector and at least one auxiliary winding electrical connector;
the metal sheet is at least partially disposed on a side surface of the magnetic core, and is located between the magnetic core and the electrical connector layer or the first power electrical connector, the metal sheet is electrically isolated from at least one potential in the electrical connector layer, and the metal sheet is electrically isolated from the first power electrical connector.

17. The N-phase TLVR integrated inductor of claim 16, wherein the top surface and/or the bottom surface of the magnetic core is provided with a groove.

18. The N-phase TLVR integrated inductor of claim 16, wherein the inner side wall of the magnetic core window is provided with a protrusion for physically isolating the main winding and the auxiliary winding.

19. The N-phase TLVR integrated inductor of claim 18, wherein a length of the protrusion is less than or equal to a depth of the magnetic core window.

20. An N-phase TLVR integrated inductor, where N is a positive integer greater than 1, characterized by comprising:
a magnetic core, N sets of winding assemblies, an electrical connector layer, a second power electrical connector, and a signal electrical connector assembly;
the magnetic core comprises a top surface, a bottom surface, a first side surface, a second side surface, a third side surface and a fourth side surface; the magnetic core is provided with N magnetic core windows, and the magnetic core window penetrates from the top surface to the bottom surface;
the winding assembly comprises a main winding and an auxiliary winding; the main winding and the auxiliary winding are electrically isolated, the winding assembly is arranged in the magnetic core window, and the main winding and the auxiliary winding are coupled to each other;
the second power electrical connector is attached to the magnetic core, the electrical connector layer and the signal electrical connector assembly are disposed on the outer side of the second power electrical connector, and a sheet-like insulating material is provided between the second power electrical connector and the electrical connector layer or the signal electrical connector assembly;
the electrical connector layer comprises a first power electrical connector and an auxiliary winding electrical connector.

21. The N-phase TLVR integrated inductor of claim 20, wherein the second power electrical connector is disposed on the first side surface, the second side surface, the third side surface, and the fourth side surface of the magnetic core, the electrical connector layer is disposed on the first side surface and the third side surface of the magnetic core, and the signal electrical connector assembly is disposed on the second side surface and the fourth side surface of the magnetic core.

22. The N-phase TLVR integrated inductor of claim 20, wherein the N magnetic core windows of the magnetic core are arranged in a row along the second side surface or the fourth side surface, and the winding assembly is arranged in a row along the second side surface or the fourth side surface.

23. The N-phase TLVR integrated inductor of claim 22, wherein the second power electrical connector is disposed on the second side surface and the fourth side surface of the magnetic core, the electrical connector layer is disposed on the second side surface of the magnetic core, and the signal electrical connector layer is disposed on the fourth side surface of the magnetic core.

24. The N-phase TLVR integrated inductor of claim 20, wherein the second power electrical connector is a metal sheet, and each metal sheet extends to the top surface and the bottom surface of the magnetic core to form a pin.

25. A multi-phase module, where N is a positive integer greater than 1, characterized by comprising:
a top assembly, a middle assembly and a bottom assembly;
the top assembly comprises a top substrate, N IPMs, at least one input capacitor, and other passive elements;
the middle assembly comprises an N-phase TLVR integrated inductor, the N-phase TLVR inductor comprising a magnetic core, N sets of winding assemblies, a plurality of electrical connectors and a metal sheet, the magnetic core comprising a top surface, a bottom surface, a first side surface, a second side surface, a third side surface and a fourth side surface, the winding assembly comprising a main winding; the main winding and the plurality of electrical connectors are respectively electrically connected to the N IPMs by means of a top substrate; the metal sheet is at least partially disposed on a side surface of the magnetic core and is attached to the magnetic core, the electrical connector is disposed on an outer side of the metal sheet, and the metal sheet is electrically isolated from the electrical connector; the plurality of electrical connectors comprise a first power electrical connector or comprise a first power electrical connector and a second power electrical connector;
the bottom assembly comprises a bottom substrate, and at least one capacitor disposed on the bottom substrate the bottom substrate comprises a first side, a second side, a third side, and a fourth side.

26. The multi-phase module of claim 25, wherein the metal sheet extends toward the top surface and the bottom surface of the magnetic core to form a pin, and the metal sheet is a second power electrical connector.

27. The multi-phase module of claim 25, the winding assembly further comprising N auxiliary windings; the magnetic core is provided with N magnetic core windows, and the magnetic core window penetrates from the top surface to the bottom surface; the main winding and the auxiliary winding are electrically isolated; the winding assembly is disposed in the magnetic core window, and the main winding and the auxiliary winding are coupled to each other.

28. The multi-phase module of claim 25, wherein the bottom assembly further comprises a plurality of copper pillars and a second plastic package, and the copper pillars are disposed on the bottom substrate;
the copper pillar is used for electrically connecting the main winding and the bottom substate, for electrically connecting the electrical connector and the bottom substrate;
the second plastic package encapsulates the copper pillars and the capacitors together, and the top surface of the second plastic package is provided with electrical connection pins.

29. The multi-phase module of claim 28, further comprising an auxiliary winding; the magnetic core is provided with N magnetic core windows, and the magnetic core window penetrates from the top surface to the bottom surface; each main winding and one auxiliary winding are coupled to each other and are disposed in a same magnetic core window; the electrical connector further comprises an auxiliary winding electrical connector; the metal sheet is electrically isolated from the auxiliary winding electrical connector; an electrical wiring is provided on the top surface of the second plastic package; and the electrical wiring is used for assisting in electrical connection of the auxiliary winding loop.

30. The multi-phase module of claim 25, wherein a bottom surface of the bottom substrate is provided with a pin, the pin is in the form of an i-row*j-column matrix, the pin comprises a VIN pin, a GND pin, a Vo pin and a Sig pin, the Sig pin is located in the first row and/or the i-th row, the GND pin and the VIN pin are located in a region of a second row to an (i-1)-th row or to an i-th row adjacent to the second side edge and the fourth side edge, and the GND pin and the VIN pin are staggered; the Vo pin and the GND pin are disposed in a region surrounded by the Sig pin and the VIN pin, and the Vo pin and the GND pin are staggered.

31. The multi-phase module of claim 29, wherein a bottom surface of the bottom substrate is provided with a pin, the pin is in the form of an i-row*j-column matrix, the pin comprises a VIN pin, a GND pin, a Vo pin and a Sig pin, the Sig pin is located in the first row and/or the i-th row, the GND pin and the VIN pin are located in a region of a second row to an (i-1)-th row or to an i-th row adjacent to the second side edge and the fourth side edge, and the GND pin and the VIN pin are alternately arranged; a Vo pin and a GND pin are disposed in a region surrounded by the Sig pin and the VIN pin, and the Vo pin and the GND pin are staggered; the bottom surface of the bottom substrate is further provided with a function extension pin TLG pin and a TLC pin.

32. The multi-phase module of claim 31, wherein the TLG pin and the TLC pin are arranged opposite to each other, symmetrically arranged or centrally arranged.

33. The multi-phase module of claim 28, wherein a top surface of the top substrate is provided with a capacitor and a heat dissipation metal block, the heat dissipation metal block and the IPM are correspondingly arranged, and projections of the IPM and the corresponding heat dissipation metal block on the top surface of the top substrate at least partially overlap.

34. The multi-phase module of claim 25, wherein a heat dissipation metal block is disposed above the IPM, the heat dissipation metal block is thermally connected to a corresponding IPM unit respectively, a plastic package is disposed above the top substrate, the plastic package encapsulates the device disposed above the top substrate, and an upper surface of the heat dissipation metal block is exposed from the plastic package.

35. The multi-phase module of claim 25, wherein the IPM is a bare silicon wafer; the top assembly further comprises a first plastic package, the first plastic package encapsulates the bare silicon wafer into a whole, and an upper surface of the bare silicon wafer is exposed from the first plastic package.

36. The multi-phase module of claim 25, wherein a bottom surface of the bottom substrate is provided with a pin, and the pin is configured as an LGA pin arranged in P*Q matrix, wherein P and Q are both natural numbers greater than 1; the pin includes a VIN pin, a GND pin, a Vo pin, and a Sig pin, the Sig pin is disposed adjacent to a third side of the bottom substrate, the VIN pin is disposed adjacent to the Sig pin, and the Vo pin and the GND pin are staggered.

37. The multi-phase module of claim 36, wherein the VIN pin is disposed at the first row and two ends of the second row adjacent to the third side, the VIN pin is disposed in the middle of the second row and the middle of the third row, and the GND pins are disposed at two ends of the third row; the Vo pin includes a plurality of Vo pin rows, the GND pin includes a plurality of GND pin rows, the Vo pin row and the GND pin row are arranged in the fourth row to the Pth row, and the Vo pin row and the GND pin row are staggered.

38. The multi-phase module of claim 37, further comprising an auxiliary winding; the magnetic core is provided with N magnetic core windows, and the magnetic core window penetrates from the top surface to the bottom surface; each of the main windings and one auxiliary winding are coupled to each other and are disposed in the same magnetic core window;
the electrical connector further comprises an auxiliary winding electrical connector; the pin further comprises a function extension pin TLG pin and a TLC pin, the TLG pin and the TLC pin are arranged adjacent to the second side and the fourth side, and the TLG pin and the TLC pin are arranged in an area where any m adjacent Vo pins and GND pins in the first column and the Q column are located, wherein m is a natural number greater than 1.

39. The N-phase module of claim 37, wherein all the Vo pins are short-circuited to form an output network.

40. The N-phase module of claim 37, wherein the Vo pin comprises at least two regions, the Vo pins in each region are short-circuited to form an output network, and the output networks independently supply power to a load or supply power to a load after being connected in parallel.

41. A multi-phase module, comprising:
M top assemblies, M middle assemblies and a bottom assembly;
each of the top assemblies comprises a top substrate, N IPMs, M and N both being positive integers greater than 1;
the middle assembly comprises M N-phase integrated inductors; each of the N-phase integrated inductors comprises a magnetic core, an N-phase main winding and a plurality of electrical connectors; the magnetic core comprises a top surface and a bottom surface; the N-phase main winding and the plurality of electrical connectors are provided with pins on the top surface and the bottom surface of the magnetic core;
a N-phase main winding and a plurality of electrical connectors in each of the N-phase integrated inductors are respectively electrically connected to the N IPMs by means of the top substrate;
the bottom assembly, comprising at least one bottom substrate, and at least one capacitor provided on the bottom substrate, wherein M*N main windings and a plurality of electrical connectors in the middle assembly are electrically connected to the capacitors on the bottom substrate and the bottom substrate;
the bottom substrate comprises a first side, a second side, a third side, and a fourth side.

42. The multi-phase module of claim 41, comprising a controller, wherein the controller is disposed on an upper surface of the bottom substrate, and the controller is configured to drive and control the multi-phase module.

43. The multi-phase module of claim 41, wherein the multi-phase module further comprises a plurality of bottom substrate pins, and the plurality of bottom substrate pins are disposed on a lower surface of the bottom substrate.

44. The multi-phase module of claim 41, wherein the magnetic core further comprises a first side surface, a second side surface, a third side surface and a fourth side surface; the magnetic core is provided with N magnetic core windows, and the magnetic core window penetrates from the top surface to the bottom surface; the plurality of electrical connectors comprise a power electrical connector assembly, N auxiliary winding electrical connectors, and a signal electrical connector; each of the N-phase integrated inductors further comprises an N-phase auxiliary winding; each of the main windings is coupled to and electrically isolated from a corresponding auxiliary winding, and the mutually coupled main winding and auxiliary winding are disposed in one window of the magnetic core; and the electrical connector is disposed on at least one side surface of the magnetic core.

45. An IPM, comprising at least one minimum power unit, wherein the minimum power unit comprises a first power sub-unit and a second power sub-unit arranged in parallel; current directions in the first power sub-unit and the second power sub-unit are opposite, and magnetic fluxes generated by the current cancel each other; the first power sub-unit and the second power sub-unit both comprise at least one pair of switching devices, the switching device comprises a high-side switching device and a low-side switching device, and the high-side switching device and the low-side switching device are electrically connected to SW points.

46. The IPM of claim 45, wherein the arrangement direction of the switch device in the first power sub-unit is 180° from the arrangement direction of the switch device in the second power sub-unit, and the SW point of the first power sub-unit and the SW point of the second power sub-unit are disposed on the same horizontal line and are electrically connected together.

47. The IPM of claim 46, comprising a plurality of minimum power units connected in series and/or in parallel, wherein each high-side switching device is horizontally adjacent to a low-side switching device with opposite current directions, each low-side switching device horizontally adjacent to a high-side switching device with opposite current directions, and the SW points of each pair of switching devices are electrically connected together.

48. The IPM of claim 45, further comprising a Sig pin row, a power pin row, and a SW pin row, wherein the power pin row comprises a VIN pin and a GND pin arranged in a staggered manner; the Sig pin row is arranged adjacent to one side edge of the IPM, and the power pin row and the SW pin row are sequentially arranged at intervals in the same direction.

49. The IPM of claim 48, wherein a high frequency filter capacitor is provided near the VIN pin and the GND pin.

50. The IPM of claim 48, wherein a high-frequency filter capacitor is disposed between the VIN pin and the GND pin.

51. The IPM of claim 45, further comprising a VIN pin, a GND pin, a SW pin, and a Sig pin, wherein the Sig pin, the VIN pin, and the GND pin are sequentially arranged in the same direction, the VIN pin is elongated, the GND pin is in a horizontal “E” shape, and comprises three vertical portions and a horizontal portion, the SW pin is located between two adjacent vertical portions, the VIN pin and the GND pin surround the SW pin, and the area of the GND pin is greater than the area of the VIN pin.

52. The IPM of claim 45, further comprising a logic unit, a synchronization enable pin, a PWM input pin, and N PWM output pins, the IPM comprises a main IPM and a slave IPM, the main IPM receives an input control signal and generates N frequency division control signals, one of the frequency division control signals is used for controlling the main IPM, and the remaining N-1 frequency division control signals are used for controlling N-1 slave IPM.

53. The IPM of claim 52, wherein the synchronization enable pin comprises an “enable” state and a “disable” state, and when the synchronous enable pin is in the “enable” state, the frequency of the N frequency division control signals is 1/N of the frequency of the input control signal, and the phase is 360/N degrees in sequence; when the synchronization enable pin is in the “disable” state, the frequency of the N frequency division control signals is the same as the frequency of the input control signal.

54. The IPM of claim 52, wherein the main IPM and the N-1 slave IPMs each comprise a current sampling signal, and the N current sampling signals are aggregated into a total sampling signal in the IPM.

55. A power supply system, wherein the power supply system supplies power to a semiconductor chip, and comprises:
a load mainboard, an IBC converter, M N-phase VR modules, and at least one controller, wherein M and N are both natural numbers greater than 1;
the load mainboard comprises a first plane and a second plane opposite to the first plane;
the IBC converter and the M N-phase VR modules and the semiconductor chip are arranged on the load mainboard;
the controller outputting a plurality of sets of PWM signals, each set of PWM signals comprising N PWMs having a phase difference of 360/N;
the controller simultaneously drives at least one VR module of the M N-phase VR modules by means of a set of PWM signals.

56. The power supply system of claim 55, wherein each of the VR modules comprises N auxiliary windings and N auxiliary electrical connectors; the M N-phase VR modules are arranged around the semiconductor chip, and the M N-phase VR modules are connected end to end to form an M*N-phase VR loop; or, the N-phase VR modules located on two adjacent sides of the semiconductor chip are connected in series to form two M*N/2-phase VR loops, and M is an even number.

57. The power supply system of claim 55, wherein each of the VR modules comprises N auxiliary windings and N auxiliary electrical connectors; the M N-phase VR modules are disposed on two sides of the semiconductor chip, the M/2 N-phase VR modules on each side are connected in series to form an M*N/2-phase TLVR loop, or half of the N-phase VR modules on one side and half of the N-phase VR modules on the other side are connected end-to-end in series to form an M*N/2-phase TLVR loop, and the other half of the N-phase VR modules on one side and the other half of the N-phase VR modules on the other side are connected end-to end in series to form an M*N/2-phase TLVR loop.

58. The power supply system of claim 57, wherein the set of PWM signals simultaneously drive an N-phase circuit of the M N-phase VR modules; the N-phase circuit is from a plurality of different N-phase VR modules, and the plurality of VR modules are located on the same side or on a different side of the semiconductor chip.

59. The power supply system of claim 55, wherein the IBC converter and the M N-phase VR modules and the semiconductor chip are disposed on a same plane of the load mainboard.

60. The power supply system of claim 55, wherein the semiconductor chip is disposed on a first plane of the load mainboard; the IBC converter and the M N-phase VR modules are disposed on a second plane of the load mainboard; and the M N-phase VR modules are disposed in a projection range of the semiconductor chip.

61. The power supply system of claim 55, wherein the M N-phase VRs are disposed on one adapter board or share one bottom substrate to form a VR module, and the VR module is disposed in a projection range of the semiconductor chip.
